(19) United States
(12) Patent Application Publication
(10) Pub. No.: US 2025/0001330 A1
(43) Pub. Date: Jan. 2, 2025

(54) APPARATUS FOR FILTERING AND CLEANING WATER IN A MIKVAH (JEWISH RITUAL PURIFICATION BATH), WHICH COMPLY WITH JEWISH RELIGIOUS LAWS (HALACHA), AND APPLICATIONS THEREOF

(71) Applicant: Yitzchak Ayzen, Beitar Illit (IL)

(72) Inventor: Yitzchak Ayzen, Beitar Illit (IL)

(21) Appl. No.: 18/710,501

(22) PCT Filed: Nov. 22, 2022
(86) PCT No.: PCT/IB22/00704

§ 371 Date: May 15, 2024

Related U.S. Application Data
(60) Provisional application No. 63/283,066, filed on Nov. 24, 2021.

(51) Int. Cl. B01D 29/15; B01D 29/92; E04H 4/12

(52) U.S. Cl. CPC B01D 29/15; B01D 29/925; E04H 4/1218; B01D 2201/4046

(57) ABSTRACT

Apparatus and method for filtering and cleaning water in a mikvah, which comply with Jewish religious law (halacha), and applications thereof. Apparatus includes: outer tube with mikvah water inlet and outlet openings, tubular filter medium within outer tube, middle tube with openings and within filter medium, inner tube with openings and within middle tube, and forced water circulation assembly including propeller, propeller shaft, and propeller motor, operatively connected to outer, middle, inner tubes. Apparatus configured with specially designed water flow assembly that facilitates continuous unobstructed flow of filtered and cleaned mikvah water inside the apparatus. Also disclosed are filter medium removal and replacement devices, for facilitating efficient and user-friendly removal and replacement of the filter medium. Applicable for filtering and cleaning water in various sized mikvahs, and maintaining mikvah water highly clean, in full compliance with Jewish religious law (halacha), and in a very efficient, user-friendly, and cost effective manner.

### RELATED APPLICATION

This application claims the benefit of priority under 35 USC 119(e) of U.S. Provisional Patent Application No. 63/283,066, filed Nov. 24, 2021, the contents of which are incorporated herein by reference in their entirety.

### FIELD OF THE INVENTION

The present invention relates to techniques (apparatuses, methods) used for cleaning water in a mikvah (Jewish ritual purification bath), which comply with stringent requirements set forth by Jewish religious law (halacha) regarding mikvahs, and more particularly, to an apparatus for filtering and cleaning water in a mikvah, which complies with Jewish religious law (halacha), and applications thereof.

### BACKGROUND OF THE INVENTION

A mikvah (mikveh, mikve) is a bath of first-hand (naturally occurring or derived) water used for the purpose of ritual immersion (of persons, or kitchenware) in Judaism to achieve ritual and spiritual purity. An important practical aspect of a mikvah is the need to maintain an appropriately high level of cleanliness of the water in a mikvah (herein, the phrase “water in a mikvah”, for brevity, is referred to as “mikvah water”), whose typical volume is in the range of 1,000-15,000 liters (1-15 cubic meters). Such need is particularly relevant for a mikvah that is highly active and often used, especially for immersions of many people, on a daily or weekly basis. Whether it be for immersion of persons, or kitchenware, it is highly desirable that the mikvah water be very clean, and contain minimal amounts of numerous possible kinds of (physical, chemical, or/and biological) contaminants, impurities, and foreign materials.

There are well established requirements (rules, regulations), along with differing interpretations and guidelines for implementing thereof, regarding how mikvah water may be cleaned by using a water cleaning apparatus, in a manner that complies with Jewish religious and legal laws (halacha). Three most basic and widely accepted requirements are as follows. First, during its operation, any and all components or parts of the water cleaning apparatus that is/are in contact with the mikvah water is/are absent of standing (static, non-moving, non-flowing) mikvah water. Second, during its operation, the water cleaning apparatus must not remove any amount of mikvah water from the mikvah. Third, during operation of the water cleaning apparatus, the mikvah water passing (flowing) therethrough must be in continuous contact (fluid communication) with mikvah water located immediately adjacent to and outside of the water cleaning apparatus. The term ‘continuous contact (fluid communication)’, as used herein, means that mikvah water flowing along an entire (full) path (passageway) through (from input into, and output from) the water cleaning apparatus, is absent of any physical separation (or barrier), having width, length, or height, less than 45 mm (4.5 cm).

Commercially available water cleaning apparatuses, used for cleaning water of, or in, numerous different types and kinds of water-containing structures and processes, and which are not specifically designed and constructed for cleaning mikvah water, do not comply with at least one, typically, all three, of the above listed religious legal requirements, and thus, cannot be used for cleaning water in a mikvah according to Jewish halacha.

An example of a commercially available mikvah water cleaning apparatus, that complies with Jewish halacha regarding mikvahs, is disclosed in U.S. Pat. Appl. Pub. No. 2003/0024862 A1 (Gal, Y.), and teaches the following. “A filtering system for cleaning a pool. The system including a casing for immersing in the pool, and at least one filtering unit located within the casing. The floor of the pool or an appendage thereto define at least one chamber together with the casing.”. Additionally described therein is “ . . . a filtering system immersed in a Mikve, which has a tube connecting the interior of the filtering system to a floor of the Mikve. The connecting tube optionally has a diameter of at least 4.5 centimeters, disqualifying the filtering system from being a container.”.

To date there have been numerous other attempts, each with particular advantages and disadvantages, of providing mikvah water cleaning apparatuses that comply with Jewish halacha. Despite such attempts, there is an on-going need for developing and implementing new and improved techniques (apparatuses, methods) applicable for cleaning water in a mikvah, which comply with stringent requirements set forth by Jewish religious laws (halacha) regarding mikvahs.

### SUMMARY OF THE INVENTION

The present invention relates to techniques (apparatuses, methods) used for cleaning water in a mikvah (Jewish ritual purification bath), which comply with stringent requirements set forth by Jewish religious law (halacha) regarding mikvahs, and more particularly, to an apparatus for filtering and cleaning water in a mikvah, which complies with Jewish religious law (halacha), and applications thereof. The mikvah water filtering and cleaning apparatus includes a specially designed water flow assembly that facilitates continuous unobstructed flow of mikvah water, and prevents formation of standing (static, non-moving, non-flowing) mikvah water, inside the mikvah water filtering and cleaning apparatus. Also disclosed are an exemplary wall securing assembly, for reversibly, securely and stably connecting the mikvah water filtering and cleaning apparatus to a wall of a mikvah, and exemplary filter medium removal and replacement devices, for facilitating efficient and user-friendly removal and replacement of the filter medium of the mikvah water filtering and cleaning apparatus. The present invention is applicable for filtering and cleaning water in various sized mikvahs, and maintaining the mikvah water highly clean, in full compliance with Jewish religious law (halacha), and in a very efficient, user-friendly, and cost effective manner.

According to an aspect of some embodiments of the present invention, there is provided an apparatus for filtering and cleaning water in a mikvah, which complies with Jewish religious laws, the apparatus comprising: an outer tube, a tubular filter medium, an inner tube, and a forced water circulation assembly.

The outer tube longitudinally extends downwardly and upwardly between outer tube top and bottom ends, and is configured with at least one outer tube mikvah water inlet opening and at least one outer tube mikvah water outlet opening.

The tubular filter medium longitudinally extends downwardly and upwardly between filter medium top and bottom ends, and is removably, collaterally positioned within and along the outer tube.

The middle tube longitudinally extends downwardly and upwardly between middle tube top and bottom ends, and is configured with a plurality of middle tube openings, and the middle tube is collaterally positioned within and along, so as to support, the filter medium.

The inner tube longitudinally extends downwardly and upwardly between inner tube top and bottom ends, and is configured with a plurality of inner tube openings. The inner tube is collaterally securely positioned within and along the middle tube, such that the plurality of inner tube openings are spatially adjacently aligned and nearly coincide with the plurality of middle tube openings, so as to facilitate continuous unobstructed flow of filtered and cleaned mikvah water from the middle tube openings into and through the inner tube openings.

The forced water circulation assembly includes a propeller, a propeller shaft, and a propeller shaft motor assembly, and is operatively connected to the outer, middle, and inner tubes, whereby the forced water circulation assembly facilitates forced continuous and directional flow, and, filtering and cleaning, of the mikvah water from the mikvah into and through the at least one outer tube mikvah water inlet opening, the filter medium, the middle and inner tube openings, and the at least one outer tube mikvah water outlet opening.

According to some embodiments of the apparatus, the outer tube is configured with at least one alignment indentation, that facilitates spatial top to bottom longitudinal or/and horizontal latitudinal alignment of structural features of apparatus components. According to some embodiments of the apparatus, the structural features of apparatus components comprise the plurality of middle tube openings that are spatially aligned and nearly coincide with the plurality of inner tube openings. According to some embodiments of the apparatus, each one of the outer tube alignment indentation is located at any top to bottom longitudinal position along the outer tube, and has any one of numerous different geometrical shapes. According to some embodiments of the apparatus, each one of the outer tube alignment indentation has a shape and size configured so as to facilitate secure fitting and holding of a complementary mated and matched alignment protrusion or projection configured in another apparatus component.

According to some embodiments of the apparatus, inside the outer tube, the filter medium is securely wrapped around, and surrounds, the middle tube along entire top to bottom longitudinal length of the middle tube.

According to some embodiments of the apparatus, the filter medium top end and the middle tube top end are covered by a filter medium and middle tube top ends cover assembly. According to some embodiments of the apparatus, the filter medium and middle tube top ends cover assembly is cylindrical in form, and includes an outer member and an inner member securely positioned and held within the outer member. According to some embodiments of the apparatus, the outer and inner members are configured with screw threads that facilitate operative connection of the apparatus to a device for removing and replacing the filter medium. According to some embodiments of the apparatus, the outer member is configured with a single screw thread that facilitates operative connection of the apparatus to a device for removing and replacing the filter medium.

According to some embodiments of the apparatus, the filter medium and middle tube top ends cover assembly is configured with at least one alignment protrusion or projection, that facilitates spatial top to bottom longitudinal or/and horizontal latitudinal alignment of structural features of apparatus components. According to some embodiments of the apparatus, the structural features of apparatus components comprise the plurality of middle tube openings spatially aligned and nearly coinciding with the plurality of inner tube openings. According to some embodiments of the apparatus, each one of the alignment protrusion or projection has a shape and size configured so as to facilitate secure fitting and holding of a complementary mated and matched alignment indentation configured in another apparatus component. According to some embodiments of the apparatus, the filter medium and middle tube top ends cover assembly is configured with at least one alignment protrusion or projection that has a shape and size configured so as to facilitate secure fitting and holding of a complementary mated and matched alignment indentation configured in a top end portion of the outer tube, to thereby facilitate spatial top to bottom longitudinal or/and horizontal latitudinal alignment of structural features of apparatus components. According to some embodiments of the apparatus, the structural features of apparatus components comprise the plurality of middle tube openings that are spatially aligned and nearly coincide with the plurality of inner tube openings.

According to some embodiments of the apparatus, the middle tube includes a bottom end portion configured with bottommost openings, whose bottom peripheries are open in a form of spaces or gaps that are parallel to, and coincide with, the middle tube bottom end, whereby the spaces or gaps facilitate continuous unobstructed flow of filtered and cleaned mikvah water which passes through and exits the filter medium and then enters and passes through the middle tube bottom end portion.

According to some embodiments of the apparatus, the apparatus further comprises a tubes and filter medium bottom ends holding member, configured for holding the filter medium bottom end, the middle tube bottom end, and the inner tube bottom end, and configured for facilitating continuous and unobstructed flow of filtered and cleaned mikvah water that passes through and exits the filter medium and enters, passes through, and exits the middle tube openings and the inner tube openings.

According to some embodiments of the apparatus, the tubes and filter medium bottom ends holding member is configured with a cylindrical encircling solid portion that encircles a cylindrical central hollow portion. According to some embodiments of the apparatus, the cylindrical encircling solid portion has an overall diameter, an outer radius, an inner radius, and a top to bottom longitudinal length or height that varies between the outer radius and the inner radius. According to some embodiments of the apparatus, the cylindrical encircling solid portion includes a solid portion top surface configured with a top surface gradient or inclination that latitudinally spans and descends upon and along the solid portion top surface, and further includes a solid portion bottom surface, a solid portion inner side surface, and a solid portion outer side surface.

According to some embodiments of the apparatus, the top surface gradient or inclination latitudinally spans and descends upon and along the solid portion top surface between an outer radius and an inner radius of the encircling solid portion. According to some embodiments of the apparatus, the top surface gradient or inclination has a gradient or inclination angle, defined as an angle formed between a first straight line originating from a point on a circumferential periphery of the cylindrical central hollow portion and parallel to the solid portion bottom surface, and a second straight line originating from the originating point of the first straight line and collinear with the top surface gradient. According to some embodiments of the apparatus, the gradient or inclination angle is in a range of between one degree and eighty-nine degrees.

According to some embodiments of the apparatus, the solid portion inner side surface has a bottom end portion configured as a cylindrical ledge or horizontal projection that horizontally, circularly extends from, and along, a circumferential periphery of the bottom end portion, inwardly into the cylindrical central hollow portion. According to some embodiments of the apparatus, the filter medium bottom end and the middle tube bottom end are positioned on, and supported by, the top surface gradient or inclination, and the inner tube bottom end is positioned along, and supported by, the solid portion inner side surface. According to some embodiments of the apparatus, the inner tube bottom end is positioned on, and supported by, a top width of the cylindrical ledge or horizontal projection of the solid portion inner side surface.

According to some embodiments of the apparatus, the propeller shaft motor assembly is housed inside a motor housing assembly that is connected to the inner tube top end.

According to an aspect of some embodiments of the present invention, there is provided a water flow assembly, for use in an apparatus for filtering and cleaning water in a mikvah, which complies with Jewish religious laws, the water flow assembly comprising: a first tube, a second tube, and a cylindrical tubes bottom ends holding member.

The first tube longitudinally extends downwardly and upwardly between first tube top and bottom ends, and is configured with a plurality of first tube openings. The first tube has a first tube bottom end portion configured with first tube bottommost openings whose bottom peripheries are open in a form of spaces or gaps that are parallel to, and coincide with, the first tube bottom end, whereby the spaces or gaps facilitate continuous unobstructed flow of filtered and cleaned mikvah water which enters and passes through the first tube bottom end portion;

The second tube longitudinally extends downwardly and upwardly between second tube top and bottom ends, and is configured with a plurality of second tube openings. The second tube has a second tube bottom end portion configured with second tube bottommost openings, and the second tube is collaterally securely positioned within and along the first tube, such that the plurality of second tube openings are spatially adjacently aligned and nearly coincide with the plurality of first tube openings, so as to facilitate continuous unobstructed flow of filtered and cleaned mikvah water from the first tube openings into and through the second tube openings;

The cylindrical tubes bottom ends holding member is configured for holding the first tube bottom end and the second tube bottom end, and is configured for facilitating continuous and unobstructed flow of filtered and cleaned mikvah water that enters, passes through, and exits the first tube openings and the second tube openings.

According to some embodiments of the water flow assembly, the cylindrical tubes bottom ends holding member is configured with a cylindrical encircling solid portion that encircles a cylindrical central hollow portion. According to some embodiments of the water flow assembly, the cylindrical encircling solid portion has an overall diameter, an outer radius, an inner radius, and a top to bottom longitudinal length or height that varies between the outer radius and the inner radius. According to some embodiments of the water flow assembly, the cylindrical encircling solid portion includes a solid portion top surface configured with a top surface gradient or inclination that latitudinally spans and descends upon and along the solid portion top surface, and further includes a solid portion bottom surface, a solid portion inner side surface, and a solid portion outer side surface.

According to some embodiments of the water flow assembly, the top surface gradient or inclination latitudinally spans and descends upon and along the solid portion top surface between an outer radius and an inner radius of the encircling solid portion. According to some embodiments of the water flow assembly, the top surface gradient or inclination has a gradient or inclination angle, defined as an angle formed between a first straight line originating from a point on a circumferential periphery of the cylindrical central hollow portion and parallel to the solid portion bottom surface, and a second straight line originating from the originating point of the first straight line and collinear with the top surface gradient. According to some embodiments of the water flow assembly, the gradient or inclination angle is in a range of between one degree and eighty-nine degrees.

According to some embodiments of the water flow assembly, the solid portion inner side surface has a bottom end portion configured as a cylindrical ledge or horizontal projection that horizontally, circularly extends from, and along, a circumferential periphery of the bottom end portion, inwardly into the cylindrical central hollow portion. According to some embodiments of the water flow assembly, the first tube bottom end is positioned on, and supported by, the top surface gradient or inclination, and the second tube bottom end is positioned along, and supported by, the solid portion inner side surface. According to some embodiments of the water flow assembly, the second tube bottom end is positioned on, and supported by, a top width of the cylindrical ledge or horizontal projection of the solid portion inner side surface.

According to an aspect of some embodiments of the present invention, there is provided a device for holding bottom ends of tubes, for use in an apparatus for filtering and cleaning water in a mikvah, which complies with Jewish religious laws, the device comprising: a cylindrical encircling solid portion that encircles a cylindrical central hollow portion, the encircling solid portion is configured for holding a bottom end of a first tube and a bottom end of a second tube, and the central hollow portion is configured for facilitating continuous and unobstructed passage therethrough of filtered and cleaned mikvah water that enters, passes through, and exits, the first and second tubes.

According to some embodiments of the device, the cylindrical encircling solid portion has an overall diameter, an outer radius, an inner radius, and a top to bottom longitudinal length or height that varies between the outer radius and the inner radius.

According to some embodiments of the device, the cylindrical encircling solid portion includes a solid portion top surface configured with a top surface gradient or inclination that latitudinally spans and descends upon and along the solid portion top surface, and further includes a solid portion bottom surface, a solid portion inner side surface, and a solid portion outer side surface.

According to some embodiments of the device, the top surface gradient or inclination latitudinally spans and descends upon and along the solid portion top surface between an outer radius and an inner radius of the encircling solid portion. According to some embodiments of the device, the top surface gradient or inclination has a gradient or inclination angle, defined as an angle formed between a first straight line originating from a point on a circumferential periphery of the cylindrical central hollow portion and parallel to the solid portion bottom surface, and a second straight line originating from the originating point of the first straight line and collinear with the top surface gradient. According to some embodiments of the device, the gradient or inclination angle is in a range of between one degree and eighty-nine degrees.

According to some embodiments of the device, the solid portion inner side surface has a bottom end portion configured as a cylindrical ledge or horizontal projection that horizontally, circularly extends from, and along, a circumferential periphery of the bottom end portion, inwardly into the cylindrical central hollow portion.

According to some embodiments of the device, the top surface gradient or inclination is configured for positioning and supporting thereupon the first tube bottom end.

According to some embodiments of the device, the cylindrical ledge or horizontal projection of the solid portion inner side surface has a top width configured for positioning and supporting thereupon the second tube bottom end.

All technical or/and scientific words, terms, or/and phrases, used herein have the same or similar meaning as commonly understood by one of ordinary skill in the art to which the invention pertains, unless otherwise specifically defined or stated herein. Exemplary embodiments of apparatuses (devices, systems, components thereof), equipment, materials, and methods (steps, procedures), illustratively described herein are exemplary and illustrative only and are not intended to be necessarily limiting. Although apparatuses, equipment, materials, and methods, equivalent or similar to those described herein can be used in practicing or/and testing embodiments of the invention, exemplary apparatuses, equipment, materials, and methods, are illustratively described below. In case of conflict, the patent specification, including definitions, will control.

### BRIEF DESCRIPTION OF THE SEVERAL VIEWS OF THE DRAWINGS

Some embodiments of the present invention are herein described, by way of example only, with reference to the accompanying drawings and photographs. With specific reference now to the drawings and photographs in detail, it is stressed that the particulars shown are by way of example and for purposes of illustrative description of some embodiments of the present invention. In this regard, the description taken together with the accompanying drawings and photographs make apparent to those skilled in the art how some embodiments of the present invention may be practiced.

In the drawings and photographs:

FIGS. 1A, 1B, 1C, and 1D are schematic perspective views of the front, back, side, and front bottom, respectively, of an exemplary embodiment of the mikvah water filtering and cleaning apparatus, in accordance with some embodiments of the invention;

FIG. 2 is a schematic transparent side view of the exemplary embodiment of the mikvah water filtering and cleaning apparatus (of FIGS. 1A-1D), in accordance with some embodiments of the invention;

FIGS. 3A-3D are schematic perspective views illustrating sequential undressing (removal of components) of the exemplary mikvah water filtering and cleaning apparatus (of FIGS. 1A-1D), in accordance with some embodiments of the invention;

FIG. 4 is a schematic perspective view of selected components of the exemplary mikvah water filtering and cleaning apparatus (of FIGS. 1A-1D), in accordance with some embodiments of the invention;

FIG. 5 is a schematic perspective view of an exemplary embodiment of the outer tube of the exemplary mikvah water filtering and cleaning apparatus (of FIGS. 1A-1D), in accordance with some embodiments of the invention;

FIGS. 6 and 7 are schematic perspective views of an exemplary embodiment of the filter medium with the middle tube inside, covered by the filter medium and middle tube top ends cover assembly (with a screw thread [FIG. 6] and without a screw thread [FIG. 7]), in accordance with some embodiments of the invention;

FIG. 8 is a schematic perspective view of an exemplary embodiment of the filter medium of the mikvah water filtering and cleaning apparatus (of FIGS. 1A-1D), in accordance with some embodiments of the invention;

FIGS. 9 and 10 are schematic close-up perspective views of the top side of an exemplary embodiment of the filter medium and middle tube top ends cover assembly (with the male screw thread [FIG. 9] and without the male screw thread [FIG. 10]), in accordance with some embodiments of the invention;

FIGS. 11A and 11B are schematic close-up perspective views of the bottom sides of exemplary embodiments of the outer member [FIG. 11A] and of the inner member [FIG. 11B], respectively, of the filter medium and middle tube top ends cover assembly, in accordance with some embodiments of the invention;

FIGS. 12A and 12B are schematic front and perspective views, respectively, of an exemplary embodiment of the middle tube of the mikvah water filtering and cleaning apparatus (of FIGS. 1A-1D), in accordance with some embodiments of the invention;

FIGS. 13A and 13B are schematic front and perspective views, respectively, of an exemplary embodiment of the inner tube of the mikvah water filtering and cleaning apparatus (of FIGS. 1A-1D), in accordance with some embodiments of the invention;

FIGS. 14A and 14B are schematic close-up perspective top and side views, respectively, of an exemplary embodiment of the middle and inner tubes bottom ends and filter medium bottom end holding member, highlighting the solid portion top surface gradient (inclination, slope, slant) γ, and the gradient (inclination, slope, slant) angle α thereof, in accordance with some embodiments of the invention;

FIG. 15 is a schematic close-up perspective view of the lower portions of the middle tube with the inner tube inside, held by the middle and inner tubes bottom ends and filter medium bottom end holding member, corresponding to the water flow assembly (WFA), highlighting the middle tube bottommost openings gaps π and the tubes and filter medium bottom ends holding member solid portion top surface gradient (inclination, slope, slant) γ, along with showing an exemplary water flow pathway, inside the mikvah water filtering and cleaning apparatus, in accordance with some embodiments of the invention;

FIG. 16 is a schematic exploded perspective view of an exemplary embodiment of the forced water circulation assembly of the mikvah water filtering and cleaning apparatus (of FIGS. 1A-1D), in accordance with some embodiments of the invention;

FIG. 17 is a schematic cut-away view of an exemplary embodiment of the mikvah water filtering and cleaning apparatus (of FIGS. 1A-1D) in mikvah water, illustrating exemplary operation thereof, highlighting sequential water flow pathways of mikvah water entering into, flowing inside and through, and exiting from, the mikvah water filtering and cleaning apparatus, in accordance with some embodiments of the invention;

FIGS. 18A-18C are schematic perspective views of exemplary embodiments of the mikvah water filtering and cleaning apparatus wall securing assembly [FIG. 18A], of the first member thereof [FIG. 18B], and of the second member thereof [FIG. 18C], respectively, in accordance with some embodiments of the invention;

FIG. 18D is a schematic perspective view of an exemplary embodiment of the mikvah water filtering and cleaning apparatus wall securing assembly connected to the mikvah water filtering and cleaning apparatus, in accordance with some embodiments of the invention;

FIGS. 19A and 19B are schematic assembled and exploded views, respectively, of an exemplary embodiment of the filter medium removal and replacement device [first type], in accordance with some embodiments of the invention;

FIG. 19C is a schematic perspective view of an exemplary embodiment of the filter medium removal and replacement device [first type] connected to the mikvah water filtering and cleaning apparatus, in accordance with some embodiments of the invention;

FIG. 20 is a schematic diagram illustrating sequential removal of the filter medium, via the filter medium removal and replacement device [first type], in accordance with some embodiments of the invention;

FIGS. 21A and 21B are schematic assembled and exploded views, respectively, of an exemplary embodiment of the filter medium removal and replacement device [second type], in accordance with some embodiments of the invention;

FIG. 21C is a schematic perspective view of an exemplary embodiment of the filter medium removal and replacement device [second type] connected to the mikvah water filtering and cleaning apparatus, in accordance with some embodiments of the invention;

FIG. 22 is a schematic diagram illustrating sequential removal of the filter medium, via the filter medium removal and replacement device [second type], in accordance with some embodiments of the invention;

FIGS. 23A and 23B are photographs showing front and back views, respectively, of an exemplary (actual) prototype mikvah water filtering and cleaning apparatus, in accordance with some embodiments of the invention;

FIG. 24 is a photograph of the outer tube, filter medium, middle tube, and inner tube of the exemplary prototype mikvah water filtering and cleaning apparatus (of FIGS. 23A, 23B), in accordance with some embodiments of the invention;

FIGS. 25A and 25B are photographs of selected components of the exemplary prototype mikvah water filtering and cleaning apparatus (of FIGS. 23A, 23B), in accordance with some embodiments of the invention;

FIGS. 26A and 26B are photographs showing close-up views of the middle tube with the inner tube inside, of the exemplary prototype mikvah water filtering and cleaning apparatus, in accordance with some embodiments of the invention;

FIGS. 27A and 27B are photographs showing close-up perspective top and side views, respectively, of an exemplary embodiment of the middle and inner tubes bottom ends and filter medium bottom end holding member, of the exemplary prototype mikvah water filtering and cleaning apparatus, highlighting the solid portion top surface gradient γ, and the gradient angle α thereof, in accordance with some embodiments of the invention;

FIGS. 28A and 28B are photographs showing close-up views of the lower part of the middle tube with the inner tube inside, held by the middle and inner tubes bottom ends and filter medium bottom end holding member, corresponding to the water flow assembly (WFA) 160, of the exemplary prototype mikvah water filtering and cleaning apparatus, highlighting the middle tube bottommost opening gap n and the bottom ends holding member top surface gradient γ, in accordance with some embodiments of the invention;

FIGS. 28C and 28D are photographs showing additional close-up views of the lower part of the middle tube with the inner tube inside, held by the middle and inner tubes bottom ends and filter medium bottom end holding member, corresponding to the water flow assembly (WFA) 160, of the exemplary prototype mikvah water filtering and cleaning apparatus, highlighting the middle tube bottommost opening gap n, the bottom ends holding member top surface gradient γ, and the bottom ends holding member top surface gradient angle α, in accordance with some embodiments of the invention;

FIGS. 29 and 30 are photographs of the forced water circulation assembly, as assembled [FIG. 29], and the individual components thereof, with an exemplary power supply and controller unit [FIG. 30], of the exemplary prototype mikvah water filtering and cleaning apparatus, in accordance with some embodiments of the invention;

FIGS. 31A and 31B are photographs of the forced water circulation assembly motor housing assembly with the propeller motor inside, as assembled [FIG. 31A], and the individual components thereof [FIG. 31B], of the exemplary prototype mikvah water filtering and cleaning apparatus, in accordance with some embodiments of the invention;

FIGS. 32A-32C are photographs of an exemplary prototype mikvah water filtering and cleaning apparatus wall securing assembly [FIG. 32A], of the first member thereof [FIG. 32B], and of the second member thereof [FIG. 32C], in accordance with some embodiments of the invention;

FIG. 32D is a photograph of an exemplary prototype mikvah water filtering and cleaning apparatus wall securing assembly p300 connected to the exemplary prototype mikvah water filtering and cleaning apparatus, in accordance with some embodiments of the invention;

FIGS. 33A and 33B are photographs of an exemplary prototype filter medium removal and replacement device [first type], as assembled [FIG. 33A], and the individual components thereof [FIG. 33B], in accordance with some embodiments of the invention;

FIG. 33C is a photograph of the exemplary prototype filter medium removal and replacement device [first type] connected to the exemplary prototype mikvah water filtering and cleaning apparatus, in accordance with some embodiments of the invention;

FIGS. 34A and 34B are photographs of an exemplary filter medium removal and replacement device [second type], as assembled [FIG. 34A], and the individual components thereof [FIG. 34B], in accordance with some embodiments of the invention;

FIG. 34C is a photograph of the exemplary prototype filter medium removal and replacement device [second type] connected to the exemplary prototype mikvah water filtering and cleaning apparatus, in accordance with some embodiments of the invention;

FIGS. 35A and 35B are schematic diagrams illustrating exemplary ‘in-mikvah’ application of the exemplary mikvah water filtering and cleaning apparatus, before operation [FIG. 35A], and during operation [FIG. 35B], inside a mikvah, in accordance with some embodiments of the invention;

FIGS. 36 and 37 are photographs showing exemplary actual ‘in-mikvah’ application of the exemplary prototype mikvah water filtering and cleaning apparatus during operation inside a mikvah, in accordance with some embodiments of the invention;

FIGS. 38A and 38B are schematic diagrams illustrating exemplary ‘in-mikvah’ application of the filter medium removal and replacement device [first type], with the exemplary mikvah water filtering and cleaning apparatus (of FIGS. 1A-1D), in accordance with some embodiments of the invention; and

FIGS. 39A and 39B are schematic diagrams illustrating exemplary ‘in-mikvah’ application of the filter medium removal and replacement device [second type], with the exemplary mikvah water filtering and cleaning apparatus (of FIGS. 1A-1D), in accordance with some embodiments of the invention.

### DESCRIPTION OF SPECIFIC EMBODIMENTS OF THE INVENTION

The present invention relates to an apparatus for filtering and cleaning water in a mikvah (Jewish ritual purification bath), which complies with stringent requirements set forth by Jewish religious law (halacha) regarding mikvahs, and applications thereof. The mikvah water filtering and cleaning apparatus includes a specially designed water flow assembly that facilitates continuous unobstructed flow of mikvah water, and prevents formation of standing (static, non-moving, non-flowing) mikvah water, inside the mikvah water filtering and cleaning apparatus. Also disclosed are an exemplary wall securing assembly, for reversibly, securely and stably connecting the mikvah water filtering and cleaning apparatus to a mikvah wall, and exemplary filter medium removal and replacement devices, for facilitating efficient and user-friendly removal and replacement of the filter medium of the mikvah water filtering and cleaning apparatus. The present invention is applicable for filtering and cleaning water in various sized mikvahs, and maintaining the mikvah water highly clean, in full compliance with Jewish religious law (halacha), and in a very efficient, user-friendly, and cost effective manner.

Implementation of the present invention attempts to address, and overcome, at least some of the on-going limitations and problems associated with cleaning water in a mikvah.

The present invention, in exemplary embodiments thereof, includes (at least) the following aspects. An apparatus for filtering and cleaning water in a mikvah, which complies with Jewish religious laws. A water flow assembly, for use in an apparatus for filtering and cleaning water in a mikvah, which complies with Jewish religious laws. A device for holding bottom ends of tubes, for use in an apparatus for filtering and cleaning water in a mikvah, which complies with Jewish religious laws. A tubular device for use in an apparatus for filtering and cleaning water in a mikvah, which complies with Jewish religious laws. A wall securing assembly, for reversibly, securely and stably connecting the mikvah water filtering and cleaning apparatus to a mikvah wall. A filter medium removal and replacement device, for removing and replacing the filter medium of the mikvah water filtering and cleaning apparatus. A method for filtering and cleaning water in a mikvah, which complies with Jewish religious laws.

In exemplary embodiments, combinations of selected individual components or members (for example, in the form of an assembly), and selected individual components or members, of the apparatus for filtering and cleaning water in a mikvah, may be considered as individual ‘stand-alone’ apparatuses or devices, particularly, based on their structural and functional (operational) characteristics and features. Such individual ‘stand-alone’ apparatuses or devices correspond to various ‘sub-combinations’ of the (overall) apparatus for filtering and cleaning water in a mikvah.

For example, in exemplary embodiments, the combination of the middle tube (also referred to as a first tube), the inner tube (also referred to as a second tube), and the middle and inner tubes and filter medium bottom ends holding member (also referred to as a cylindrical tubes bottom ends holding member), corresponds to a ‘sub-combination’ of the (overall) apparatus for filtering and cleaning water in a mikvah, and may be considered as an individual ‘stand-alone’ device, herein, referred to as a ‘water flow assembly’. In such exemplary embodiments, the water flow assembly, being considered as a ‘stand-alone’ apparatus or device, is suitable for use in an apparatus for filtering and cleaning water in a mikvah (such as the herein disclosed apparatus for filtering and cleaning water of a mikvah).

Additionally, for example, in exemplary embodiments, the individual component being the middle and inner tubes and filter medium bottom ends holding member (also referred to as a cylindrical tubes bottom ends holding member), corresponds to another ‘sub-combination’ of the (overall) apparatus for filtering and cleaning water in a mikvah, and may also be considered as an individual ‘stand-alone’ apparatus or device, herein referred to as a ‘device for holding bottom ends of tubes’. In such exemplary embodiments, the device for holding bottom ends of tubes, being considered as a ‘stand-alone’ apparatus or device, is also suitable for use in an apparatus for filtering and cleaning water in a mikvah (such as the herein disclosed apparatus for filtering and cleaning water of a mikvah).

Additionally, for example, in exemplary embodiments, the individual component being the middle tube (also referred to as a first tube), corresponds to another ‘sub-combination’ of the (overall) apparatus for filtering and cleaning water in a mikvah, and may also be considered as an individual ‘stand-alone’ apparatus or device, herein referred to as a ‘tubular device’. In such exemplary embodiments, the tubular device, being considered as a ‘stand-alone’ apparatus or device, is also suitable for use in an apparatus for filtering and cleaning water in a mikvah (such as the herein disclosed apparatus for filtering and cleaning water of a mikvah).

Additionally, for example, in exemplary embodiments, the two types of devices for removal and replacement of a filter medium, although not components of the (overall) apparatus for filtering and cleaning water in a mikvah, may also be considered as individual ‘stand-alone’ apparatus or devices. In such exemplary embodiments, the devices for removal and replacement of a filter medium, being considered as ‘stand-alone’ apparatuses or devices, are also suitable for use with an apparatus for filtering and cleaning water in a mikvah (such as the herein disclosed apparatus for filtering and cleaning water of a mikvah).

The term “mikvah” (commonly also spelled mikveh, or mikve), as used herein, refers to the actual specific religious bath, or bath-like, structure that contains (holds), or is capable of containing (holding), (naturally occurring or derived) water used for the purpose of ritual immersion (of persons, or kitchenware) in Judaism, in order to achieve ritual and spiritual purity of that which is immersed. Accordingly, a mikvah may be the actual specific bath, or bath-like, structure which is partially or entirely filled with, and containing (holding), water, or, alternatively, may be the actual specific bath, or bath-like, structure which is empty, yet is capable of containing (holding) water. Per such terminology, the mikvah (bath or bath-like) structure is ordinarily housed in a larger, more encompassing structure in the form of a building, an abode, or a room. Such larger, more encompassing structure (building, abode, room), in a more general sense, is commonly also referred to as a ‘mikvah’, without specifically distinguishing between it and the herein reference made to the (smaller) actual specific religious bath or bath-like structure that is housed in the larger structure.

The phrase “water in a mikvah”, and “water in the mikvah”, as used herein, refer to water that is contained (held) in a (the) mikvah (i.e., the bath or bath-like structure). Herein, for brevity, these phrases are also referred to by, and synonymous with, the phrase “mikvah water”.

The phrases “apparatus for filtering and cleaning water in a mikvah”, and “method for filtering and cleaning water in a mikvah”, herein, are also referred to by, and synonymous with, the phrases “mikvah water filtering and cleaning apparatus”, and “mikvah water filtering and cleaning method”, respectively.

For purposes of further understanding exemplary embodiments of the present invention, in the following illustrative description thereof, reference is made to the figures. Throughout the following description and accompanying drawings, same reference numbers refer to same objects, components, elements, or features. It is to be understood that the invention is not necessarily limited in its application to particular details of construction or/and arrangement of exemplary device, apparatus, or/and system components, or to particular sequential ordering of exemplary method steps or procedures, set forth in the following illustrative description. The invention is capable of having other exemplary embodiments, or/and of being practiced or carried out in various alternative ways.

Throughout the description and accompanying drawings, physical orientational (location, position) and directional type terms “top”, and “bottom”, are used for indicating relative orientation (location, position) and direction of the stated or illustrated object, component, element, or structural feature of the herein disclosed mikvah water filtering and cleaning apparatus. For example, the term “top”, as used herein, refers to the (vertically or longitudinally) ‘upper’, ‘upward’, or ‘upwardly facing’ location, position, or direction of the stated or illustrated object/s, component/s, element/s, or structural feature/s of the herein disclosed mikvah water filtering and cleaning apparatus. For example, the term “bottom”, as used herein, refers to the (vertically or longitudinally) ‘lower’, ‘downward’, or ‘downwardly facing’ location, position, or direction of the stated or illustrated object/s, component/s, element/s, or structural feature/s of the herein disclosed mikvah water filtering and cleaning apparatus. With respect to the (physical) sides of a printed page, or of a computer display screen, located opposite a viewer thereof, the terms “top” and “bottom”, as used herein, in a non-limiting manner, correspond to the (vertically or longitudinally) top and bottom sides or side portions, respectively, of the printed page, or of the computer display screen.

Additionally, for application and operation of the mikvah water filtering and cleaning apparatus, the intended physical orientational positioning of the apparatus in a mikvah is as shown in the figures, namely, longitudinally vertical, spanning from the topmost part or portion of the apparatus to the bottommost part or portion of the apparatus.

The herein disclosed invention, and aspects thereof (i.e., the mikvah water filtering and cleaning apparatus, the water flow assembly, the device for holding bottom ends of tubes, the tubular device, the filter medium removal and replacement device, and the mikvah water filtering and cleaning method), include, or, alternatively, consist essentially of, or, alternatively, consist of, the following illustratively described structural and functional (operational) features thereof.

The apparatus for filtering and cleaning water in a mikvah, which complies with Jewish religious laws, in a non-limiting manner, and in some embodiments, includes: an outer tube, a tubular filter medium, a middle tube, an inner tube, and a forced water circulation assembly.

In such exemplary embodiments, the outer tube longitudinally extends downwardly and upwardly between outer tube top and bottom ends, and is configured with at least one outer tube mikvah water inlet opening and at least one outer tube mikvah water outlet opening.

The tubular filter medium longitudinally extends downwardly and upwardly between filter medium top and bottom ends, and is removably, collaterally positioned within the outer tube.

The middle tube longitudinally extends downwardly and upwardly between middle tube top and bottom ends, and is configured with a plurality of middle tube openings. The middle tube is (longitudinally) collaterally positioned within and along, so as to support, the filter medium.

The inner tube longitudinally extends downwardly and upwardly between inner tube top and bottom ends, and is configured with a plurality of inner tube openings. The inner tube is collaterally securely positioned within and along the middle tube, such that the inner tube openings are spatially adjacently aligned and nearly coincide with the middle tube openings, so as to facilitate continuous unobstructed flow of filtered and cleaned mikvah water from the middle tube openings into and through the inner tube openings.

The forced water circulation assembly includes a propeller, a propeller shaft, and a propeller shaft motor assembly, and is operatively connected to the outer, middle, and inner tubes. The forced water circulation assembly facilitates forced continuous and directional flow, and, filtering and cleaning, of the mikvah water from the mikvah into and through at least one outer tube mikvah water inlet opening, into and through the filter medium, into and through middle and inner tube openings, and, into and through at least one outer tube mikvah water outlet opening.

The water flow assembly, for use in an apparatus for filtering and cleaning water in a mikvah, which complies with Jewish religious laws, in a non-limiting manner, and in some embodiments, includes: a first tube, a second tube, and a cylindrical tubes bottom ends holding member.

In such exemplary embodiments, the first tube longitudinally extends downwardly and upwardly between first tube top and bottom ends, and is configured with a plurality of first tube openings. The first tube has a first tube bottom end portion configured with first tube bottommost openings whose bottom peripheries are open in a form of spaces or gaps that are parallel to, and coincide with, the first tube bottom end, whereby the spaces or gaps facilitate continuous unobstructed flow of filtered and cleaned mikvah water which enters and passes through the first tube bottom end portion.

The second tube longitudinally extends downwardly and upwardly between second tube top and bottom ends, and is configured with a plurality of second tube openings. The second tube has a second tube bottom end portion configured with second tube bottommost openings, and the second tube is collaterally (longitudinally) securely (firmly, tightly, snugly) positioned within and along the first tube, such that the plurality of second tube openings are spatially adjacently aligned and nearly coincide with the plurality of first tube openings, so as to facilitate continuous unobstructed flow of filtered and cleaned mikvah water from the first tube openings into and through the second tube openings.

The cylindrical tubes bottom ends holding member is configured for holding the first tube bottom end and the second tube bottom end, and is configured for facilitating continuous and unobstructed flow of filtered and cleaned mikvah water that enters, passes through, and exits the first tube openings and the second tube openings.

The device for holding bottom ends of tubes, for use in an apparatus for filtering and cleaning water in a mikvah, which complies with Jewish religious laws, in a non-limiting manner, and in some embodiments, includes: a cylindrical encircling solid portion that encircles a cylindrical central hollow portion. The encircling solid portion is configured for holding a first tube bottom end and a second tube bottom end, and the central hollow portion facilitates passage therethrough of filtered and cleaned mikvah water.

The method for filtering and cleaning water in a mikvah, which complies with Jewish religious laws, in a non-limiting manner, and in some embodiments, includes: (i) placing the herein disclosed mikvah water filtering and cleaning apparatus inside the mikvah, either before or after the mikvah is filled with water; and (ii) operatively connecting the motor of the forced water circulation assembly of the mikvah water filtering and cleaning apparatus to a power supply and controller unit; and (iii) for the mikvah filled with water, activating the motor, so as to facilitate forced continuous and directional flow, and, filtering and cleaning, of the mikvah water from the mikvah into, through, and out from, the mikvah water filtering and cleaning apparatus.

### Mikvah Water Filtering and Cleaning Apparatus, and Components Thereof

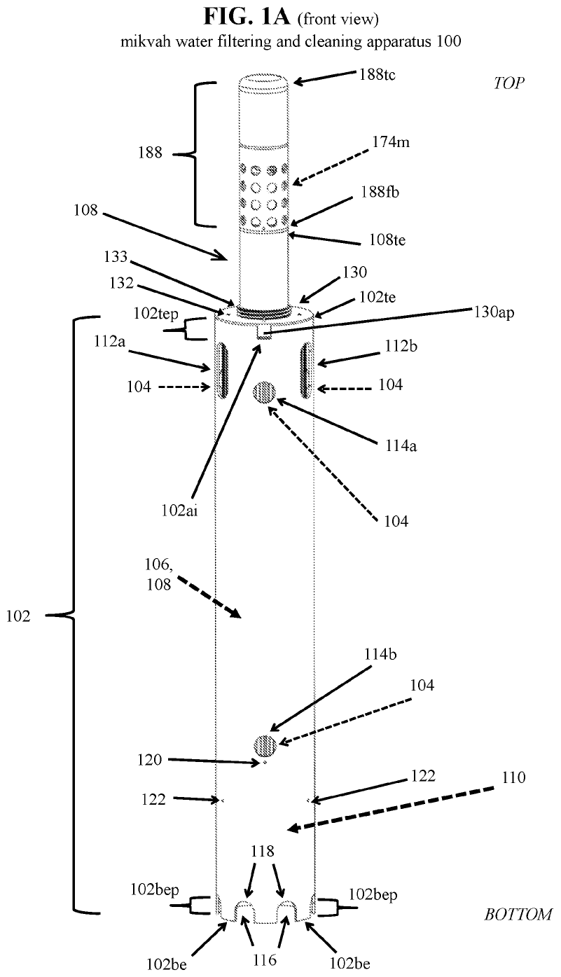

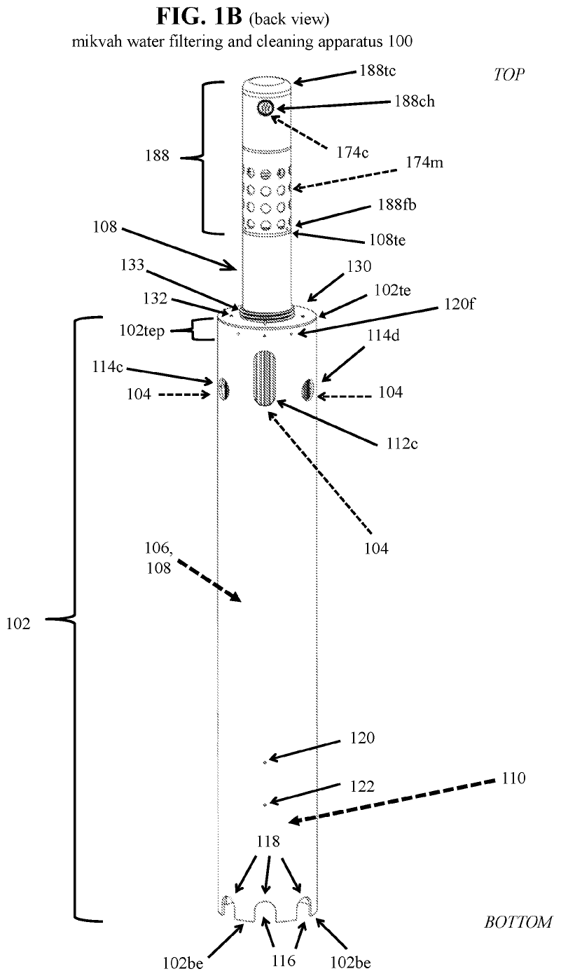

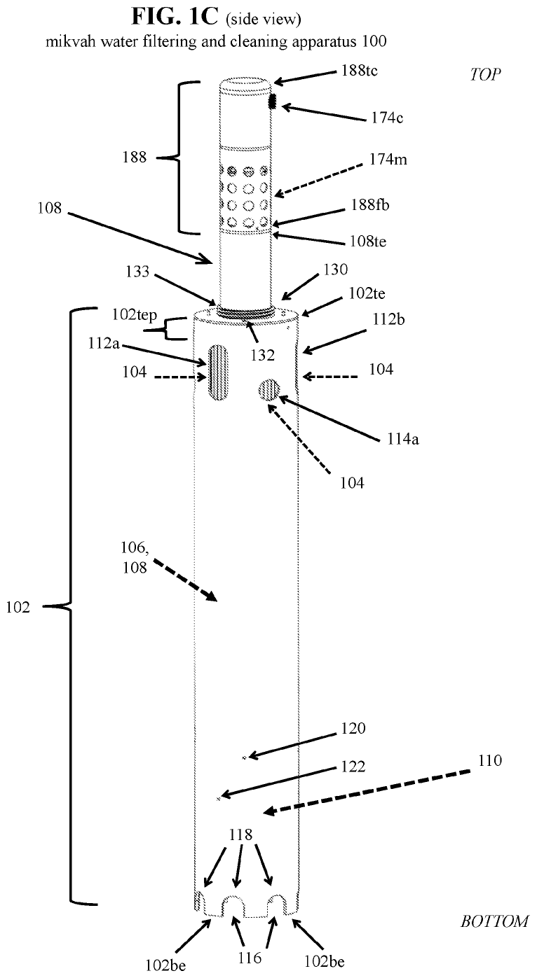

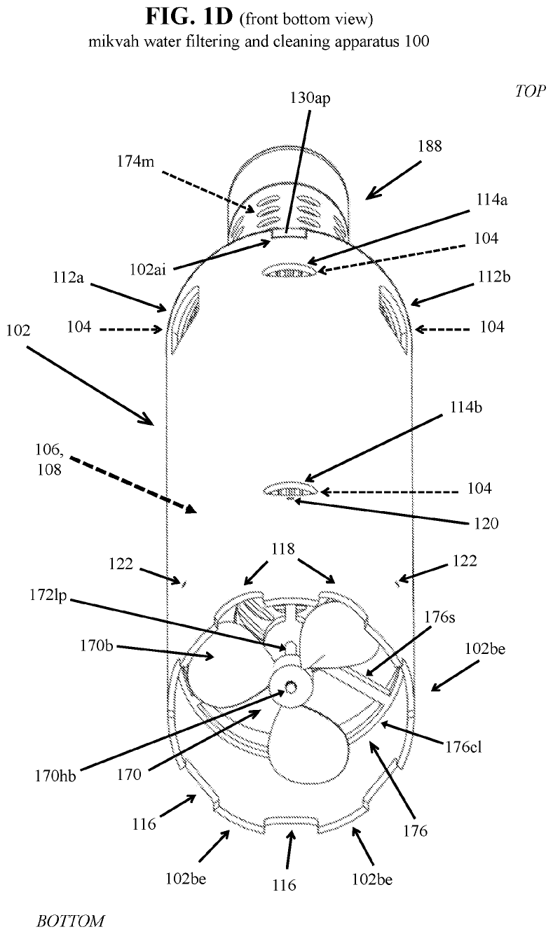

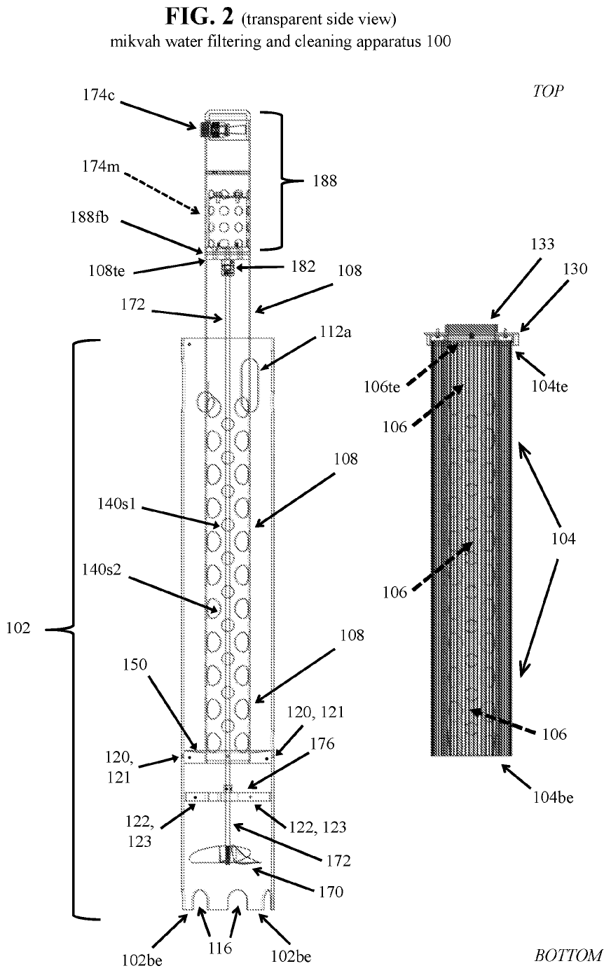

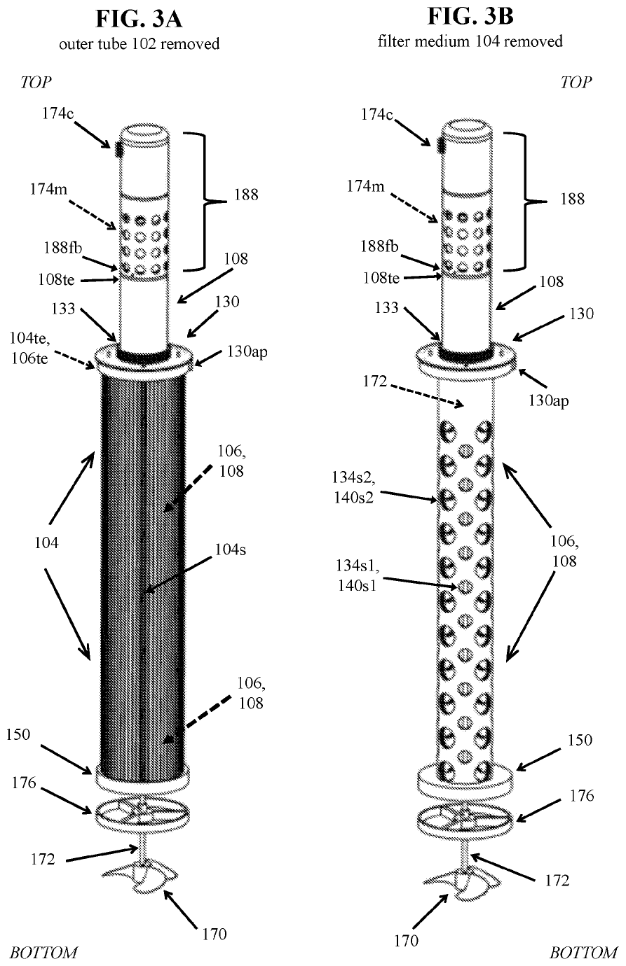

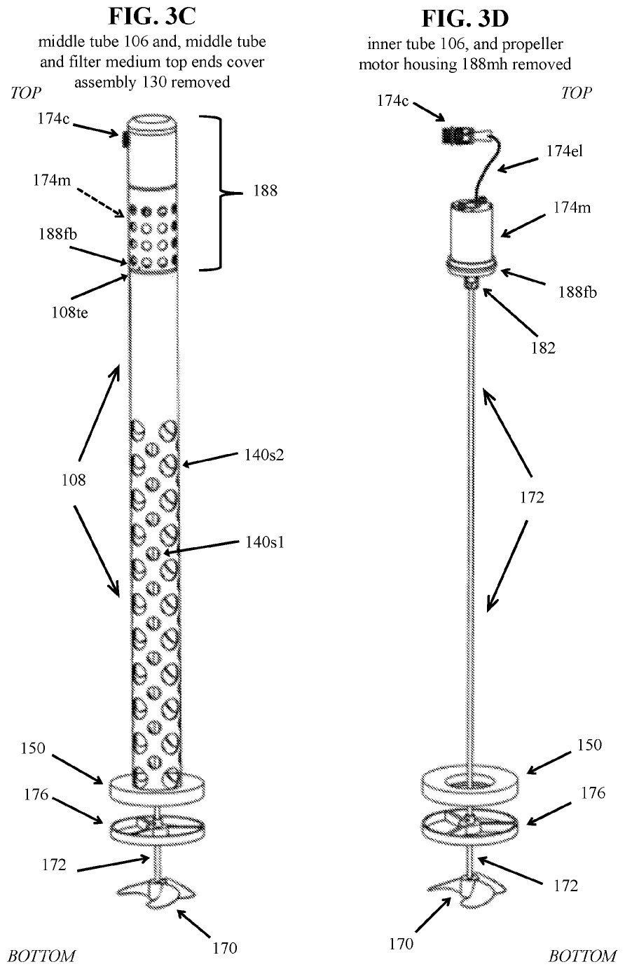

Referring now to the drawings, FIGS. 1A, 1B, 1C, and 1D are schematic perspective views of the front, back, side, and front bottom, respectively, of an exemplary embodiment of the mikvah water filtering and cleaning apparatus [indicated as, and referred to by, reference number 100]. FIG. 2 is a schematic transparent side view of the exemplary embodiment of the mikvah water filtering and cleaning apparatus 100 (of FIGS. 1A-1D). FIGS. 3A-3D are schematic perspective views illustrating sequential undressing (removal of selected components) of the exemplary mikvah water filtering and cleaning apparatus 100 (of FIGS. 1A-1D).

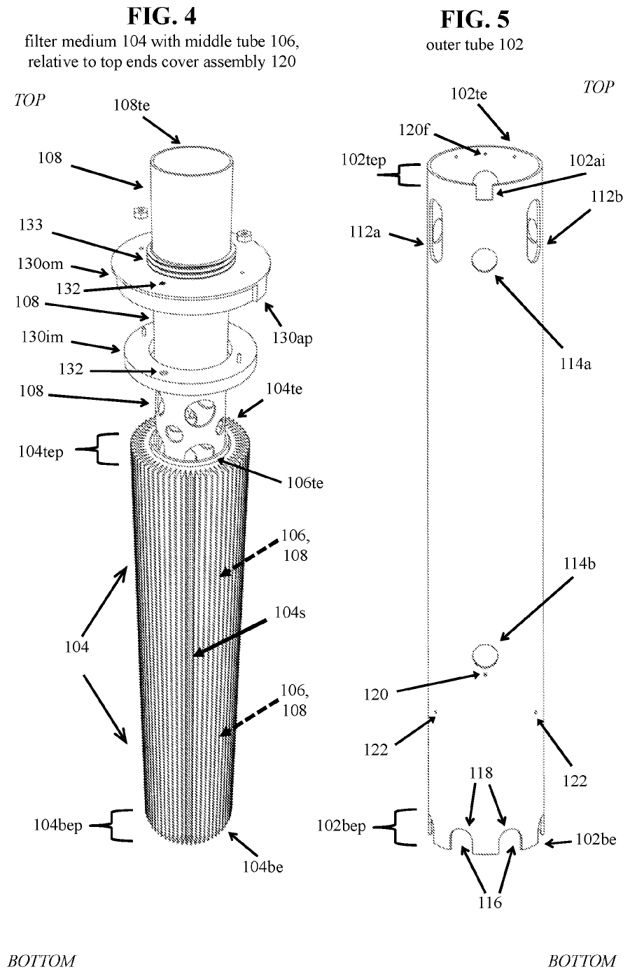

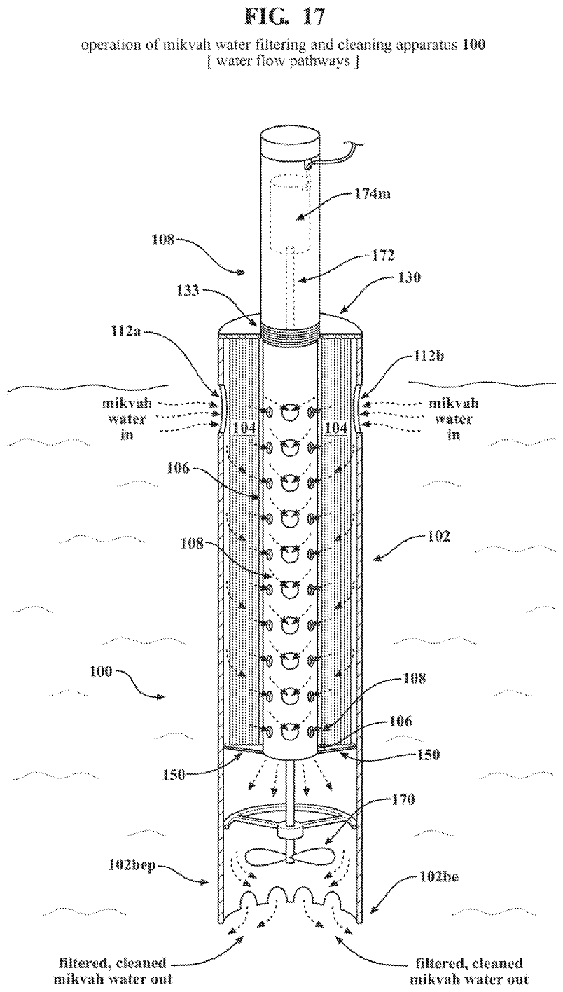

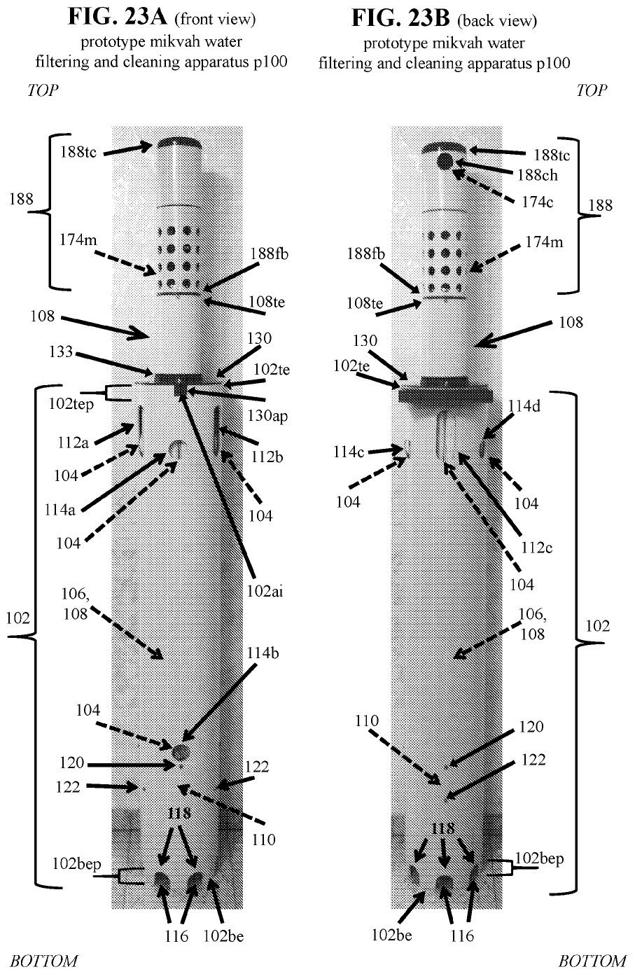

FIGS. 4 through 16 are different schematic views of exemplary embodiments of the several components (and structural features thereof) of the exemplary mikvah water filtering and cleaning apparatus 100 (of FIGS. 1A-1D). FIG. 17 is a schematic cut-away view of an exemplary embodiment of the mikvah water filtering and cleaning apparatus 100 (of FIGS. 1A-1D) in mikvah water, illustrating exemplary operation thereof, highlighting sequential water flow pathways of mikvah water entering into, flowing inside and through, and exiting from, the mikvah water filtering and cleaning apparatus 100. FIGS. 23A through 31B are photographs of an exemplary (actual) prototype mikvah water filtering and cleaning apparatus p100, and the several components (and structural features thereof), which respectively correspond to the exemplary mikvah water filtering and cleaning apparatus 100, and the several components (and structural features thereof).

In exemplary embodiments, the apparatus 100 for filtering and cleaning water in a mikvah includes: an outer tube 102, a tubular filter medium 104, a middle tube 106, an inner tube 108, and a forced water circulation assembly 110. The filter medium 104, the middle tube 106, the inner tube 108, and the forced water circulation assembly 110, are present in the apparatus 100 shown in FIGS. 1A-1D, as indicated by the dashed line arrows, but, only partly viewable. These apparatus components (and components thereof) are additionally viewable in FIGS. 2-16.

### Outer Tube

Mikvah water (from the mikvah) enters the mikvah water filtering and cleaning apparatus 100 via the outer tube 102, for example, as shown in FIG. 17. Filtered and cleaned mikvah water exits the mikvah water filtering and cleaning apparatus 100 via the outer tube 102. Thus, the outer tube 102 is configured for facilitating both: (i) entry of mikvah water from the mikvah into the mikvah water filtering and cleaning apparatus 100, and (ii) exit of filtered and cleaned mikvah water from the mikvah water filtering and cleaning apparatus 100 back into the mikvah.

The outer tube 102 longitudinally extends downwardly and upwardly between the outer tube top end 102te and the outer tube bottom end 102be, and is configured with at least one outer tube mikvah water inlet opening (hole or slit) and with at least one outer tube mikvah water outlet opening (hole or slit). The outer tube 102 includes an outer tube top end portion 102tep (whose top end corresponds to the outer tube top end 102te), and an outer tube bottom end portion 102bep (whose bottom end corresponds to the outer tube bottom end 102be).

FIG. 5 shows a schematic perspective view of an exemplary embodiment of the outer tube 102, as a ‘stand-alone’ component, which is part of the overall mikvah water filtering and cleaning apparatus 100. The outer tube 102 is configured with any number of outer tube mikvah water inlet openings (holes or/and slits). For example, as shown in at least FIGS. 1A-1D, and 5, the outer tube 102 is configured with seven outer tube mikvah water inlet openings 112a, 112b, 112c, 114a, 114b, 114c, 114d. One or more of the at least one outer tube mikvah water inlet opening (hole or slit) has/have any of numerous different geometrical shapes, for example, (partly or fully) circular, elliptical, trigonal, square, rectangular, heptagonal, hexagonal, heptagonal, octagonal, etc. For example, as shown in at least FIGS. 1A-1D, and 5, the outer tube mikvah water inlet openings 112a, 112b, and 112c have an elliptical shape, and the outer tube mikvah water inlet openings 114a, 114b, 114c, and 114d have a fully circular shape.

The outer tube 102 is configured with any number of outer tube mikvah water outlet openings (holes or/and slits). In exemplary embodiments, the outer tube mikvah water outlet openings are located in the outer tube bottom end portion 102bep. For example, as shown in at least FIGS. 1A-1D, 2, 5, and 17, the outer tube 102 is configured with one outer tube mikvah water outlet opening 116 located in and along (i.e., occupying the volumetric space defined and encircled by) the full circumferential periphery of the (arched) outer tube bottom end portion 102bep and the outer tube bottom end 102be thereof.

In exemplary embodiments, the outer tube bottom end portion 102bep is configured in a shape of one or more arches, ridges, or/and crests. In exemplary embodiments, the arches, ridges, or/and crests, have same shape size dimensions (width, height, length). Alternatively, in exemplary embodiments, the arches, ridges, or/and crests, have different shape size dimensions, or have a combination of same and different shape size dimensions, namely, one or more of the arches, ridges, or/and crests have shape size dimensions which are different from the shape size dimensions of one or more other arches, ridges, or/and crests that are configured in the outer tube bottom end portion 102bep. For example, as shown in at least FIGS. 1A-1D, 5, and 17, the outer tube bottom end portion 102bep is configured in a shape of arches 118 which have same shape size dimensions (arch height or length, arch width).

With reference again to FIGS. 1A-1D, and 5, in exemplary embodiments, the outer tube 102 includes a plurality of small sized holes (configured, for example, for screws), for example, small sized holes 120 and 122, that facilitate firm connection (attachment) of selected components of the mikvah water filtering and cleaning apparatus 100 to the outer tube 102. The small sized holes 120 and 122 are present, but not viewable in FIGS. 1A-1D which show the assembled mikvah water filtering and cleaning apparatus 100, wherein the screw holes 120 and 122 are occupied by respective screws, and only the screw heads are viewable in FIGS. 1A-1D. FIG. 5 shows an exemplary plurality of the small sized holes 120 and 122. In exemplary embodiments, for example, as shown in FIG. 2 (left side), small sized holes 120 in the lower part of the outer tube 102 are configured for firmly connecting (attaching) the middle and inner tubes bottom ends and filter medium bottom end holding member 150 to the inside surface of the lower part of the outer tube 102. Additionally, therein, small sized holes 122 in the lower part of the outer tube 102 are configured for firmly connecting (attaching) the propeller shaft aligning and holding member 176 (of the forced water circulation assembly 110) to the inside surface of the lower part of the outer tube 102.

### Outer Tube Alignment Indentation

In exemplary embodiments, the outer tube 102 is configured with at least one alignment indentation (cut out portion or notch), that facilitates spatial (i.e., vertical [top to bottom longitudinal] or/and horizontal [sideways latitudinal]) alignment of structural features (for example, openings, holes) of selected components (particularly, of the middle tube 106 and the inner tube 108) of the mikvah water filtering and cleaning apparatus 100. In turn, such spatial alignment of structural features of selected components of the mikvah water filtering and cleaning apparatus 100 facilitates continuous unobstructed flow of filtered and cleaned mikvah water inside of, and through, the mikvah water filtering and cleaning apparatus 100, for example, from middle tube openings (holes or/and slits) into and through inner tube openings (holes or/and slits) that are spatially adjacently aligned and nearly coincide with the middle tube openings (holes or/and slits). Such spatial alignment, and continuous unobstructed flow of mikvah water, prevent formation of standing (static, non-moving, non-flowing) mikvah water inside the mikvah water filtering and cleaning apparatus 100, and also contribute to achieving high mikvah water throughput and processing (filtering and cleaning), during operation of the apparatus 100.

The at least one outer tube alignment indentation is/are located at any one or more respective top to bottom longitudinal position(s) along the outer tube 102. In exemplary embodiments, each outer tube alignment indentation has any one of numerous different geometrical shapes, for example, (partly or fully, opened or closed) circular, elliptical, trigonal, square, rectangular, heptagonal, hexagonal, heptagonal, octagonal, etc. Each outer tube alignment indentation is configured (shaped and sized) so as to facilitate secure (firm, tight, snug) fitting and holding of a complementary (mated, matched) alignment protrusion (projection) configured in the filter medium and middle tube top ends cover assembly 130, as further illustratively described below.

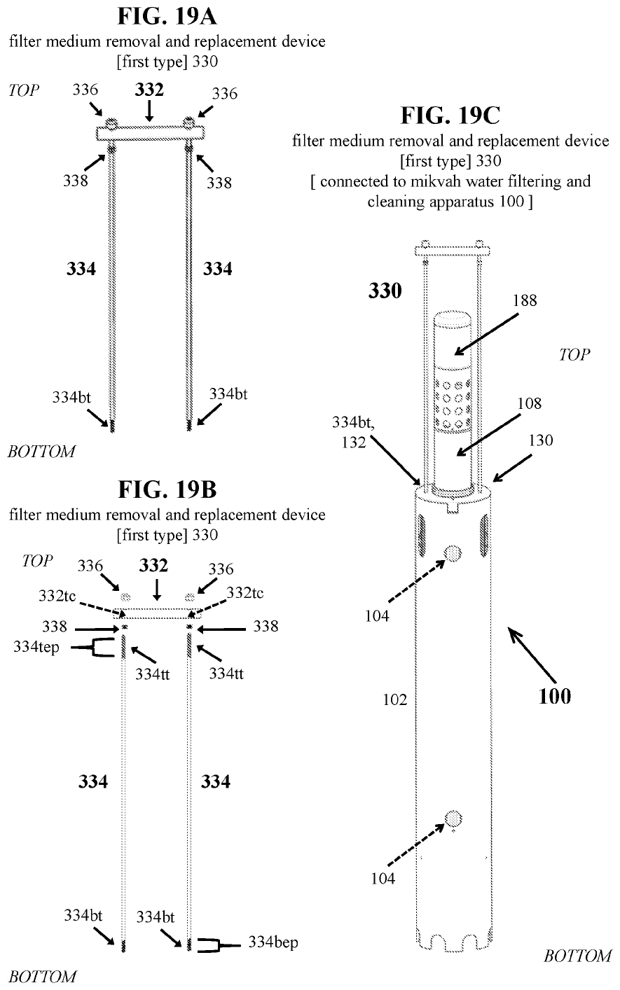

For example, as particularly shown in FIG. 5, and also viewable in FIGS. 1A, 1D, and 17, the outer tube top end portion 102tep is configured with an exemplary single open square or rectangular shaped outer tube alignment indentation 102ai. Exemplary outer tube alignment indentation 102ai facilitates secure (firm, tight, snug) fitting and holding of a complementary (mated, matched) alignment protrusion (projection), for example, square or rectangular shaped top ends cover assembly alignment protrusion 130ap, configured along the lower wall of the outer member 130om of the filter medium and middle tube top ends cover assembly 130, for example, as shown in FIGS. 4 and 11A. Such secure (firm, tight, snug) fitting and holding of top ends cover assembly alignment protrusion 130ap by, and within, the outer tube alignment indentation 102ai, is particularly viewable, for example, in FIGS. 1A and 1D, and also in FIGS. 19C and 21C.

### Tubular Filter Medium

Upon exiting the outer tube 102, mikvah water enters, passes through, is filtered and cleaned, exits the tubular filter medium 104, and enters into and through the spatially adjacently aligned and nearly coinciding openings (holes or/and slits) of the middle tube 106 and the inner tube 108, for example, as shown in FIG. 17.

The tubular filter medium (herein, also referred to as the filter medium) 104 longitudinally extends downwardly and upwardly between the filter medium top end 104te and the filter medium bottom end 104be, and is removably, collaterally positioned within and along the outer tube 102. The filter medium 104 includes a filter medium top end portion 104tep (whose top end corresponds to the filter medium top end 104te), and a filter medium bottom end portion 104bep (whose bottom end corresponds to the filter medium bottom end 104be). The filter medium 104 has an outer diameter that is less than the inner diameter of the outer tube 102, and has a top to bottom longitudinal length (height) that is essentially the same as that of the middle tube 106.

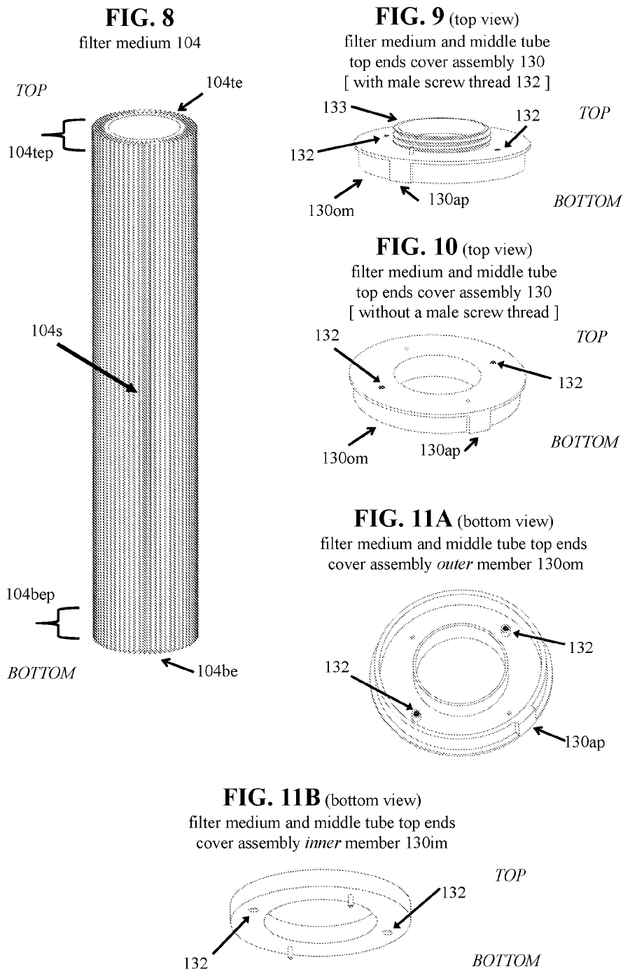

FIG. 8 shows a schematic perspective view of an exemplary embodiment of the filter medium 104, as a ‘stand-alone’ component, which is part of the overall mikvah water filtering and cleaning apparatus 100. In exemplary embodiments, for example, as viewable in FIGS. 2, 3A, 4, 6, and 7, inside the outer tube 102, the tubular filter medium 104 is securely (firmly, tightly, snugly) wrapped around, and surrounds, the middle tube 106 along its entire top to bottom longitudinal length (height).

In exemplary embodiments, the filter medium 104 includes one or more top to bottom longitudinally extending seams, for example, a single seam 104s as shown in FIGS. 3A, 4, 6, 7, and 8. Each such seam indicates the line of junction formed by joining, connecting, or lapping (e.g., via sewing, stitching, gluing) together two (top to bottom longitudinally extending) ends, sections, or separate pieces, of the filter medium material along their margins (edges).

### Filter Medium and Middle Tube Top Ends Cover Assembly

The filter medium top end 104te and the middle tube top end 106te are covered by a filter medium and middle tube top ends cover assembly 130 (herein, also referred to as the top ends cover assembly 130), for example, as particularly viewable in FIGS. 2 (right side) and 3A. In exemplary embodiments, as particularly viewable in FIGS. 4, and 9-11B, the filter medium and middle tube top ends cover assembly (top ends cover assembly) 130 is cylindrical in form and includes an outer member 130om and an inner member 130im securely (firmly, tightly, snugly) positioned and held within the outer member 130om. FIG. 4 is an exploded perspective view of an exemplary embodiment of the filter medium 104 with the middle tube 106 inside thereof, relative to the inner tube 108 and to the filter medium and middle tube top ends cover assembly (top ends cover assembly) 130 [outer member 130om and inner member 130im].

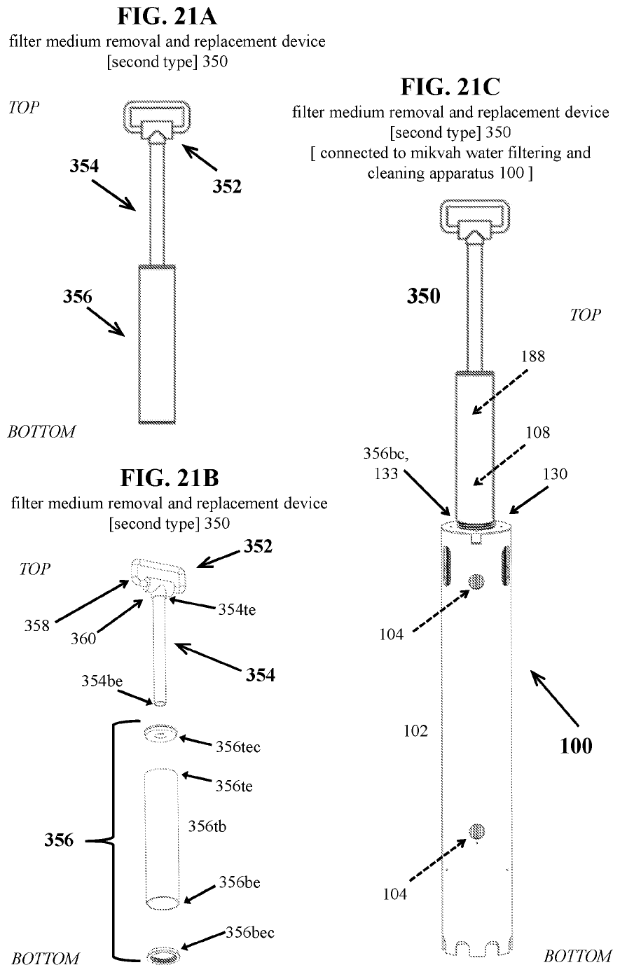

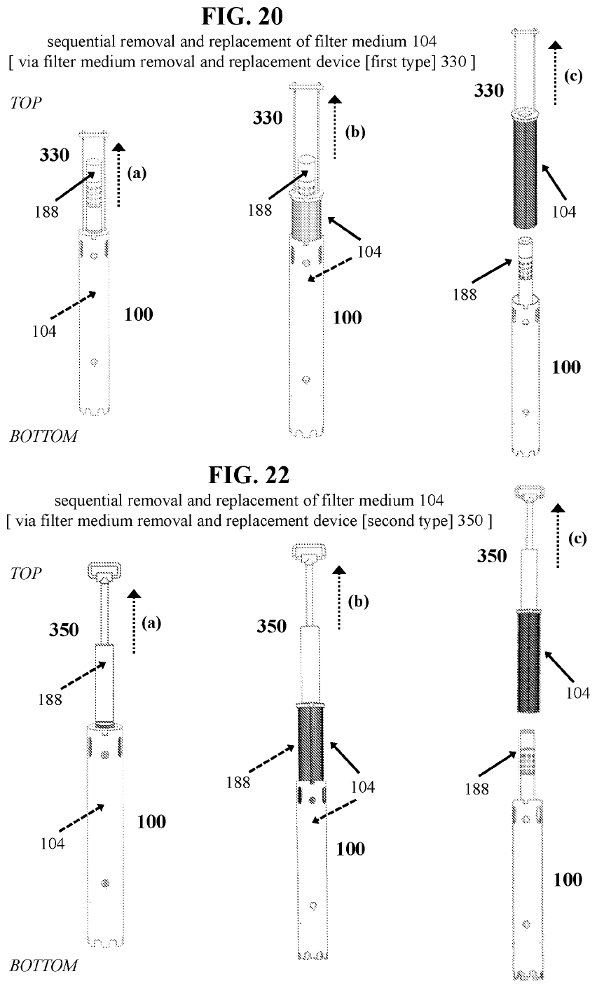

In exemplary embodiments, the outer and inner members 130om and 130im, respectively, of the filter medium and middle tube top ends cover assembly 130 are configured with small screw threads (for example, small female screw threads 132 as shown in the figures). The (female) screw threads facilitate operative connection of the mikvah water filtering and cleaning apparatus to a filter medium removal and replacement device, via correspondingly mated small (male) screw threads thereof. For example, as shown in FIGS. 19A-19C, and 20, the two (female) screw threads 132 facilitate operative connection of the mikvah water filtering and cleaning apparatus 100 to the filter medium removal and replacement device [first type] 330, via correspondingly mated two small (male) screw threads 334bt thereof.

Alternatively, or additionally (for example, as shown in the figures), in exemplary embodiments, the outer member 130om of the filter medium and middle tube top ends cover assembly 130 is configured with a single large screw thread (for example, single large male screw thread 133 as shown in the figures). The (male) screw thread 133 facilitates operative connection of the mikvah water filtering and cleaning apparatus 100 to a (second type of) filter medium removal and replacement device (for example, 350 shown in FIGS. 21A-21C, and 22), via a correspondingly mated single large (female) screw thread thereof. In exemplary embodiments, the screw thread 133 is structurally integral to, and part of, the outer member 130om. Alternatively, in exemplary embodiments, the screw thread 133 is a structurally separate component that is connected (attached) to the outer member 130om of the top ends cover assembly 130.

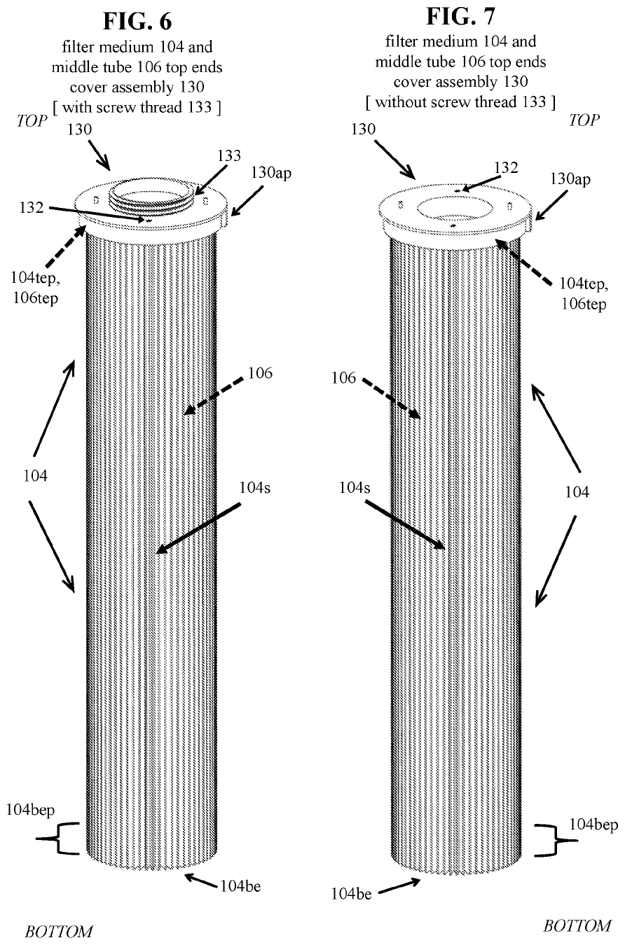

FIGS. 6 and 7 are schematic perspective views of an exemplary embodiment of the filter medium 104 with the middle tube 106 inside thereof, covered by the filter medium and middle tube top ends cover assembly 130 (with an exemplary large male screw thread 133 [FIG. 6], and without a large male screw thread [FIG. 7]). FIGS. 9 and 10 are schematic close-up perspective views of the top side of an exemplary embodiment of the filter medium and middle tube top ends cover assembly 130 (with a large male screw thread 133 [FIG. 9] and without a large male screw thread [FIG. 10]). FIGS. 11A and 11B are schematic close-up perspective views of the bottom sides of exemplary embodiments of the outer member 130om [FIG. 11A], and of the inner member 130im [FIG. 11B], respectively, of the filter medium and middle tube top ends cover assembly 130.

### Top Ends Cover Assembly Alignment Protrusion

In exemplary embodiments, the filter medium and middle tube top ends cover assembly 130 is configured with at least one alignment protrusion (projection), that facilitates spatial (i.e., vertical [top to bottom longitudinal] or/and horizontal [sideways latitudinal]) alignment of structural features (for example, openings, holes) of selected components (particularly, of the middle tube 106 and the inner tube 108) of the mikvah water filtering and cleaning apparatus 100. In turn, such spatial alignment of structural features of selected components of the mikvah water filtering and cleaning apparatus 100 facilitates continuous unobstructed flow of filtered and cleaned mikvah water inside of, and through, the mikvah water filtering and cleaning apparatus 100, for example, from middle tube openings (holes or/and slits) into and through inner tube openings (holes or/and slits) that are spatially adjacently aligned with and nearly coincide with the middle tube openings (holes or/and slits). Such spatial alignment, and continuous unobstructed flow of mikvah water, prevent formation of standing (static, non-moving, non-flowing) mikvah water inside the mikvah water filtering and cleaning apparatus 100, and also contribute to achieving high mikvah water throughput and processing (filtering and cleaning), during operation of the apparatus 100.

In exemplary embodiments, each top ends cover assembly alignment protrusion (projection) has any of numerous different geometrical shapes, for example, (partly or fully) circular, elliptical, trigonal, square, rectangular, heptagonal, hexagonal, heptagonal, octagonal, etc. Each top ends cover assembly alignment protrusion (projection) is configured (shaped and sized) so as to facilitate secure (firm, tight, snug) fitting within, and holding by, a complementary (mated, matched) alignment indentation (cut out portion or notch) configured in the outer tube 102, as illustratively described hereinabove. For example, as particularly shown in FIGS. 9, 10, and 11A, the top ends cover assembly 130, for example, in the outer member 130om thereof, is configured with an exemplary single square or rectangular shaped alignment protrusion 130ap. Exemplary top ends cover assembly alignment protrusion 130ap is configured (shaped and sized) so as to facilitate secure (firm, tight, snug) fitting within, and holding by, the complementary (mated, matched) outer tube alignment indentation 102ai, as particularly viewable in FIGS. 1A and 1D, and also in FIGS. 19C and 21C.

### Middle Tube

Upon exiting the filter medium 104, filtered and cleaned mikvah water enters, passes through, and exits the middle tube 106. More specifically, upon exiting the filter medium 104, filtered and cleaned mikvah water enters and passes through the openings (holes or/and slits) of the middle tube 106, and then immediately enters and passes through the openings (holes or/and slits) of the inner tube 108 (which are spatially adjacently aligned and nearly coincide with the openings (holes or/and slits) of the middle tube 106), for example, as shown in FIG. 17.

The middle tube 106 longitudinally extends downwardly and upwardly between the middle tube top end 106te and the middle tube bottom end 106be, and is configured with a plurality of middle tube openings (holes or/and slits). The middle tube 106 is longitudinally collaterally entirely (fully) positioned within and along, and surrounding, the tubular filter medium 104, so as to support the tubular filter medium 104 along its entire top to bottom longitudinal length (height). The middle tube 106 includes a middle tube top end portion 106tep (whose top end corresponds to the middle tube top end 106te), and a middle tube bottom end portion 106bep (whose bottom end corresponds to the middle tube bottom end 106be). The middle tube 106 has an outer diameter that is less than the inner diameter of the filter medium 104, and has a top to bottom longitudinal length (height) that is essentially the same as that of the filter medium 104, as shown, for example, in FIG. 2 (right side).

As viewable in FIGS. 2 (right side), 3A, 4, 6, and 7, inside the outer tube 102, the tubular filter medium 104 is securely (firmly, tightly, snugly) wrapped around, surrounds, and is supported by, the middle tube 106 along the entire top to bottom longitudinal length (height) of the filter medium 104.

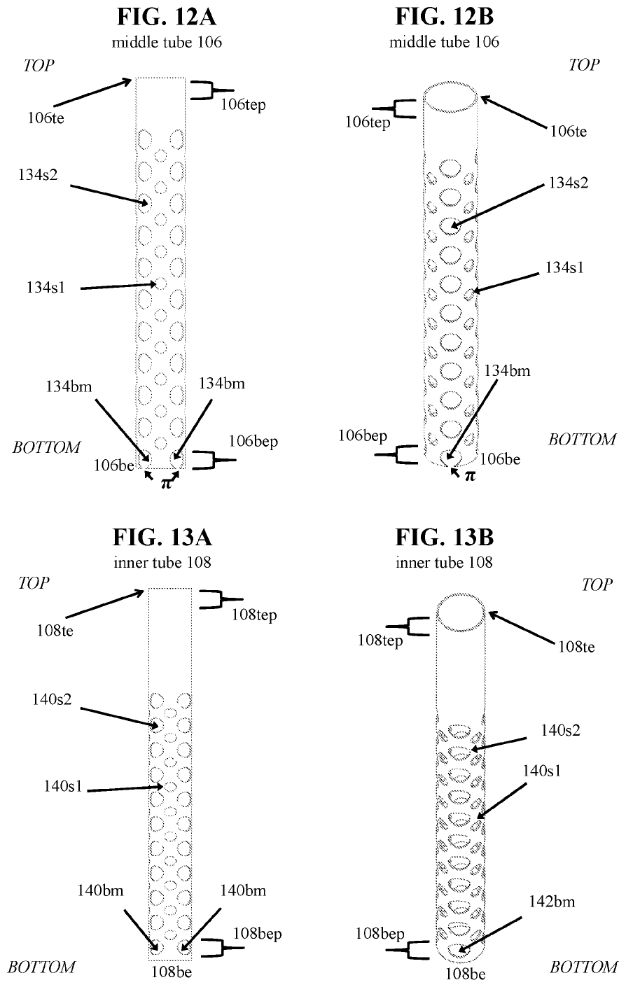

FIGS. 12A and 12B show schematic front and perspective views, respectively, of an exemplary embodiment of the middle tube 106, as a ‘stand-alone’ component, which is part of the overall mikvah water filtering and cleaning apparatus 100. The middle tube 106 is configured with any number of openings (holes or/and slits). For example, as shown in FIGS. 2 (right side), 3B, 12A, and 12B, the middle tube 106 is configured with an exemplary number of more than fifty middle tube openings 134s1 and 134s2. The middle tube openings (holes or slits) have any of numerous different geometrical shapes, for example, (partly or fully) circular, elliptical, trigonal, square, rectangular, heptagonal, hexagonal, heptagonal, octagonal, etc. As shown in FIGS. 2 (right side), 3B, 12A, and 12B, the middle tube openings 134s1 and 134s2 are in the form of holes having a fully circular shape. In exemplary embodiments, the middle tube 106 is configured with the middle tube openings having two or more different geometrical shapes or/and sizes. Such exemplary embodiments are shown in FIGS. 2 (right side), 3B, 12A, and 12B, wherein the middle tube 106 is configured with a first plurality of a first size circular shaped middle tube openings (holes) 134s1, and a second plurality of a second (larger) size circular shaped middle tube openings (holes) 134s2. In alternative exemplary embodiments, the middle tube 106 is configured with all of the middle tube openings (holes or/and slits) having the same geometrical shape and size (height or length, width).

In exemplary embodiments, for example, as shown in FIGS. 12A and 12B, in the middle tube 106, the middle tube bottom end portion 106bep is configured with bottommost openings (holes or/and slits) 134bm, whose bottom peripheries (boundaries) are open, for example, in the form of spaces or gaps R that are parallel to, and coincide (are collinear) with, the middle tube bottom end 106be. The spaces or gaps R in the bottommost openings (holes) 134bm facilitate continuous unobstructed flow of filtered and cleaned mikvah water which passes through and exits the filter medium 104 and then enters and passes through the middle tube bottom end portion 106bep. Such spaces or gaps R in the bottommost openings (holes) 134bm of the middle tube 106, and continuous unobstructed flow of mikvah water, prevent formation of standing (static, non-moving, non-flowing) mikvah water inside the mikvah water filtering and cleaning apparatus 100, and also contribute to achieving high mikvah water throughput and processing (filtering and cleaning), during operation of the apparatus 100.

In exemplary embodiments, with reference to FIGS. 3B, and 12A-15, the middle tube 106 is also configured for collateral secure (firm, tight, snug) positioning therein of a second tube, in particular, the inner tube 108 (as descried hereinbelow), that longitudinally extends downwardly and upwardly between the top and bottom ends of the second tube (inner tube 108). In such exemplary embodiments, the second tube (inner tube 108) is configured with a plurality of openings (holes or/and slits) that are spatially adjacently alignable/aligned, so as to nearly coincide, with the plurality of the openings (holes or/and slits) 134 (s1, s2, bm) of the middle tube 106, in order to facilitate continuous unobstructed flow of filtered and cleaned mikvah water from the openings of the middle tube 106 into and through the openings of the second tube (inner tube 108).

### Inner Tube

Upon exiting the middle tube 106, the filtered and cleaned mikvah water enters, passes through, and exits the inner tube 108. More specifically, upon exiting the openings (holes or/and slits) of the middle tube 106, the filtered and cleaned mikvah water immediately enters and passes through the openings (holes or/and slits) of the inner tube 108 (which are spatially adjacently aligned and nearly coincide with the openings (holes or/and slits) of the middle tube 106), for example, as shown in FIG. 17.

The inner tube 108 longitudinally extends downwardly and upwardly between the inner tube top end 108te and the inner tube bottom end 108be, and is configured with a plurality of inner tube openings (holes or/and slits). The inner tube 108 is collaterally securely (firmly, tightly, snugly) positioned within and along the middle tube 106, such that the plurality of inner tube openings are spatially adjacently alignable/aligned and nearly coincide with the plurality of middle tube openings, so as to facilitate continuous unobstructed flow of filtered and cleaned mikvah water from the middle tube openings into and through the inner tube openings. Such spatial alignment, and continuous unobstructed flow of mikvah water, prevent formation of standing (static, non-moving, non-flowing) mikvah water inside the mikvah water filtering and cleaning apparatus 100, and also contribute to achieving high mikvah water throughput and processing (filtering and cleaning), during operation of the apparatus 100.

The inner tube 108 includes an inner tube top end portion 108tep (whose top end corresponds to the inner tube top end 108te), and an inner tube bottom end portion 108bep (whose bottom end corresponds to the inner tube bottom end 108be). The inner tube 108 has an outer diameter that is less than the inner diameter of the middle tube 106, and has a top to bottom longitudinal length (height) that is larger than the top to bottom longitudinal length (height) of each of the middle tube 106 and of the filter medium 104.

As viewable in FIGS. 1A-1D, 2 (left side), 3A-3C, and 4, the inner tube top end 108te is connected (attached) to, and holds, the bottom cover 188bc of the propeller motor housing 188 (being part of the forced water circulation assembly 110).

FIGS. 13A and 13B show schematic front and perspective views, respectively, of an exemplary embodiment of the inner tube 108, as a ‘stand-alone’ component, which is part of the overall mikvah water filtering and cleaning apparatus 100. The inner tube 108 is configured with any number of openings (holes or/and slits), with the requirement that the inner tube 108 be configured with the exact same number of openings as the number of openings in the middle tube 106. For example, as shown in FIGS. 2 (left side), 3C, 13A, and 13B, the inner tube 108 is configured with an exemplary number of more than fifty inner tube openings 140s1 and 140s2, which is the same number of openings in the middle tube 106. The inner tube openings (holes or slits) have any of numerous different geometrical shapes, for example, (partly or fully) circular, elliptical, trigonal, square, rectangular, heptagonal, hexagonal, heptagonal, octagonal, etc., with the requirement that the inner tube 108 is configured with the geometrical shape(s) of the inner tube openings 140s1 and 140s2 being exactly the same as the geometrical shape(s) of the middle tube openings 134s1 and 134s2, respectively.

As shown in FIGS. 2 (left side), 3C, 13A, and 13B, the inner tube openings 140s1 and 140s2 are in the form of holes having a fully circular shape, being exactly the same geometrical shape of the middle tube openings 134s1 and 134s2, respectively. In exemplary embodiments, the inner tube 108 is configured with the inner tube openings having two or more different geometrical shapes or/and sizes, with the requirement that the inner tube 108 is configured with exactly the same number of different geometrical shapes or/and sizes as those of the middle tube 106. Such exemplary embodiments are shown in FIGS. 2, 3B and 3C, 12A and 13A, and 12B and 13B, wherein the inner tube 108 is configured with a first plurality of a first size circular shaped inner tube openings (holes) 140s1, and a second plurality of a second (larger) size circular shaped inner tube openings (holes) 140s2, which are exactly the same as the first plurality of the first size circular shaped middle tube openings (holes) 134s1 and the second plurality of the second (larger) size circular shaped middle tube openings (holes) 134s2 that are configured in the middle tube 106. In alternative exemplary embodiments, the inner tube 108 is configured with all of the inner tube openings (holes or/and slits) having the same geometrical shape and size (height or length, width), with the requirement that the middle tube 106 is also configured with all of the middle tube openings having the same geometrical shape and size (height or length, width).

In exemplary embodiments, for example, as shown in FIGS. 13A and 13B, in the inner tube 108, the inner tube bottom end portion 108bep is configured with bottommost openings (holes or/and slits) 140bm in the form of holes having a fully circular shape, whose bottom peripheries (boundaries) are closed (i.e., absent of spaces or gaps) and parallel to the inner tube bottom end 108be. Such configuration of the inner tube bottom end portion 108bep is in contrast to the configuration of the middle tube bottom end portion 106bep, which, as described above, includes bottommost openings (holes or/and slits) 134bm, whose bottom peripheries (boundaries) are open, in the form of spaces or gaps that are parallel to, and coincide (are collinear) with, the middle tube bottom end 106be. The reason for this structural difference is that once the filtered and cleaned mikvah water enters, passes through, and exits the middle tube bottommost openings 134bm, then, per the highly accurate spatial adjacent alignment and near coincidence of the middle tube bottommost openings 134bm with the inner tube bottommost openings 140bm, especially the bottom peripheries (boundaries) thereof, the filtered and cleaned mikvah water readily, continuously (absent of any obstruction) enters the inner tube bottommost openings 134bm, and continues its uninterrupted and unobstructed flow into and through the cylindrical central hollow portion 150-chp of a middle and inner tubes bottom ends and filter medium bottom end holding member 150.

### Middle and Inner Tubes Bottom Ends and Filter Medium Bottom End Holding Member

Upon exiting the inner tube 108, the filtered and cleaned mikvah water enters, passes through, and exits (the central hollow portion of) a middle and inner tubes bottom ends and filter medium bottom end holding member 150 (herein, also referred to as the tubes and filter medium bottom ends holding member 150) for example, as shown in FIG. 17.

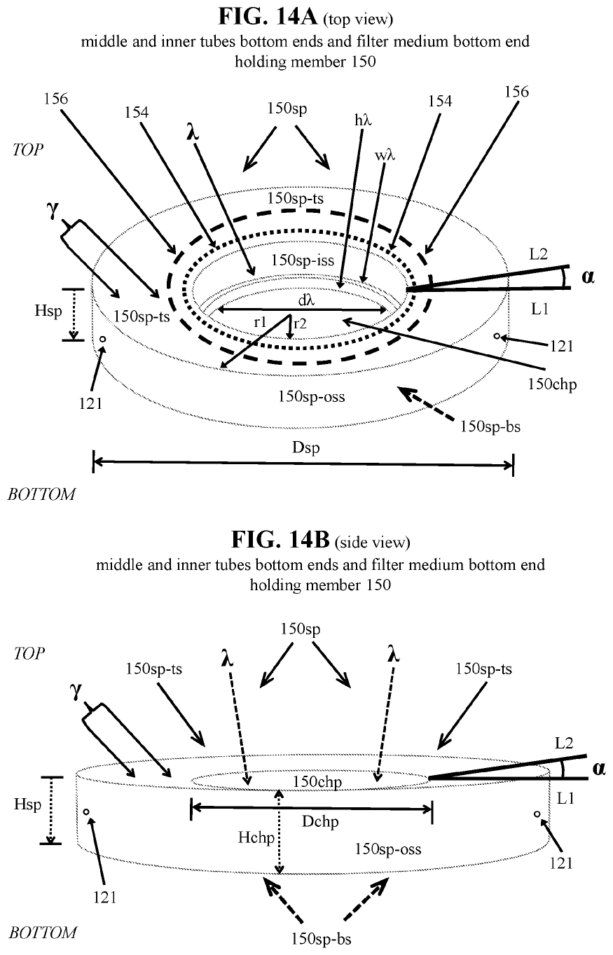

FIGS. 14A and 14B are schematic close-up perspective top and side views, respectively, of an exemplary embodiment of the middle and inner tubes bottom ends and filter medium bottom end holding member 150, highlighting the solid portion top surface gradient (inclination, slope, slant) γ, and the gradient (inclination, slope, slant) angle α thereof. Also shown therein are the locations (positions) 156 (dashed line circle), λ (circular ledge, projection), and 154 (dotted line circle), of holding the filter medium bottom end 104be, the middle tube bottom end 106be, and the inner tube bottom end 108be, respectively.

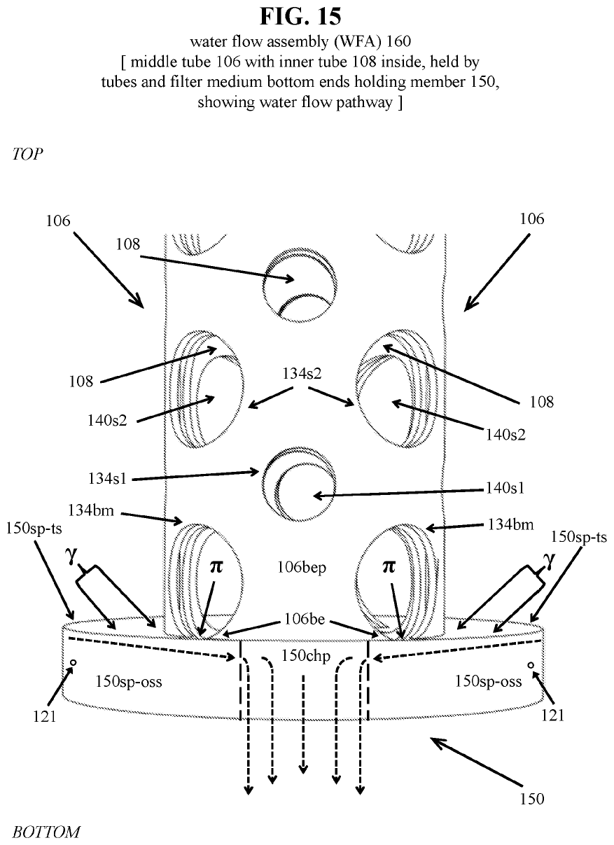

FIG. 15 is a schematic close-up perspective view of the lower portion of the middle tube 106 with the lower portion of the inner tube 108 inside, held by the tubes and filter medium bottom ends holding member 150, corresponding to the water flow assembly (WFA) 160, highlighting the gaps R in the middle tube bottommost openings 134bm, and the tubes and filter medium bottom ends holding member solid portion top surface gradient (inclination, slope, slant) Y. Also shown therein is an exemplary water flow pathway [indicated therein by the dashed line arrows] upon and within the tubes and filter medium bottom ends holding member 150.

In exemplary embodiments of the mikvah water filtering and cleaning apparatus 100, the tubes and filter medium bottom ends holding member 150 is configured for the following. (1) Holding: (i) the filter medium bottom end 104be, (ii) the middle tube bottom end 106be (positioned inside of, and surrounded by, the filter medium bottom end 104be), and (iii) the inner tube bottom end 108be (positioned within the middle tube bottom end 106be). Alternatively stated, the tubes and filter medium bottom ends holding member 150 is configured for holding the bottom ends 104be, 106be, and 108be, of the filter medium 104, the middle tube 106, and the inner tube 108, respectively. (2) Facilitating continuous and unobstructed flow of filtered and cleaned mikvah water passing through and exiting the filter medium 104 that enters, passes through, and exits the middle tube openings 134 (s1, s2, bm), the inner tube openings 140 (s1, s2, bm), and the cylindrical central hollow portion 150chp of the tubes and filter medium bottom ends holding member 150 (for example, as indicated in FIG. 15, via the exemplary water flow pathway [dashed line arrows] upon and within the tubes and filter medium bottom ends holding member 150). Such structural and functional (operational) features of the tubes and filter medium bottom ends holding member 150, and continuous unobstructed flow of mikvah water, prevent formation of standing (static, non-moving, non-flowing) mikvah water inside the mikvah water filtering and cleaning apparatus 100, and also contribute to achieving high mikvah water throughput and processing (filtering and cleaning), during operation thereof.

As shown in FIGS. 14A, 14B, and 15, the tubes and filter medium bottom ends holding member 150 is configured with a cylindrical encircling solid portion 150sp that encircles a cylindrical central hollow portion 150chp.

The cylindrical encircling solid portion 150sp has an overall diameter Dsp, an outer radius r1, an inner radius r2, and a top to bottom (longitudinal) length (height) Hsp. The top to bottom longitudinal length (height) Hsp varies between the outer radius r1 and the inner radius r2, in accordance with the filter medium bottom ends holding member 150 solid portion top surface gradient (inclination, slope, slant) γ, and gradient (inclination, slope, slant) angle α thereof. For example, the cylindrical encircling solid portion 150sp top to bottom longitudinal length (height) Hsp decreases (as indicated by the downward directed dotted line arrow) from a maximum height transverse to the outer radius r1, to a minimum height transverse to the inner radius r2.

The cylindrical encircling solid portion 150sp includes a solid portion top surface 150sp-ts, a solid portion bottom surface 150sp-bs [in FIGS. 14A, 14B, 15, present, but, not viewable, and indicated by the dashed line arrow], a solid portion inner side surface 150sp-iss, and a solid portion outer side surface 150sp-oss.

The cylindrical central hollow portion 150chp has a diameter Dchp, and a top to bottom longitudinal length (height) Hchp (dotted line two headed arrow) that corresponds to the smallest (inner radius r2) top to bottom longitudinal length (height) Hsp of the cylindrical encircling solid portion 150sp.

### Solid Portion Top Surface Gradient (Inclination, Slope, Slant) γ, and Angle α Thereof

The solid portion top surface 150sp-ts is configured with a top surface gradient (inclination, slope, slant) γ [indicated by the bracket with two extending arrows] that latitudinally spans and descends, upon and along the solid portion top surface 150sp-ts, between the outer radius r1 and the inner radius r2 of the encircling solid portion 150sp. The top surface gradient (inclination, slope, slant) γ has a gradient (inclination, slope, slant) angle α, defined as the angle formed between a first straight line L1 originating from a point on the circumferential periphery (perimeter) of the central hollow portion 150chp and parallel to the (flat) solid portion bottom surface 150sp-bs, and a second straight line L2 originating from the same originating point of L1 and collinear (coincident) with the top surface gradient (inclination, slope, slant) γ of the solid portion top surface 150sp-ts. In exemplary embodiments, the gradient (inclination, slope, slant) angle α is in a broad range of between one degree (1°) and eighty-nine degrees (89°). In exemplary embodiments, the gradient angle α is in a particular range of between three degrees (3°) and twenty degrees (20°), corresponding to a range of a relatively small angle of the gradient (inclination, slope, slant) γ that latitudinally spans and descends, upon and along the solid portion top surface 150sp-ts, between the outer and inner radii, r1 and r2, respectively, of the encircling solid portion 150sp of the tubes and filter medium bottom ends holding member 150.

Such configuration of the solid portion top surface 150sp-ts, with solid portion top surface gradient γ, having gradient angle α, facilitates continuous unobstructed flow of mikvah water, and prevents formation of standing (static, non-moving, non-flowing) mikvah water, inside the mikvah water filtering and cleaning apparatus 100, and also contributes to achieving high mikvah water throughput and processing (filtering and cleaning), during operation of the apparatus 100.

### Solid Portion Inner Side Surface—Bottom End Portion Cylindrical Ledge (Projection) λ

The solid portion inner side surface 150sp-iss has a bottom end portion configured as a cylindrical ledge (relatively small horizontal projection) λ, that (slightly) horizontally, circularly extends (projects) from, and along, the circumferential periphery (perimeter) of the bottom end portion of the solid portion inner side surface 150sp-iss, inwardly into the cylindrical central hollow portion 150chp. The cylindrical ledge λ has a top to bottom (longitudinal) length (height) hμ, a width wλ, and a diameter dλ, wherein the diameter dλ is less than the diameter of the remaining part of the solid portion inner side surface 150sp-iss (being the diameter Dchp of the cylindrical central hollow portion 150chp).

In exemplary embodiments, in the middle tubes and filter medium bottom ends holding member 150, the solid portion outer side surface 150sp-oss includes a plurality of small sized holes 121 (configured, for example, for screws or nails), that facilitate firm connection (attachment) of the tubes and filter medium bottom ends holding member 150 to the inside surface of the lower part of the outer tube 102. In exemplary embodiments, for example, as shown in FIGS. 1A-1D, and 2 (left side), the small sized holes 121 in the solid portion outer side surface 150sp-oss are aligned with the small sized holes 120 in the lower part of the outer tube 102, into which screws or nails are fitted, for firmly connecting (attaching) the tubes and filter medium bottom ends holding member 150 to the inside surface of the lower part of the outer tube 102.

In accordance with above illustratively described middle and inner tubes bottom ends and filter medium bottom end holding member 150, the filter medium bottom end 104be, the middle tube bottom end 106be, and the inner tube bottom end 108be, are positioned and held thereupon, as follows.

The filter medium bottom end 104be is positioned on, and supported by, the top surface gradient (inclination, slope, slant) γ of the solid portion top surface 150sp-ts. In exemplary embodiments, the filter medium bottom end 104be is positioned and supported thereupon, whereby the circumferential periphery (perimeter) of the inner wall or inner part of the filter medium bottom end 104be is immediately adjacent to, and surrounds, the circumferential periphery (perimeter) of the outer wall of the middle tube bottom end 106be. Alternatively stated, on the top surface gradient γ of the solid portion top surface 150sp-ts, the (circular) filter medium bottom end 104be is positioned so as to surround, and wrap around, the (circular) middle tube bottom end 106be, for example, as indicated in FIG. 14A by the dashed line circle 156, and shown in FIG. 3A. According to such exemplary embodiments, the middle tube 106 is longitudinally collaterally entirely (fully) positioned within and along the tubular filter medium 104, so as to support the tubular filter medium 104 along its entire top to bottom longitudinal length (height).

The middle tube bottom end 106be is also positioned on, and supported by, the top surface gradient (inclination, slope, slant) γ of the solid portion top surface 150sp-ts. In exemplary embodiments, the middle tube bottom end 106be is positioned and supported thereupon, whereby the circumferential periphery (perimeter) of the inner wall of the middle tube bottom end 106be coincides with, or nearly coincides with (i.e., is immediately adjacent to, and surrounds), the circumferential periphery (perimeter) of the cylindrical central hollow portion 150chp, for example, as indicated in FIG. 14A by the dotted line circle 154, and shown in FIG. 15. According to such exemplary embodiments, the bottom peripheries (boundaries) of the bottommost openings 134bm, and the middle tube bottom end 106be, of the middle tube bottom end portion 106bep are positioned upon and around, or immediately adjacent to and around, the circumferential periphery (perimeter) 154 situated on the top surface gradient γ of the solid portion top surface 150sp-ts.

The inner tube bottom end 108be is not positioned on, or supported by, the solid portion top surface 150sp-ts. Rather, the inner tube bottom end 108be is positioned along, and supported by, the solid portion inner side surface 150-sp-iss. In exemplary embodiments, the inner tube bottom end 108be is positioned on, and supported by, the top (width wk) of the cylindrical ledge λ of the solid portion inner side surface 150sp-iss. In exemplary embodiments, the circumferential periphery (perimeter) of the outer wall of the inner tube bottom end 108be coincides with, or nearly coincides with, the circumferential periphery (perimeter) of the top (width wk) of the cylindrical ledge λ, such that the periphery of the inner tube bottom end 108be securely (firmly, tightly, snugly) and stably sits upon the circumferential periphery (perimeter) of the top (width wk) of the cylindrical ledge λ.

According to such exemplary embodiments, the inner tube 108 is collaterally securely (firmly, tightly, snugly) positioned within and along the middle tube 106, such that the plurality of inner tube openings 140 (s1, s2, and bm) are spatially adjacently aligned and nearly coincide with the plurality of middle tube openings 134 (s1, s2, and bm), so as to facilitate continuous unobstructed flow of filtered and cleaned mikvah water from the middle tube openings 134 (s1, s2, bm) into and through the inner tube openings 140 (s1, s2, bm), and subsequently, into and through the cylindrical central hollow portion 150chp of the tubes and filter medium bottom ends holding member 150.

### Water Flow Assembly

The herein disclosed water flow assembly (WFA) corresponds to a ‘sub-combination’ of the (overall) apparatus for filtering and cleaning water in a mikvah, and may be considered as an individual ‘stand-alone’ device. In exemplary embodiments, for example, with reference to FIG. 15, the sub-combination ‘stand-alone’ water flow assembly [indicated as, and referred to by, reference number 160] consists essentially of, or, alternatively, consists of: the middle tube 106, the inner tube 108, and the middle and inner tubes bottom ends and filter medium bottom end holding member 150. In the context of the water flow assembly 160 being a ‘stand-alone’ device, regarding component terminology, the middle tube 106 corresponds to a first tube 106; the inner tube 108 corresponds to a second tube 108; and the middle and inner tubes bottom ends and filter medium bottom end holding member 150 corresponds to a cylindrical tubes bottom ends holding member 150. The components of the water flow assembly 160 have all the same structural and functional technical features and characteristics, and the same reference numbers, as of their respective corresponding counterpart components of the herein illustratively described mikvah water filtering and cleaning apparatus 100.

Thus, according to another aspect of the herein disclosed invention, there is provided a water flow assembly, for use in an apparatus for filtering and cleaning water in a mikvah, which complies with Jewish religious laws (halacha). The water flow assembly 160 consists essentially of, or, alternatively, consists of, the components (with reference to FIGS. 15, 14A, 14B, and preceding figures): a first tube 106, a second tube 108, and a cylindrical tubes bottom ends holding member 150, which are characterized by the following illustratively described structural and functional (operational) features thereof.

In exemplary embodiments of the water flow assembly 160, for example, as shown in FIG. 15, the first tube 106 longitudinally extends downwardly and upwardly between first tube top and bottom ends 106te and 106be, respectively, and is configured with a plurality of first tube openings (holes or/and slits) 134 (s1, s2, bm). The first tube 106 has a first tube bottom end portion 106bep configured with first tube bottommost openings 134bm whose bottom peripheries (boundaries) are open, for example, in the form of spaces or gaps R that are parallel to, and coincide (are collinear) with, the first tube bottom end 106be. The spaces or gaps R in the bottommost openings (holes) 134bm facilitate continuous unobstructed flow of filtered and cleaned mikvah water which enters and passes through the first tube bottom end portion 106bep of the water flow assembly 160, for example, after passing through and exiting a filter medium, for example, filter medium 104.

In exemplary embodiments of the water flow assembly 160, the second tube 108 longitudinally extends downwardly and upwardly between second tube top and bottom ends 108te and 108be, respectively, and is configured with a plurality of second tube openings 140 (s1, s2, bm). The second tube 108 has a second tube bottom end portion 108bep configured with second tube bottommost openings 140bm. The second tube 108 is collaterally securely (firmly, tightly, snugly) positioned within and along the first tube 106, such that the plurality of second tube openings 140 (s1, s2, bm) are spatially adjacently aligned and nearly coincide with the plurality of first tube openings 134 (s1, s2, bm), so as to facilitate continuous unobstructed flow of filtered and cleaned mikvah water from the first tube openings 134 (s1, s2, bm) into and through the second tube openings 140 (s1, s2, bm), and subsequently, into and through the cylindrical central hollow portion 150chp of the cylindrical tubes bottom ends holding member 150.

In exemplary embodiments of the water flow assembly 160, the cylindrical tubes bottom ends holding member 150 is configured for the following. (1) Holding: (i) the first tube bottom end 106be, and (ii) the second tube bottom end 108be (positioned within the first tube bottom end 106be). In exemplary embodiments, the cylindrical tubes bottom ends holding member 150 is configured for additionally being suitable for holding (iii) the bottom end of a filter medium, for example, the bottom end 104be of the filter medium 104. (2) Facilitating continuous and unobstructed flow of filtered and cleaned mikvah water that enters, passes through, and exits the first tube openings 134 (s1, s2, bm), the second tube openings 140 (s1, s2, bm), and the cylindrical central hollow portion 150chp of the cylindrical tubes bottom ends holding member 150, for example, as indicated in FIG. 15, via the exemplary water flow pathway [dashed line arrows] upon and within the cylindrical tubes bottom ends holding member 150. Such structural and functional (operational) features of the cylindrical tubes bottom ends holding member 150, and continuous unobstructed flow of mikvah water, prevent formation of standing (static, non-moving, non-flowing) mikvah water inside the mikvah water filtering and cleaning apparatus, and also contribute to achieving high mikvah water throughput and processing (filtering and cleaning), during operation thereof.

As shown in FIGS. 14A, 14B, and 15, the cylindrical tubes bottom ends holding member 150 is configured with a cylindrical encircling solid portion 150sp that encircles a cylindrical central hollow portion 150chp. These components of the cylindrical tubes bottom ends holding member 150 have the same structural and functional features and characteristics as of their respective corresponding counterpart components (cylindrical encircling sold portion 150sp, and cylindrical central hollow portion 150chp) of the herein illustratively described tubes and filter medium bottom ends holding member 150.

The cylindrical encircling solid portion 150sp includes a solid portion top surface 150sp-ts, a solid portion bottom surface 150sp-bs, a solid portion inner side surface 150sp-iss, and a solid portion outer side surface 150sp-oss.

The cylindrical encircling solid portion 150sp has an overall diameter Dsp, an outer radius r1, an inner radius r2, and a top to bottom (longitudinal) length (height) Hsp. The top to bottom longitudinal length (height) Hsp varies between the outer radius r1 and the inner radius r2, in accordance with the cylindrical tubes bottom ends holding member 150 solid portion top surface gradient (inclination, slope, slant) γ, and gradient (inclination, slope, slant) angle α thereof. For example, the cylindrical encircling solid portion 150sp top to bottom longitudinal length (height) Hsp decreases (as indicated by the downward directed dotted line arrow) from a maximum height transverse to the outer radius r1, to a minimum height transverse to the inner radius r2.

The solid portion top surface 150sp-ts is configured with a top surface gradient (inclination, slope, slant) γ that latitudinally spans and descends, upon and along the solid portion top surface 150sp-ts, between the outer radius r1 and the inner radius r2 of the encircling solid portion 150sp. The top surface gradient γ has a gradient (inclination, slope, slant) angle α, as defined hereinabove. In exemplary embodiments, the gradient angle α is in a broad range of between one degree (10) and eighty-nine (89°). In exemplary embodiments, the gradient angle α is in a particular range of between three degrees (30) and twenty degrees (20°).

The solid portion inner side surface 150sp-iss has a bottom end portion configured as a cylindrical ledge (relatively small horizontal projection) λ, that (slightly) horizontally, circularly extends (projects) from, and along, the circumferential periphery (perimeter) of the bottom end portion of the solid portion inner side surface 150sp-iss, inwardly into the cylindrical central hollow portion 150chp. The cylindrical ledge λ has a top to bottom (longitudinal) length (height) hλ, a width wk, and a diameter da, wherein the diameter d, is less than the diameter of the remaining part of the solid portion inner side surface 150sp-iss (being the diameter Dchp of the cylindrical central hollow portion 150chp).

In exemplary embodiments of the water flow assembly 160, the cylindrical central hollow portion 150chp has a diameter Dchp, and a top to bottom longitudinal length (height) Hchp (dotted line two headed arrow) that corresponds to the smallest (inner radius r2) top to bottom longitudinal length (height) Hsp of the cylindrical encircling solid portion 150sp. The central hollow portion 150chp is configured for facilitating continuous and unobstructed passage therethrough of filtered and cleaned mikvah water that enters, passes through, and exits, the first tube 106 and the second tube 108.

In accordance with above illustratively described cylindrical tubes bottom ends holding member 150, the first tube bottom end 106be, and the second tube bottom end 108be, are positioned and held thereupon, as follows.

The first tube bottom end 106be is positioned on, and supported by, the top surface gradient (inclination, slope, slant) γ of the solid portion top surface 150sp-ts. In exemplary embodiments, the first tube bottom end 106be is positioned and supported thereupon, whereby the circumferential periphery (perimeter) of the inner wall of the first tube bottom end 106be coincides with, or nearly coincides with (i.e., is immediately adjacent to, and surrounds), the circumferential periphery (perimeter) of the cylindrical central hollow portion 150chp, for example, as indicated in FIG. 14A by the dotted line circle 154, and shown in FIG. 15. According to such exemplary embodiments, the bottom peripheries (boundaries) of the bottommost openings 134bm, and the first tube bottom end 106be, of the first tube bottom end portion 106bep are positioned upon and around, or immediately adjacent to and around, the circumferential periphery (perimeter) 154 situated on the top surface gradient γ of the solid portion top surface 150sp-ts.

The second tube bottom end 108be is positioned along, and supported by, the solid portion inner side surface 150-sp-iss. In exemplary embodiments, the second tube bottom end 108be is positioned on, and supported by, the top (width wk) of the cylindrical ledge λ of the solid portion inner side surface 150sp-iss. In exemplary embodiments, the circumferential periphery (perimeter) of the outer wall of the second tube bottom end 108be coincides with, or nearly coincides with, the circumferential periphery (perimeter) of the top (width wk) of the cylindrical ledge λ, such that the periphery of the second tube bottom end 108be securely (firmly, tightly, snugly) and stably sits upon the circumferential periphery (perimeter) of the top (width wk) of the cylindrical ledge λ.

### Device for Holding Bottom Ends of Tubes

The herein disclosed device for holding bottom ends of tubes corresponds to another ‘sub-combination’ of the (overall) apparatus for filtering and cleaning water in a mikvah, and may also be considered as an individual ‘stand-alone’ device. In exemplary embodiments, for example, with reference to FIGS. 14A, 14B, and 15, the device for holding bottom ends of tubes corresponds to the hereinabove illustratively described middle and inner tubes bottom ends and filter medium bottom end holding member (tubes and filter medium bottom ends holding member) 150. The sub-combination ‘stand-alone’ device [also indicated as, and referred to by, same reference number 150] for holding bottom ends of tubes has all the same components, and the same structural and functional features, as for the corresponding counterpart component middle and inner tubes bottom ends and filter medium bottom end holding member (tubes and filter medium bottom ends holding member) 150 that is hereinabove illustratively described in the context of the (overall) mikvah water filtering and cleaning apparatus 100.

Thus, according to another aspect of the herein disclosed invention, there is provided a device for holding bottom ends of tubes, for use in an apparatus for filtering and cleaning water in a mikvah, which complies with Jewish religious laws (halacha). As illustratively described hereinabove regarding the tubes and filter medium bottom ends holding member 150, along with reference to FIGS. 15, 14A, 14B, and preceding figures, in exemplary embodiments, the device 150 for holding bottom ends of tubes consists essentially of, or, alternatively, consists of, a cylindrical encircling solid portion 150sp that encircles a cylindrical central hollow portion 150chp. The device 150 for holding bottom ends of tubes is characterized by the following illustratively described structural and functional (operational) features thereof.

In exemplary embodiments, the device 150 for holding bottom ends of tubes is configured for the following. (1) Holding: (i) the bottom end of a first tube (for example, the bottom end 106be of a first tube 106), and (ii) the bottom end of a second tube (for example, the bottom end 108be of a second tube 108 which is positioned within the first tube bottom end 106be). In exemplary embodiments, the device 150 is configured for additionally being suitable for holding: (iii) the bottom end of a filter medium (for example, the bottom end 104be of the filter medium 104). (2) Facilitating continuous and unobstructed flow of filtered and cleaned mikvah water that enters, passes through, and exits the openings 134 (s1, s2, bm) of the first tube 106, the openings 140 (s1, s2, bm) of the second tube 108, and the cylindrical central hollow portion 150chp of the device 150. In practice, when the device 150 for holding bottom ends of tubes is used in an apparatus for filtering and cleaning water in a mikvah (for example, apparatus 100), such structural and functional (operational) features of the device 150, and continuous unobstructed flow of mikvah water, prevent formation of standing (static, non-moving, non-flowing) mikvah water inside the mikvah water filtering and cleaning apparatus, and also contribute to achieving high mikvah water throughput and processing (filtering and cleaning), during operation thereof.

In exemplary embodiments of the device 150, the encircling solid portion 150sp includes a solid portion top surface 150sp-ts, a solid portion bottom surface 150sp-bs, a solid portion inner side surface 150sp-iss, and a solid portion outer side surface 150sp-oss.

The cylindrical encircling solid portion 150sp has an overall diameter Dsp, an outer radius r1, an inner radius r2, and a top to bottom (longitudinal) length (height) Hsp. The top to bottom longitudinal length (height) Hsp varies between the outer radius r1 and the inner radius r2, in accordance with the device 150 solid portion top surface gradient (inclination, slope, slant) γ, and gradient (inclination, slope, slant) angle α thereof. For example, the cylindrical encircling solid portion 150sp top to bottom longitudinal length (height) Hsp decreases (as indicated by the downward directed dotted line arrow) from a maximum height transverse to the outer radius r1, to a minimum height transverse to the inner radius r2.

The solid portion top surface 150sp-ts is configured with a top surface gradient (inclination, slope, slant) γ that latitudinally spans and descends, upon and along the solid portion top surface 150sp-ts, between the outer radius r1 and the inner radius r2 of the encircling solid portion 150sp. The top surface gradient γ has a gradient (inclination, slope, slant) angle α, as defined hereinabove. In exemplary embodiments, the gradient angle α is in a broad range of between one degree (1°) and eighty-nine (89°). In exemplary embodiments, the gradient angle α is in a particular range of between three degrees (3°) and twenty degrees (20°).

The solid portion inner side surface 150sp-iss has a bottom end portion configured as a cylindrical ledge (relatively small horizontal projection) λ, that (slightly) horizontally, circularly extends (projects) from, and along, the circumferential periphery (perimeter) of the bottom end portion of the solid portion inner side surface 150sp-iss, inwardly into the cylindrical central hollow portion 150chp. The cylindrical ledge λ has a top to bottom (longitudinal) length (height) hλ, a width wλ, and a diameter dλ, wherein the diameter dλ is less than the diameter of the remaining part of the solid portion inner side surface 150sp-iss (being the diameter Dchp of the cylindrical central hollow portion 150chp).

In exemplary embodiments of the device 150, the cylindrical central hollow portion 150chp has a diameter Dchp, and a top to bottom longitudinal length (height) Hchp (dotted line two headed arrow) that corresponds to the smallest (inner radius r2) top to bottom longitudinal length (height) Hsp of the cylindrical encircling solid portion 150sp. The central hollow portion 150chp is configured for facilitating continuous and unobstructed passage therethrough of filtered and cleaned mikvah water that enters, passes through, and exits, the first tube 106 and the second tube 108.

### Tubular Device

The herein disclosed tubular device corresponds to another ‘sub-combination’ of the (overall) apparatus for filtering and cleaning water in a mikvah, and may also be considered as an individual ‘stand-alone’ device. In exemplary embodiments, for example, with reference to FIGS. 2 (right side), 3A, 3B, 4, 12A, 12B, and 15, the tubular device corresponds to the hereinabove illustratively described middle tube 106. The sub-combination ‘stand-alone’ tubular device [also indicated as, and referred to by, same reference number 106] has all the same structural and functional features as for the corresponding counterpart component middle tube 106 hereinabove illustratively described in the context of the (overall) mikvah water filtering and cleaning apparatus 100, and as for the corresponding component first tube 106 hereinabove illustratively described in the context of the water flow assembly 160.

Thus, according to another aspect of the herein disclosed invention, there is provided a tubular device for use in an apparatus for filtering and cleaning water in a mikvah, which complies with Jewish religious laws (halacha). The tubular device 106 consists essentially of, or, alternatively, consists of, a first tube 106, longitudinally extending downwardly and upwardly between top and bottom ends 106te and 106be, respectively, of the first tube 106, and configured with a plurality of first tube openings (holes or/and slits) 134 (s1, s2, bm). In exemplary embodiment of the tubular device, the first tube 106 is configured for collateral secure (firm, tight, snug) positioning therein of a second tube (for example, inner tube 108) that longitudinally extends downwardly and upwardly between second tube top and bottom ends (for example, 108te and 108be, respectively). In exemplary embodiments, the plurality of first tube openings 134 (s1, s2, bm) are spatially adjacently alignable, so as to nearly coincide with, a plurality of openings (holes or/and slits), for example, 140 (s1, s2, bm), of a second tube (for example, inner tube 108), in order to facilitate continuous unobstructed flow of filtered and cleaned mikvah water from the tubular device (first tube) openings 134 (s1, s2, bm) into and through the second tube openings (for example, 140 (s1, s2, bm)).

FIGS. 12A and 12B show schematic front and perspective views, respectively, of an exemplary embodiment of the tubular device 106 (hereinabove, also referred to as the first tube 106 in the context of the water flow assembly 160, and in the context of the device 150 for holding bottom ends of tubes), corresponding to the hereinabove illustratively described middle tube 106 part of the overall mikvah water filtering and cleaning apparatus 100), as a ‘stand-alone’ component. The tubular device (first tube) 106 is configured with any number of openings (holes or/and slits). For example, as shown in FIGS. 2 (right side), 3B, 12A, and 12B, the tubular device (first tube) 106 is configured with an exemplary number of more than fifty tubular device (first tube) openings 134s1 and 134s2. The tubular device (first tube) openings (holes or slits) have any of numerous different geometrical shapes, for example, (partly or fully) circular, elliptical, trigonal, square, rectangular, heptagonal, hexagonal, heptagonal, octagonal, etc. As shown in FIGS. 2 (right side), 3B, 12A, and 12B, the tubular device (first tube) openings 134s1 and 134s2 are in the form of holes having a fully circular shape. In exemplary embodiments, the tubular device (first tube) 106 is configured with the tubular device (first tube) openings having two or more different geometrical shapes or/and sizes. Such exemplary embodiments are shown in FIGS. 2 (right side), 3B, 12A, and 12B, wherein the tubular device (first tube) 106 is configured with a first plurality of a first size circular shaped tubular device (first tube) openings (holes) 134s1, and a second plurality of a second (larger) size circular shaped tubular device (first tube) openings (holes) 134s2. In alternative exemplary embodiments, the tubular device (first tube) 106 is configured with all of the tubular device (first tube) openings (holes or/and slits) having the same geometrical shape and size (height or length, width).

In exemplary embodiments, for example, as shown in FIGS. 12A and 12B, in the tubular device (first tube) 106, the tubular device (first tube) bottom end portion 106bep is configured with bottommost openings (holes or/and slits) 134bm, whose bottom peripheries (boundaries) are open, for example, in the form of spaces or gaps R that are parallel to, and coincide (are collinear) with, the tubular device (first tube) bottom end 106be. The spaces or gaps R in the bottommost openings (holes) 134bm facilitate continuous unobstructed flow of filtered and cleaned mikvah water which enters and passes through the tubular device (first tube) bottom end portion 106bep. In practice, when the tubular device 106 is used in an apparatus for filtering and cleaning water in a mikvah (for example, apparatus 100), such spaces or gaps R in the bottommost openings (holes) 134bm of the tubular device (functioning as a middle tube) 106, and continuous unobstructed flow of mikvah water, prevent formation of standing (static, non-moving, non-flowing) mikvah water inside the mikvah water filtering and cleaning apparatus 100, and also contribute to achieving high mikvah water throughput and processing (filtering and cleaning), during operation of the apparatus 100.

### Forced Water Circulation Assembly

The forced water circulation assembly 110 facilitates forced continuous and directional flow, and, filtering and cleaning, of the mikvah water from the mikvah into and through the at least one outer tube mikvah water inlet opening (for example, inlet openings 112a, 112b, 112c, 114a, 114b, 114c, 114d) into and through the filter medium 104, into and through the middle tube openings 134 (s1, s2, bm) and the inner tube openings 140 (s1, s2, bm), and, into and through the at least one outer tube mikvah water outlet opening (for example, outlet opening 116).

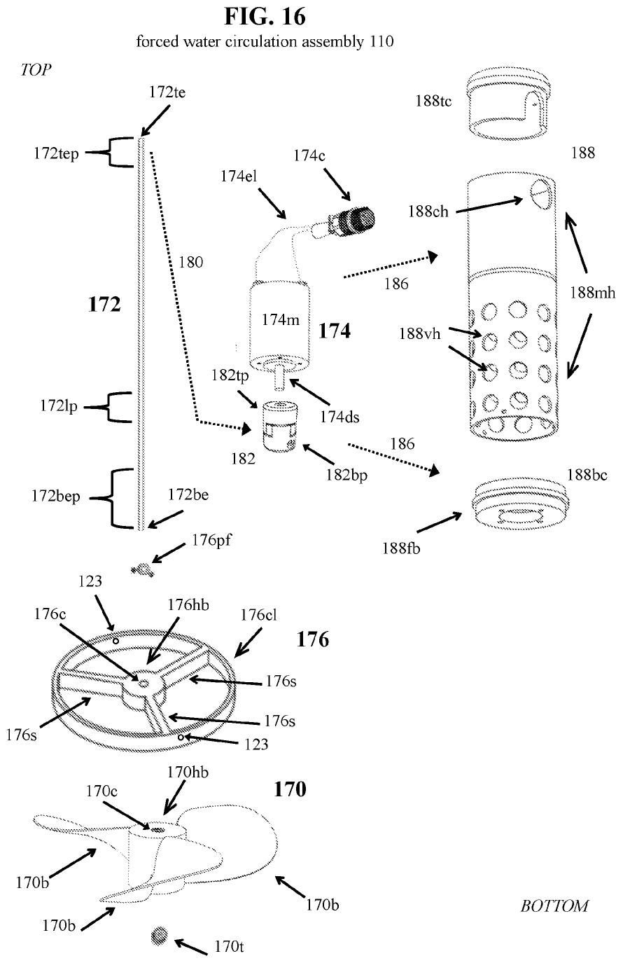

FIG. 16 is a schematic exploded perspective view of an exemplary embodiment of the forced water circulation assembly 110 of the mikvah water filtering and cleaning apparatus 100. Some components of the forced water circulation assembly 110 are also viewable in FIG. 1D. In exemplary embodiments, the forced water circulation assembly 110 includes: a propeller 170, a propeller shaft 172, and a propeller shaft motor assembly 174, and is operatively connected to the outer, middle, and inner tubes 102, 106, and 108, respectively.

The propeller 170 includes a propeller hub 170hb, and a plurality of propeller blades, for example, three propeller blades 170b, outwardly extending from the propeller hub 170hb, as shown in FIGS. 16 and 1D. The propeller hub 170hb is configured with a top to bottom (longitudinal) channel 170c that securely (firmly, tightly, snugly) holds the bottom end portion 172bep of the propeller shaft 172. The bottom end 172be of the propeller shaft 172 is secured to the bottom of the propeller hub 170hb via a bolt 170t.

The propeller shaft 172 is configured with a lower portion 1721p that is securely (firmly, tightly, snugly) held in a stable centrally aligned position within the lower portion of the outer tube 102, via a propeller shaft aligning and holding member 176. The propeller shaft aligning and holding member 176 includes a hub 176hb, a cylindrical member 176cl, and a plurality of spokes (braces, rods, bars), for example, three spokes 176s, extending between the hub 176hb and the cylindrical member 176cl, as shown in FIGS. 16 and 1D. The hub 176hb is configured with a top to bottom (longitudinal) channel 176c within which is securely (firmly, tightly, snugly) held the lower portion 1721p of the propeller shaft 172. A position fixing assembly 176pf, configured, for example, with a ring member and two screws threaded therein, is fixedly positioned on top of the hub 176hb, and facilitates the secure (firm, tight, snug) holding of the propeller shaft lower portion 1721p inside the hub channel 176c.

In exemplary embodiments, the cylindrical member 176cl of the propeller shaft aligning and holding member 176 includes a plurality of small sized holes 123 (configured, for example, for screws or nails), that facilitate firm connection (attachment) of the propeller shaft aligning and holding member 176 to the inside surface of the lower part of the outer tube 102. In exemplary embodiments, for example, as shown in FIGS. 1A-1D, 2 (left side), and 16, the small sized holes 123 in the cylindrical member 176cl are aligned with the small sized holes 120 in the outer tube 102, into which screws or nails are fitted, for firmly connecting (attaching) the cylindrical member 176, and thus, the propeller shaft aligning and holding member 176, to the inside surface of the lower part of the outer tube 102.

The propeller shaft motor assembly 174 is operatively connected (in FIG. 16, indicated by the dotted line arrow 180), via a shaft-to-shaft coupling assembly 182, to the propeller shaft 172. In exemplary embodiments, the propeller shaft motor assembly 174 includes a motor 174m, a drive shaft 174ds, electrical leads 174el, and a leads connector 174c.

In exemplary embodiments, the shaft-to-shaft coupling assembly 182 includes a bottom part 182bp and a top part 182tp. The bottom part 182bp is configured for securely (firmly, tightly, snugly) holding the propeller shaft top end portion 172tep (and top end 172te thereof). The top part 182tp is configured for securely (firmly, tightly, snugly) holding the drive shaft 174ds of the propeller shaft motor assembly 174. The electrical leads 174el are connected to the leads connector 174c, which, in turn, is configured for being reversibly connectable to (and disconnectable from) a corresponding mated power supply connector of a power supply and controller unit.

Controllable power is supplied to the motor 174m for controllably driving (rotating) the drive shaft 174ds. In turn, the drive shaft 174ds mechanically engages with, and drives, the propeller shaft 172, which then turns and rotates the propeller 170. Rotation of the propeller 170 facilitates forced continuous and directional flow, and, filtering and cleaning, of mikvah water from the mikvah into and through the outer tube mikvah water inlet openings (for example, inlet openings 112a, 112b, 112c, 114a, 114b, 114c, 114d) into and through the filter medium 104, into and through the middle tube openings 134 (s1, s2, bm) and the inner tube openings 140 (s1, s2, bm), and, into and through the outer tube bottom end portion 102bep (and the outer tube mikvah water outlet opening, for example, outlet opening 116, therein) back into the mikvah.

In exemplary embodiments, the propeller shaft motor assembly 174, and the shaft-to-shaft coupling assembly 182, are housed (in FIG. 16, indicated by the two dotted line arrows 186) inside a motor housing assembly 188. In exemplary embodiments, the motor housing assembly 188 includes a main housing 188mh, a housing top cover 188tc, and a housing bottom cover 188bc. In exemplary embodiments, the main housing 188mh includes a single connector opening (hole) 188ch configured for providing ready access to the leads connector 174c, and additionally includes a plurality of heat venting openings (holes) 188vh configured for venting (releasing) heat produced by the motor 174m. In exemplary embodiments, the bottom cover 188bc is configured with a flanged bottom portion 188fb that facilitates connection (attachment) thereof to the top end 108te of the inner tube 108, as shown, for example, in FIGS. 1A-1D, 2 (left side), and 3A-3C.

### Operation of the Mikvah Water Filtering and Cleaning Apparatus

FIG. 17 is a schematic drawing illustrating exemplary operation of the mikvah water filtering and cleaning apparatus (of FIGS. 1A-1D), highlighting the sequential water flow pathways (dotted line arrows) of mikvah water entering into, flowing inside and through, and exiting from, the mikvah water filtering and cleaning apparatus 100. As illustratively described hereinabove, rotation of the propeller 170 facilitates forced continuous and directional flow, and, filtering and cleaning, of mikvah water from the mikvah into and through the outer tube mikvah water inlet openings 112a, 112b, 112c, 114a, 114b, 114c, and 114d, of the outer tube 102, into and through the filter medium 104, into and through the middle tube openings 134 (s1, s2, bm) of the middle tube 106 and the spatially adjacently aligned and nearly coincidental inner tube openings 140 (s1, s2, bm) of the inner tube 108, into and through the cylindrical central hollow portion 150chp of the tubes and filter medium bottom ends holding member 150, and finally, into and through the outer tube bottom end portion 102bep (and the mikvah water outlet opening 116 therein) of the outer tube 102, back into the mikvah.

The combination of: (i) spatially adjacently aligned and nearly coincidental middle tube openings with inner tube openings; (ii) configuration of spaces or gaps in the bottommost openings (holes) of the middle tube; and (iii) configuration of the tubes and filter medium bottom ends holding member with a solid portion top surface gradient, having a gradient angle; along with other hereinabove illustratively described structural and functional (operational) features of the mikvah water filtering and cleaning apparatus 100, facilitate continuous unobstructed flow of mikvah water, and prevent formation of standing (static, non-moving, non-flowing) mikvah water, inside the mikvah water filtering and cleaning apparatus 100, and also contribute to achieving high mikvah water throughput and processing (filtering and cleaning), during operation of the apparatus 100.

The herein disclosed mikvah water filtering and cleaning apparatus 100 is designed, constructed, and operated, in ways that result in full compliance with all three of the well established requirements (rules, regulations), interpretations thereof, and guidelines thereof, regarding how mikvah water may be cleaned by using a water cleaning apparatus, according to Jewish religious and legal laws (halacha). Namely, first, during operation, any and all components or parts of the apparatus 100 that is/are in contact with the mikvah water is/are absent of standing (static, non-moving, non-flowing) mikvah water. Second, during operation, the apparatus 100 does not remove any amount of mikvah water from the mikvah. Third, during operation of the apparatus 100, the mikvah water passing (flowing) therethrough is always in continuous contact (fluid communication) with mikvah water located immediately adjacent to and outside of the apparatus 100. The term ‘continuous contact (fluid communication)’, as used herein, means that mikvah water flowing along an entire (full) path (passageway) through (from input into, and output from) the apparatus 100, is absent of any physical separation (or barrier), having width, length, or height, less than 45 mm (4.5 cm).

### Wall Securing Assembly

The mikvah water filtering and cleaning apparatus 100 is configured for operating in a top to bottom (vertically/longitudinally) directed position, whereby the top to bottom (vertical/longitudinal) length (height) of the outer tube 102 is essentially parallel to a wall of a mikvah (mikvah wall), and the outer tube bottom end 102be is essentially transverse (orthogonal) to the mikvah wall and parallel to the floor of the mikvah. In exemplary embodiments, the mikvah water filtering and cleaning apparatus 100, in such top to bottom (vertically/longitudinally) directed position, is reversibly, securely (firmly, tightly, snugly) and stably connected (attached) to a wall of a mikvah (mikvah wall). In exemplary embodiments, a mikvah water filtering and cleaning apparatus wall securing assembly (wall securing assembly) is configured, and used, for facilitating such secure and stable connection of the mikvah water filtering and cleaning apparatus 100 to a mikvah wall.

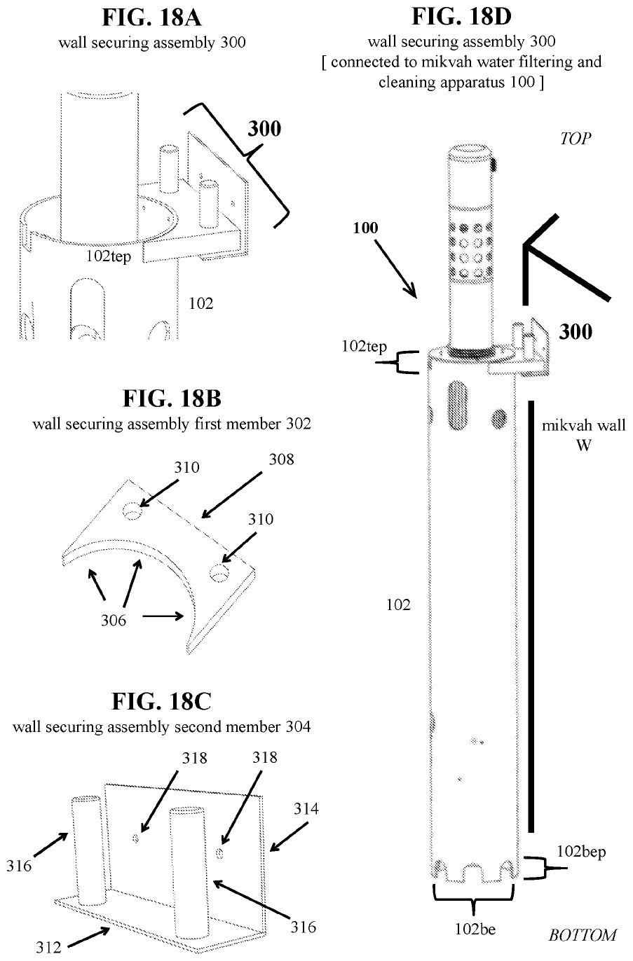

FIGS. 18A-18C are schematic perspective views of exemplary embodiments of a mikvah water filtering and cleaning apparatus wall securing assembly 300 (FIG. 18A), a first member 302 thereof (FIG. 18B), and a second member 304 thereof (FIG. 18C).

In exemplary embodiments, the first member 302 of the wall securing assembly 300 is configured in a form of a semi-square or semi-rectangular plate 308 having a semi-circular/semi-cylindrical portion 306 and two openings (holes) 310. The semi-circular/semi-cylindrical portion 306 is configured for securely (firmly, tightly, snugly) engaging with the outer circumferential periphery of the outer tube top end portion 102tep of the mikvah water filtering and cleaning apparatus 100 (for example, as shown in FIG. 18D).

In exemplary embodiments, the second member 304 of the wall securing assembly 300 is configured in a form of a folded plate having two main sides 312 and 314 perpendicular to each other. The folded plate first main side 312 has two (hollow or solid) cylindrical rods or bars 316, that are configured for securely and stably engaging with the openings (holes) 310 of the first member 302. The folded plate second main side 314 has two openings (holes) 318 that are configured for passage therethrough of screws, that facilitate secure and stable connection (attachment) of the folded plate second main side 314, and of the overall second member 304, to a wall of a mikvah.

FIG. 18D is a schematic perspective view of the exemplary embodiment of the mikvah water filtering and cleaning apparatus wall securing assembly 300 connected (attached) to the mikvah water filtering and cleaning apparatus 100. Therein, the wall securing assembly 300 is reversibly, securely and stably connected (attached) to a mikvah wall W, thereby, securely and stably connecting the apparatus 100 to the mikvah wall W.

### Filter Medium Removal and Replacement Device

The filter medium 104 is removable from the mikvah water filtering and cleaning apparatus 100, and replaceable (either with a brand new filter medium 104, or after being cleaned and reconditioned for further use) in the mikvah water filtering and cleaning apparatus 100. In exemplary embodiments, removal and replacement of the filter medium 104 is performed with the mikvah water filtering and cleaning apparatus 100 remaining in-situ (in place) securely (firmly, tightly, snugly) and stably connected (attached) to a mikvah wall (for example, via wall securing assembly 300). In alternative exemplary embodiments, for example, when there is need to remove the entire mikvah water filtering and cleaning apparatus 100 (with its not yet cleaned filter medium 104) out from the mikvah, removal and replacement of the filter medium 104 is performed with the mikvah water filtering and cleaning apparatus 100 outside of the mikvah (for example, via detaching mikvah water filtering and cleaning apparatus 100 from wall securing assembly 300).

Following are described two categories of exemplary embodiments of the filter medium 104 configured for being operative in the mikvah water filtering and cleaning apparatus 100, whereby the filter medium 100 eventually becomes undesirably unclean with substantial decrease in its ability to properly filter and clean the mikvah water entering into the apparatus 100.

In a first category of exemplary embodiments, the filter medium 104 is configured for being operative in the apparatus 100, without removal therefrom, for a period of time (depending upon several factors and operating conditions), after which the filter medium 104 is one time permanently removed from the apparatus 100 and then discarded, without being cleaned and reconditioned for further use in the apparatus 100, followed by replacing the used filter medium 104 with a brand new filter medium 104.

Alternatively, in a second category of exemplary embodiments, the filter medium 104 is configured for being operative in the apparatus 100 for a period of time (depending upon several factors and operating conditions), after which the filter medium 104 is removed from the apparatus 100, and then cleaned and reconditioned for further use in the apparatus 100, followed by replacing the cleaned and reconditioned filter medium 104 back into the apparatus 100. According to such embodiments, the cyclical sequence of removing the filter medium 104, cleaning and reconditioning the used filter medium 104, and replacing the cleaned and reconditioned filter medium 110 back into the apparatus 100, is performed a number of times, so long as the cleaned and reconditioned filter medium 104 is in a proper operative condition for continuing to filter and clean mikvah water entering into the apparatus 100.

For either of the preceding first or second category of exemplary embodiments, there is need for removing the used filter medium 104, and replacing it with either a brand new filter medium 104, or with a cleaned and reconditioned filter medium 104. According to another aspect of the present disclosure, there is provision of a device for removal and replacement of a filter medium, for use with an apparatus for filtering and cleaning water in a mikvah, which complies with Jewish religious laws. Disclosed herein are two main different types (a first type, and a second type) of a device for removal and replacement of a filter medium (for example, filter medium 104), for use with an apparatus for filtering and cleaning water in a mikvah (for example, mikvah water filtering and cleaning apparatus 100), which complies with Jewish religious laws.

### First Type

FIGS. 19A and 19B are schematic assembled and exploded views, respectively, of an exemplary embodiment of the filter medium removal and replacement device [first type] 330. FIG. 19C is a schematic perspective view of the exemplary embodiment of the filter medium removal and replacement device [first type] 330 connected to the mikvah water filtering and cleaning apparatus 100.

The filter medium removal and replacement device [first type] 330 includes a manual handle assembly 332 that is operatively connected to a pair of tube or rod connectors 334, which, in turn, is reversibly, connectable to, and disconnectable from, the mikvah water filtering and cleaning apparatus 100.

In exemplary embodiments, the manual handle assembly 332 is configured as a tube or rod with a shape and size that facilitate an operator to ergonomically firmly place one or two hands thereupon, and to manipulate top to bottom longitudinally directed motion thereof relative to the mikvah water filtering and cleaning apparatus 100. The tube or rod 332 has two horizontally directed opposite end portions configured with two respective top to bottom longitudinally directed tubular channels 332tc oppositely positioned and parallel relative to each other.

In exemplary embodiments, in the pair of tube or rod connectors, each tube or rod connector 334 longitudinally extends downwardly and upwardly between tube or rod connector top and bottom ends. Each tube or rod connector 334 has atop end portion 334tep wherein the top end thereof passes through a respective one of the tubular channels 332tc, and is reversibly, transversely, fixedly connected, via bolts 336 and 338, to one of the opposite end portions of the manual handle assembly tube or rod 332. Additionally, each tube or rod connector 334 has a bottom end portion 334bep wherein the bottom end is configured with a screw threading (for example, male screw threading) 334bt that is screwable with a mated screw threading (for example, female screw threading 132) configured in a top portion (for example, in the filter medium and middle tube top ends cover assembly 130) of the mikvah water filtering and cleaning apparatus 100 that covers, and is engaged with, the filter medium top end 104te. In exemplary embodiments, the pair of tube or rod connectors 334 is configured to be removably placeable, in a form of a bridge, over the motor housing 188 and engageable with the mated screw threading 132 of the mikvah water filtering and cleaning apparatus 100, for example, as particularly shown in FIG. 19C.

FIG. 20 is a schematic diagram illustrating an exemplary embodiment of sequential removal (a), (b), and (c), of the filter medium 104, via the filter medium removal and replacement device [first type] 330, from the mikvah water filtering and cleaning apparatus 100. Sequential replacement of the filter medium 104 back into the mikvah water filtering and cleaning apparatus 100 corresponds to the reverse sequence, namely, (c), (b), and (a).

### Second Type

FIGS. 21A and 21B are schematic assembled and exploded views, respectively, of an exemplary embodiment of the filter medium removal and replacement device [second type] 350. FIG. 21C is a schematic perspective view of the exemplary embodiment of the filter medium removal and replacement device [second type] 350 connected to the mikvah water filtering and cleaning apparatus 100.

The filter medium removal and replacement device [second type] 350 includes a manual handle assembly 352 that is operatively connected to an extension member 354. The extension member 354 is operatively connected to a tubular connector assembly 356, which, in turn, is reversibly, connectable to, and disconnectable from, the mikvah water filtering and cleaning apparatus 100.

In exemplary embodiments, the manual handle assembly 352 includes a manual handle 358 and a handle holder 360 that holds the manual handle 358. The manual handle assembly 352 is configured with a shape and size that facilitate an operator to ergonomically firmly place one or two hands thereupon, and to manipulate top to bottom longitudinally directed motion thereof relative to the mikvah water filtering and cleaning apparatus 100.

In exemplary embodiments, the extension member 354 is configured as a tube or rod, longitudinally extending downwardly and upwardly between the tube or rod top and bottom ends 354te and 354be, respectively. The extension member top end 354te is fixedly connected to the bottom end of the handle holder 360, so as to provide top to bottom longitudinal extension of the manual handle assembly 352.

In exemplary embodiments, the tubular connector assembly 356 includes a tubular body 356tb, a top end cover 356tec, and a bottom end cover 356bec. The tubular body 356tb longitudinally extends downwardly and upwardly between the tubular body top and bottom ends 356te and 356be, respectively. The top end cover 356tec is fixedly connected to the bottom end 354be of the extension member tube or rod 354. The bottom end cover 356bec is configured with a screw threading (for example, a female screw threading) that is screwable with a mated screw threading (for example, male screw threading 133) configured in a top portion (for example, in the filter medium and middle tube top ends cover assembly 130) of the mikvah water filtering and cleaning apparatus 100 that covers, and is engaged with, the filter medium top end 104te. In exemplary embodiments, the tubular connector assembly 356 is configured to be removably placeable over the motor housing 188 and engageable with the mated screw threading 133 of the mikvah water filtering and cleaning apparatus 100, for example, as particularly shown in FIG. 21C.

FIG. 22 is a schematic diagram illustrating an exemplary embodiment of sequential removal (a), (b), and (c), of the filter medium 104, via the filter medium removal and replacement device [second type] 350, from the mikvah water filtering and cleaning apparatus 100. Sequential replacement of the filter medium 104 back into the mikvah water filtering and cleaning apparatus 100 corresponds to the reverse sequence, namely, (c), (b), and (a).

### Exemplary (Actual) Prototype of the Mikvah Water Filtering and Cleaning Apparatus, and Components Thereof

The following figures are of photographs showing various views of an exemplary (actual) prototype mikvah water filtering and cleaning apparatus [indicated as, and referred to by, reference number p100], and components thereof. For purposes of preserving clarity and consistency, in the following illustrative description, the components, and the structural features, of the prototype mikvah water filtering and cleaning apparatus p100 are assigned ‘identically’ the same reference numbers as the respectively corresponding components, and structural features, of the exemplary mikvah water filtering and cleaning apparatus 100 illustratively described hereinabove.

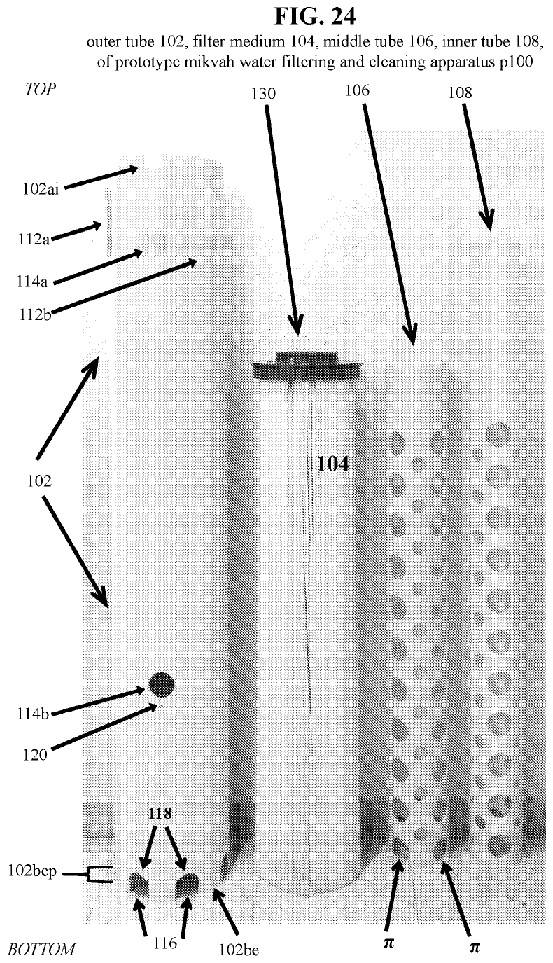

FIGS. 23A and 23B are photographs showing front and back views, respectively, of the exemplary (actual) prototype mikvah water filtering and cleaning apparatus p100. FIG. 24 is a photograph of the outer tube 102, the filter medium 104, the middle tube 106, and the inner tube 108, of the exemplary prototype mikvah water filtering and cleaning apparatus p100 (of FIGS. 23A, 23B).

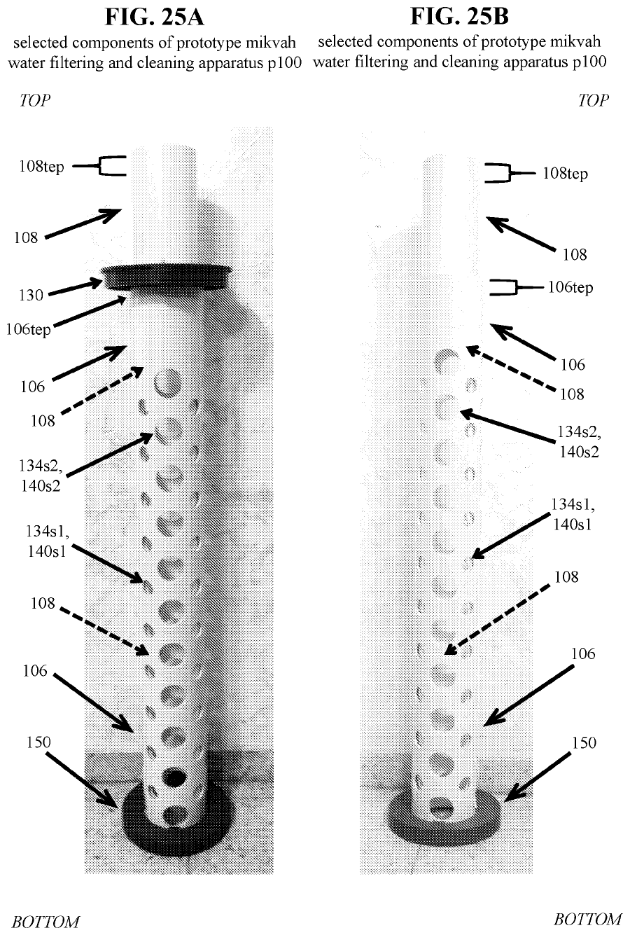

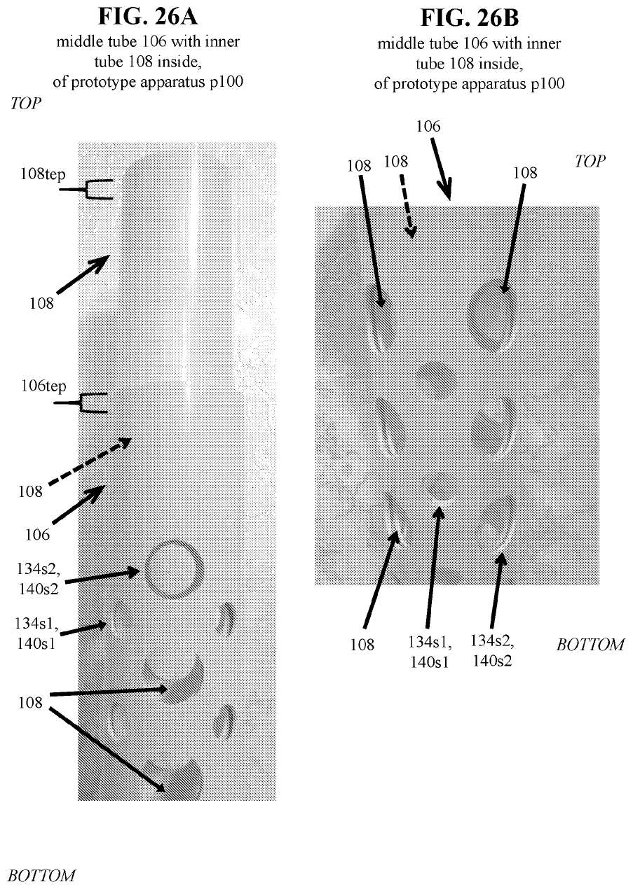

FIGS. 25A and 25B are photographs of selected components of the exemplary prototype mikvah water filtering and cleaning apparatus p100 (of FIGS. 23A, 23B). FIGS. 26A and 26B are photographs showing close-up views of the middle tube 106 with the inner tube 108 inside, of the exemplary prototype mikvah water filtering and cleaning apparatus p100. As shown in these figures, the inner tube 108 is collaterally securely (firmly, tightly, snugly) positioned within and along the middle tube 106, such that the plurality of middle tube openings 134 (s1, s2) are spatially adjacently aligned and nearly coincide with the plurality of inner tube openings 140 (s1, s2). Also shown therein are exemplary actual relative positions and sizes of the middle tube 106, the inner tube 108, the filter medium and middle tube top ends cover assembly 130, and the middle and inner tubes bottom ends and filter medium bottom end holding member 150.

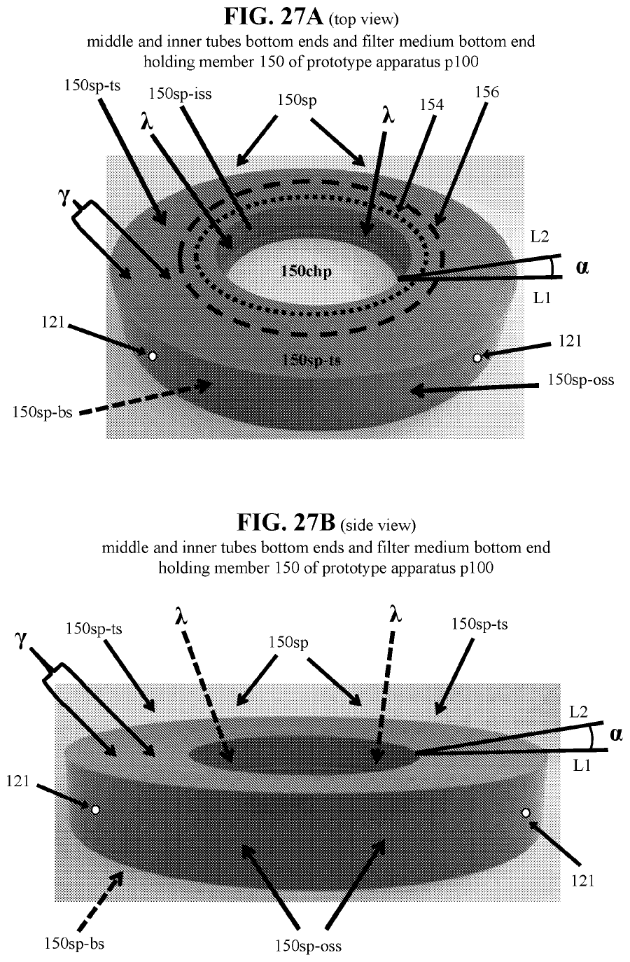

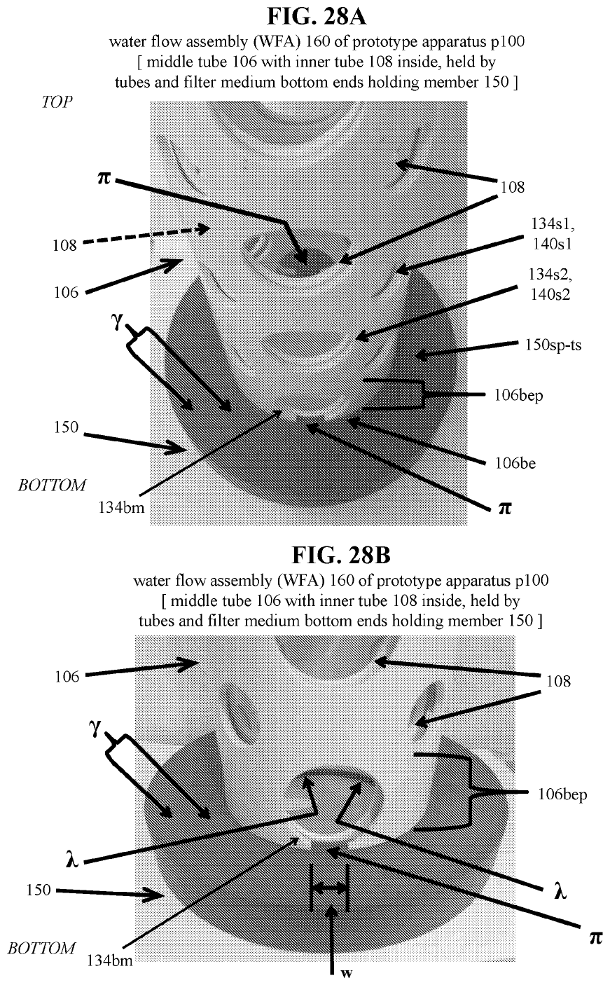

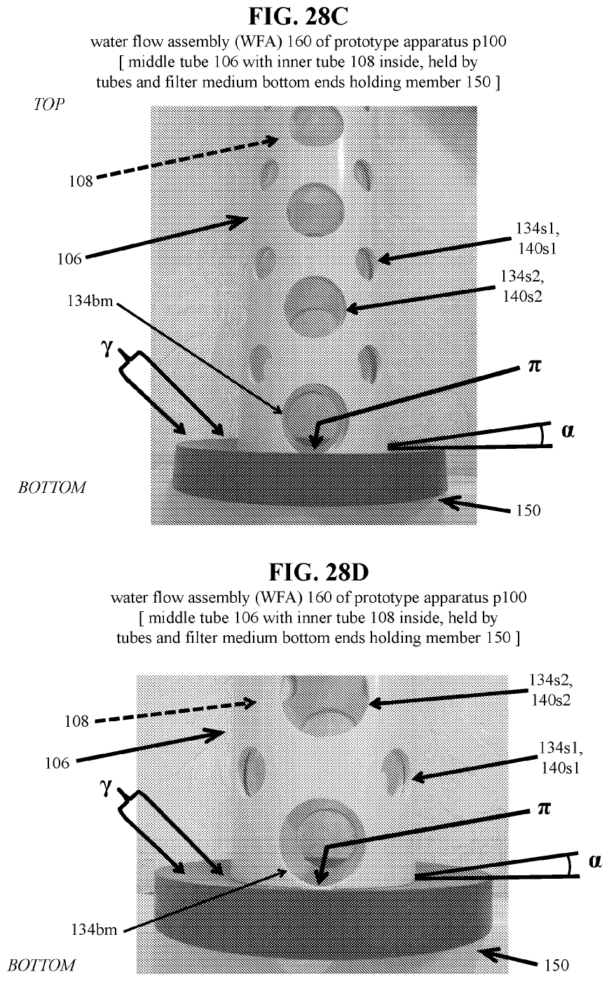

FIGS. 27A and 27B are photographs showing close-up perspective top and side views, respectively, of an exemplary embodiment of the middle and inner tubes bottom ends and filter medium bottom end holding member 150, of the exemplary prototype mikvah water filtering and cleaning apparatus p100, highlighting the gradient (inclination, slope, slant) γ of the solid portion top surface (150sp-ts), and the gradient (inclination, slope, slant) angle α thereof. FIGS. 28A and 28B are photographs showing close-up views of the lower part of the middle tube 106 with the inner tube 108 inside, held by the middle and inner tubes bottom ends and filter medium bottom end holding member 150, corresponding to the water flow assembly (WFA) 160, of the exemplary prototype mikvah water filtering and cleaning apparatus p100. Highlighted therein are the gaps R (of width w) in the middle tube bottommost openings 134bm, and the gradient (inclination) γ along the solid portion top surface (150sp-ts) of the bottom ends holding member 150. FIGS. 28C and 28D are photographs showing additional close-up views of the lower part of the middle tube 106 with the inner tube 108 inside, held by the middle and inner tubes bottom ends and filter medium bottom end holding member 150, corresponding to the water flow assembly (WFA) 160, of the exemplary prototype mikvah water filtering and cleaning apparatus p100. Highlighted therein are the gaps R in the middle tube bottommost openings 134bm, the gradient (inclination) γ along the solid portion top surface (150sp-ts) of the bottom ends holding member 150, and the gradient (inclination) angle α thereof. Also shown in FIGS. 27A-28D are the exemplary actual relative positions and sizes of the middle tube 106, the inner tube 108, and the middle and inner tubes bottom ends and filter medium bottom end holding member 150.

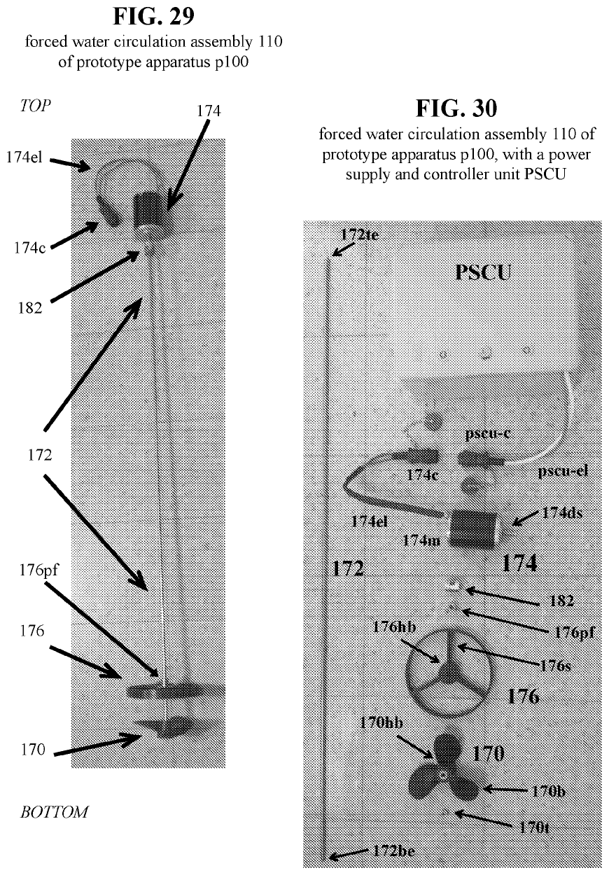

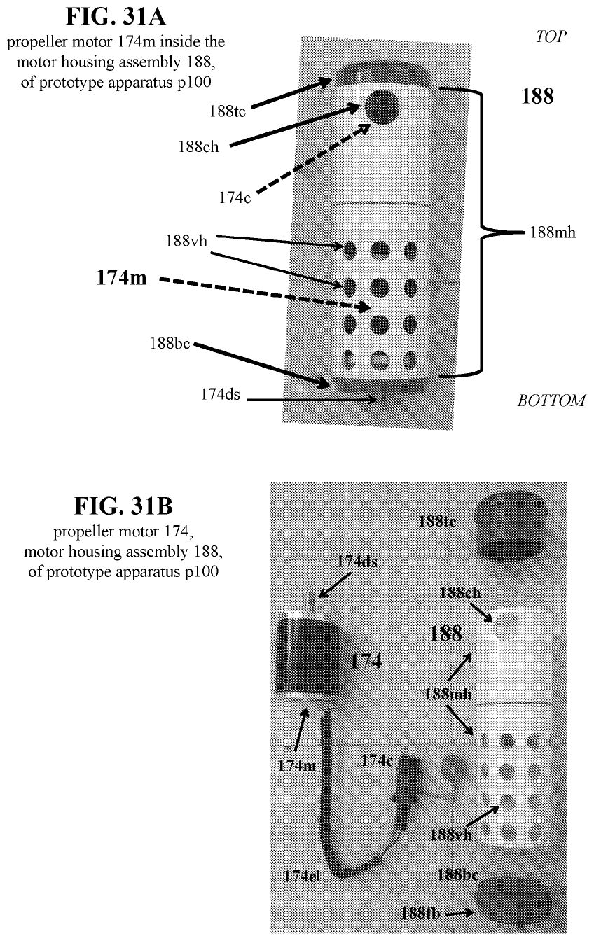

FIGS. 29 and 30 are photographs of the forced water circulation assembly 110, as assembled [FIG. 29], and the individual components thereof, with an exemplary power supply and controller unit (PSCU) [FIG. 30], of the exemplary prototype mikvah water filtering and cleaning apparatus p100. In FIG. 30, exemplary power supply and controller unit (PSCU) includes power supply unit electrical leads (pscu-el) whose end portion is configured with a power supply unit connector (pscu-c) that is reversibly connectable to (and disconnectable from) the corresponding mated leads connector 174c of the propeller shaft motor assembly 174. FIGS. 31A and 31B are photographs of the forced water circulation assembly motor housing assembly 188 with the propeller motor 174m inside, as assembled [FIG. 31A], and the individual components thereof [FIG. 31B], of the exemplary prototype mikvah water filtering and cleaning apparatus p100.

### Exemplary (Actual) Prototype of the Mikvah Water Filtering and Cleaning Apparatus Wall Securing Assembly

The following figures are of photographs showing various views of an exemplary (actual) prototype mikvah water filtering and cleaning apparatus wall securing assembly [indicated as, and referred to by, reference number p300], and components thereof. For purposes of preserving clarity and consistency, in the following illustrative description, the components, and the structural features, of the prototype mikvah water filtering and cleaning apparatus wall securing assembly p300 are assigned ‘identically’ the same reference numbers as the respectively corresponding components, and structural features, of the exemplary mikvah water filtering and cleaning apparatus wall securing assembly 300 illustratively described hereinabove.

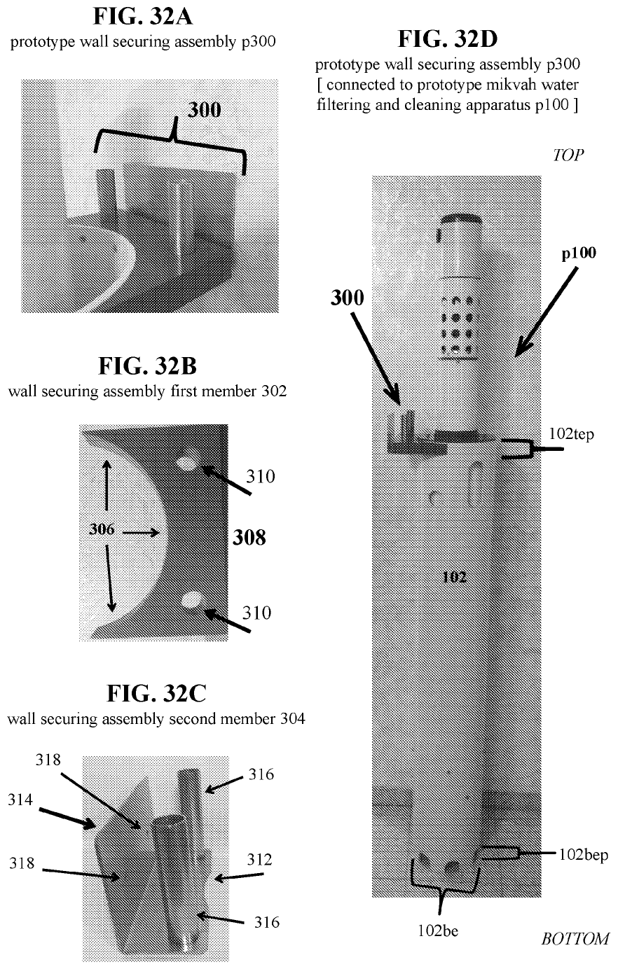

FIGS. 32A-32C are photographs of the exemplary prototype mikvah water filtering and cleaning apparatus wall securing assembly p300 [FIG. 32A], of the first member 302 thereof [FIG. 32B], and of the second member 304 thereof [FIG. 32C]. FIG. 32D is a photograph of the exemplary prototype mikvah water filtering and cleaning apparatus wall securing assembly p300 connected to the exemplary prototype mikvah water filtering and cleaning apparatus p100.

### Exemplary (Actual) Prototypes of the Filter Medium Removal and Replacement Device

The following figures are of photographs showing various views of exemplary (actual) prototypes of the two main different types (the first type, and the second type) of the filter medium removal and replacement device [indicated as, and referred to by, reference numbers p330 and p350, respectively], and components thereof. For purposes of preserving clarity and consistency, in the following illustrative description, the components, and the structural features, of the prototype filter medium removal and replacement devices p330 [first type] and p350 [second type] are assigned ‘identically’ the same reference numbers as the respectively corresponding components, and structural features, of the exemplary two main different types (first type, and second type) of the filter medium removal and replacement devices 330 and 350, respectively, illustratively described hereinabove.

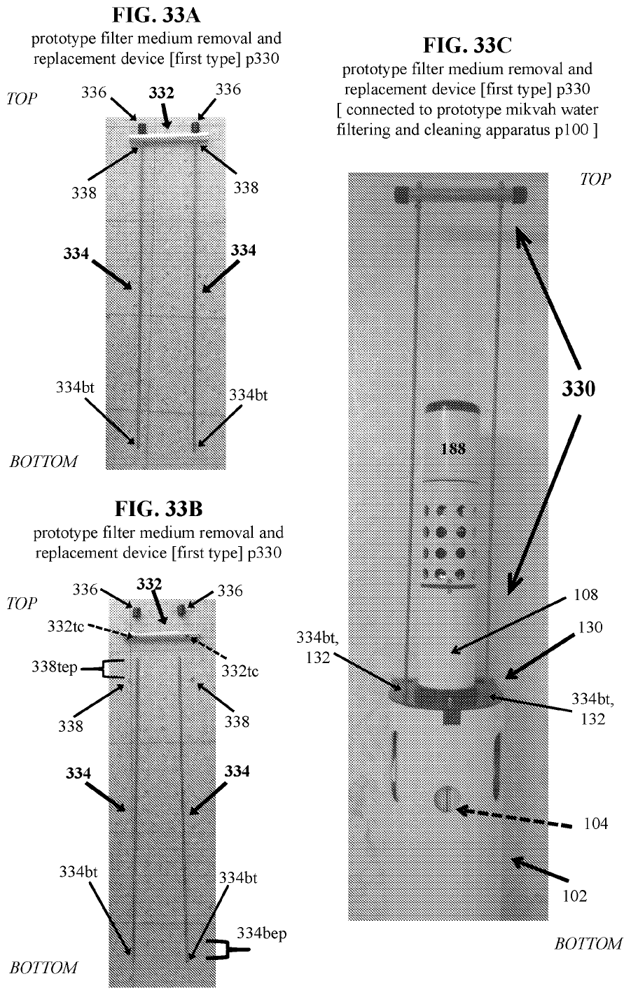

FIGS. 33A and 33B are photographs of the exemplary prototype filter medium removal and replacement device [first type] p330, as assembled [FIG. 33A], and of the individual components thereof [FIG. 33B]. FIG. 33C is a photograph of the exemplary prototype filter medium removal and replacement device [first type] p330 connected to the exemplary prototype mikvah water filtering and cleaning apparatus p100.

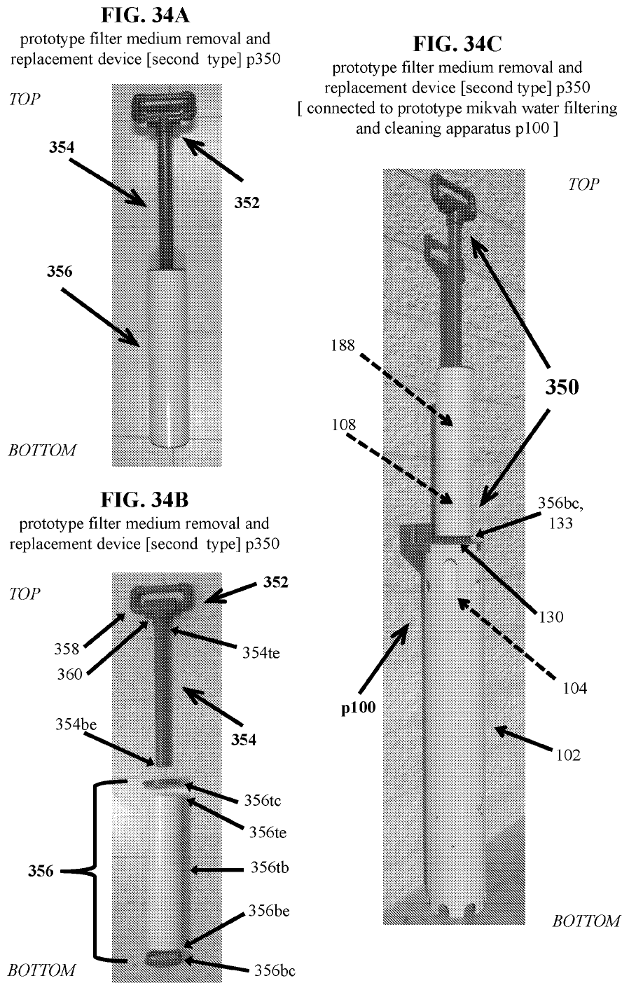

FIGS. 34A and 34B are photographs of the exemplary prototype filter medium removal and replacement device [second type] p350, as assembled [FIG. 34A], and of the individual components thereof [FIG. 34B]. FIG. 34C is a photograph of the exemplary prototype filter medium removal and replacement device [second type] p350 connected to the exemplary prototype mikvah water filtering and cleaning apparatus p100.

### Exemplary ‘In-Mikvah’ Application of the Mikvah Water Filtering and Cleaning Apparatus

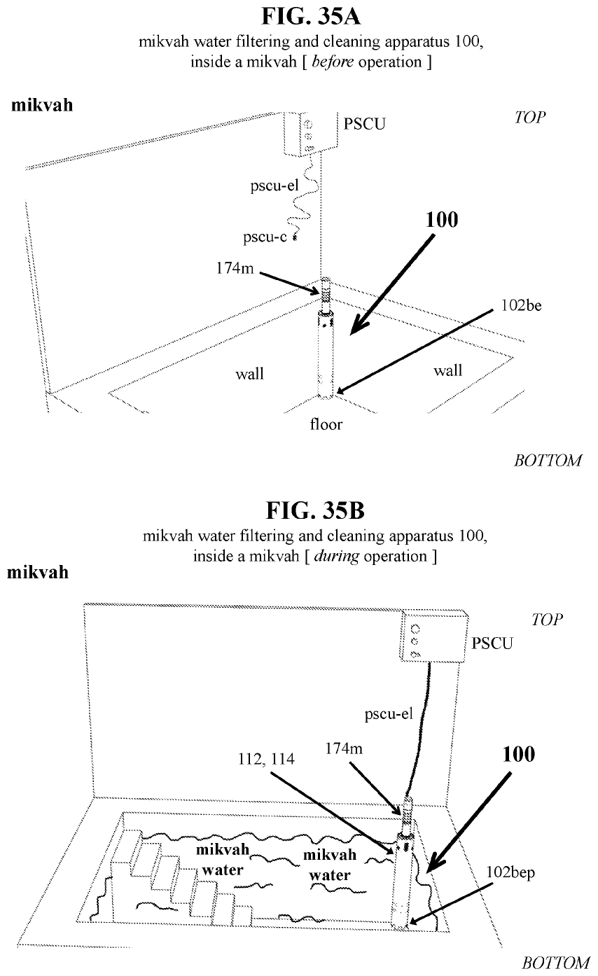

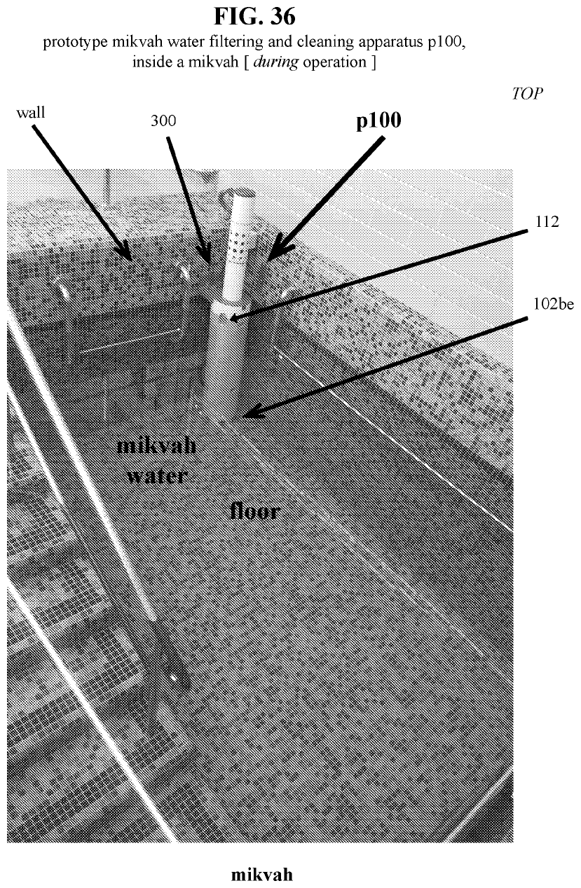

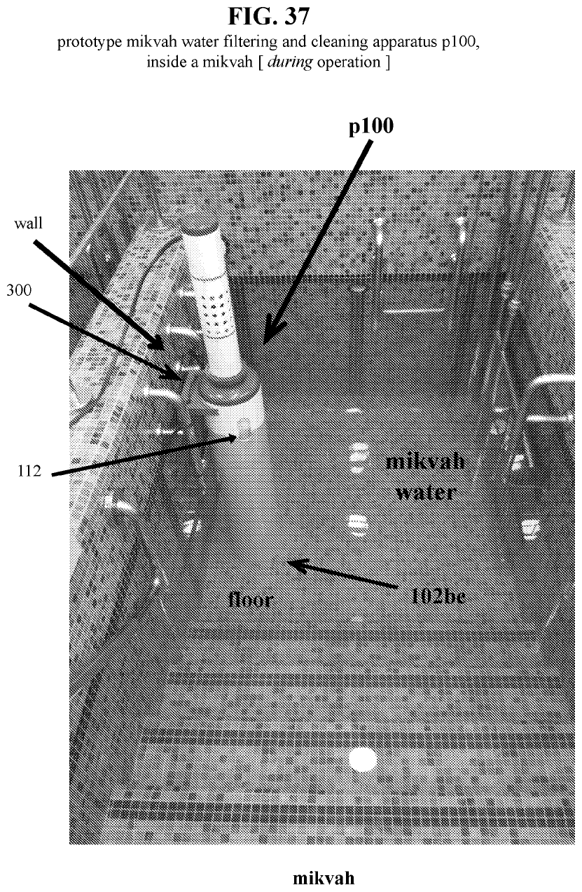

FIGS. 35A and 35B are schematic diagrams illustrating exemplary ‘in-mikvah’ application of the exemplary mikvah water filtering and cleaning apparatus 100, before operation [FIG. 35A], and during operation [FIG. 35B], inside a mikvah. FIGS. 36 and 37 are photographs showing exemplary actual ‘in-mikvah’ application of the exemplary prototype mikvah water filtering and cleaning apparatus p100 during operation inside a mikvah.

Application and operation of the exemplary mikvah water filtering and cleaning apparatus 100 (FIGS. 35A, 35B), and of the exemplary prototype mikvah water filtering and cleaning apparatus p100 (FIGS. 36, 37), are in accordance with that shown in previously referenced FIG. 17 which schematically highlights sequential water flow pathways (dotted line arrows) of mikvah water entering into, flowing inside and through, and exiting from, the mikvah water filtering and cleaning apparatus 100.

Another aspect of the present disclosure is provision of a method for filtering and cleaning water in a mikvah, which complies with Jewish religious laws. With reference to FIGS. 35A-35B, 36, and 37, in exemplary embodiments, the mikvah water filtering and cleaning method includes: (i) placing and securing a mikvah water filtering and cleaning apparatus (for example, the herein disclosed mikvah water filtering and cleaning apparatus 100 or 100p) inside the mikvah, either before or after the mikvah is filled with water; (ii) operatively connecting the motor 174m of the forced water circulation assembly 110 to a power supply and controller unit (PSCU); and (iii) for the mikvah filled with water, activating the motor 174m, so as to facilitate forced continuous and directional flow, and, filtering and cleaning, of the mikvah water from the mikvah into, through, and out from, the mikvah water filtering and cleaning apparatus (100 or 100p).

In such exemplary embodiments, the mikvah water filtering and cleaning apparatus (100 or 100p) that is placed inside the mikvah includes: an outer tube 102, a tubular filter medium 104, a middle tube 106, an inner tube 108, and a forced water circulation assembly 110 operatively connected to the outer, middle, and inner tubes, whereby the numerous structural and functional aspects and features of these components are illustratively described hereinabove.

The mikvah water filtering and cleaning apparatus (100 or 100p) is placeable inside the mikvah according to any of a variety of different possible positions and configurations. In exemplary embodiments, the mikvah water filtering and cleaning apparatus (100 or 100p) is placed and configured inside the mikvah for operating in a top to bottom (vertically/longitudinally) directed position, whereby the top to bottom (vertical/longitudinal) length (height) of the outer tube 102 is essentially parallel to a wall of the mikvah (mikvah wall), and the outer tube bottom end 102be is essentially transverse (orthogonal) to the mikvah wall and parallel to the floor of the mikvah.

In exemplary embodiments, the mikvah water filtering and cleaning apparatus (100 or 100p), in such top to bottom (vertically/longitudinally) directed position, is reversibly, securely (firmly, tightly, snugly) and stably connected (attached) to a wall of the mikvah (mikvah wall). In exemplary embodiments, such reversible, secure and stable connecting (attaching) of the mikvah water filtering and cleaning apparatus (100 or 100p) to the mikvah wall is facilitated by using a mikvah water filtering and cleaning apparatus wall securing assembly (for example, the herein disclosed wall securing assembly 300 or 300p).

### Exemplary ‘In-Mikvah’ Application of the Filter Medium Removal and Replacement Device

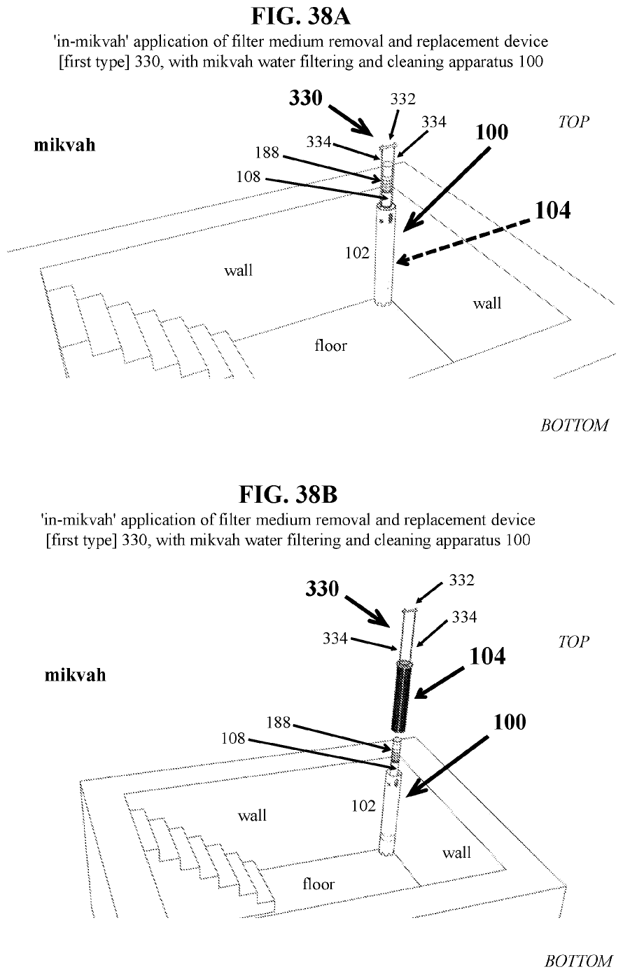

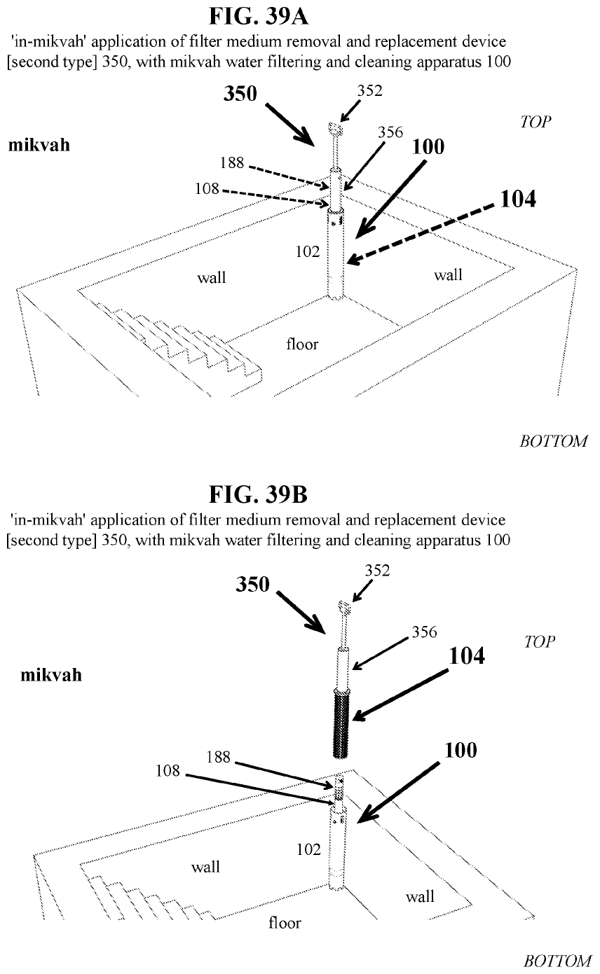

FIGS. 38A and 38B are schematic diagrams illustrating exemplary ‘in-mikvah’ application of the filter medium removal and replacement device [first type] 330, with the exemplary mikvah water filtering and cleaning apparatus 100. FIGS. 39A and 39B are schematic diagrams illustrating exemplary ‘in-mikvah’ application of the filter medium removal and replacement device [second type] 350, with the exemplary mikvah water filtering and cleaning apparatus 100. In FIGS. 38A and 39A, the mikvah water filtering and cleaning apparatus 100 includes the filter medium 104, which is present, but, not viewable, as indicated by the dashed line arrows 104.

As shown FIGS. 38A-39B, the filter medium removal and replacement devices 330, 350 are applied for removing and replacing the filter medium 104 with the mikvah water filtering and cleaning apparatus 100 remaining in the mikvah (in-situ, in place) securely (firmly, tightly, snugly) and stably connected (attached) to the mikvah wall. Exemplary ‘in-mikvah’ application of the filter medium removal and replacement devices [first type] 330, and [second type] 350, with the exemplary mikvah water filtering and cleaning apparatus 100, are in accordance with that shown in FIGS. 20, and 22, respectively, which schematically illustrate sequential removal (a), (b), and (c), of the filter medium 104 from the mikvah water filtering and cleaning apparatus 100, and sequential replacement (c), (b), and (a), of either a brand new or cleaned and reconditioned filter medium 104 back into the mikvah water filtering and cleaning apparatus 100.

### Exemplary Materials of Construction, and Exemplary Size Dimensions, of Components of the Mikvah Water Filtering and Cleaning Apparatus

The following, in a non-limiting manner, is presentation of exemplary materials of construction, and exemplary size dimensions, of components of the herein disclosed mikvah water filtering and cleaning apparatus. Implementation and practice of embodiments of the herein disclosed invention are not limited to the below presented exemplary materials and size dimensions. Alternative or additional materials of construction and size dimensions may be used for implementing and practicing embodiments of the herein disclosed invention.

Components of the mikvah water filtering and cleaning apparatus are made of materials that are (to a large extent) rust and corrosion resistant, and which are capable of providing a relatively long lifetime (for example, of up to several years) of continuous, robust use and operation of these devices in a mikvah water environment. In exemplary embodiments, apparatus components are made mostly of plastic materials, except for some selected components, electrical components, and small screws or/and nails which, instead of plastic, are made of rust and corrosion resistant metallic materials. In exemplary embodiments, selected components of the mikvah water filtering and cleaning apparatus are made of composite materials, being materials consisting of combinations of plastic, metal, or/and ceramic materials, that are rust and corrosion resistant. In exemplary embodiments, selected components of the mikvah water filtering and cleaning apparatus are made of a suitable combination of plastic materials, metallic materials, and composite materials.

### Outer Tube (102)

Top to bottom (longitudinal) length (height): 50 cm-500 cm.
Outer diameter (width): 10 cm-250 cm.
   Filter medium (104)
Material: cloth or cloth-type fabric or material made from flax or linen, and having small sized holes throughout the material, suitable for filtering and cleaning water of a mikvah.
Top to bottom (longitudinal) length (height): 20 cm-400 cm.
Outer diameter (width): 10 cm-230 cm.

### Middle Tube (106)

Top to bottom (longitudinal) length (height): 20 cm-400 cm.
Outer diameter (width): 10 cm-230 cm.

### Inner Tube (108)

Top to bottom (longitudinal) length (height): 60 cm-600 cm.
Outer diameter (width): 8 cm-225 cm.

### Forced Water Circulation Assembly (110)

Capable of routine and continuous operation for forcibly circulating the mikvah water through the mikvah water filtering and cleaning apparatus, at a volumetric rate of up to 10,000 liters (cubic meters)-20,000 liters (cubic meters) of mikvah water per hour.

Operative via direct current (DC) with, for example, 24 volts DC, or 12 volts DC.

Capable of routine and continuous operation with power in a range of between 100 watts and 2,000 watts, for example, 500 watts.

In exemplary embodiments, the mikvah water filtering and cleaning apparatus wall securing assembly, and the filter medium removal and replacement device [first and second types], are made of the same (above listed) materials as for the mikvah water filtering and cleaning apparatus.

Each of the following terms written in singular grammatical form: ‘a’, ‘an’, and ‘the’, as used herein, means ‘at least one’, or ‘one or more’. Use of the phrase ‘one or more’ herein does not alter this intended meaning of ‘a’, ‘an’, or ‘the’. Accordingly, the terms ‘a’, ‘an’, and ‘the’, as used herein, may also refer to, and encompass, a plurality of the stated entity or object, unless otherwise specifically defined or stated herein, or, unless the context clearly dictates otherwise. For example, the phrases: ‘a unit’, ‘a device’, ‘an assembly’, ‘a mechanism’, ‘a component’, ‘an element’, and ‘a step or procedure’, as used herein, may also refer to, and encompass, a plurality of units, a plurality of devices, a plurality of assemblies, a plurality of mechanisms, a plurality of components, a plurality of elements, and, a plurality of steps or procedures, respectively.

Each of the following terms: ‘includes’, ‘including’, ‘has’, ‘having’, ‘comprises’, and ‘comprising’, and, their linguistic/grammatical variants, derivatives, or/and conjugates, as used herein, means ‘including, but not limited to’, and is to be taken as specifying the stated component(s), feature(s), characteristic(s), parameter(s), integer(s), or step(s), and does not preclude addition of one or more additional component(s), feature(s), characteristic(s), parameter(s), integer(s), step(s), or groups thereof.

Each of the phrases ‘consisting of’, and ‘consists of’, as used herein, means ‘including and limited to’.

Each of the phrases ‘consisting essentially of’, and ‘consists essentially of’, as used herein, means that the stated entity or item (system, system unit, system sub-unit, device, assembly, sub-assembly, mechanism, structure, component, element, or, peripheral equipment, utility, accessory, or material, method or process, step or procedure, sub-step or sub-procedure), which is an entirety or part of an exemplary embodiment of the disclosed invention, or/and which is used for implementing an exemplary embodiment of the disclosed invention, may include at least one additional ‘feature or characteristic’ being a system unit, system sub-unit, device, assembly, sub-assembly, mechanism, structure, component, or element, or, peripheral equipment, utility, accessory, or material, step or procedure, sub-step or sub-procedure), but only if each such additional ‘feature or characteristic’ does not materially alter the basic novel and inventive characteristics or special technical features, of the claimed entity or item.

The term ‘method’, as used herein, refers to a single step, procedure, manner, means, or/and technique, or a sequence, set, or group of two or more steps, procedures, manners, means, or/and techniques, for accomplishing or achieving a given task or action. Any such herein disclosed method, in a non-limiting manner, may include one or more steps, procedures, manners, means, or/and techniques, that are known or readily developed from one or more steps, procedures, manners, means, or/and techniques, previously taught about by practitioners in the relevant field(s) and art(s) of the herein disclosed invention. In any such herein disclosed method, in a non-limiting manner, the stated or presented sequential order of one or more steps, procedures, manners, means, or/and techniques, is not limited to that specifically stated or presented sequential order, for accomplishing or achieving a given task or action, unless otherwise specifically defined or stated herein, or, unless the context clearly dictates otherwise. Accordingly, in any such herein disclosed method, in a non-limiting manner, there may exist one or more alternative sequential orders of the same steps, procedures, manners, means, or/and techniques, for accomplishing or achieving a same given task or action, while maintaining same or similar meaning and scope of the herein disclosed invention.

Throughout this disclosure, a numerical value of a parameter, feature, characteristic, object, or dimension, may be stated or described in terms of a numerical range format. Such a numerical range format, as used herein, illustrates implementation of some exemplary embodiments of the invention, and does not inflexibly limit the scope of the exemplary embodiments of the invention. Accordingly, a stated or described numerical range also refers to, and encompasses, all possible sub-ranges and individual numerical values (where a numerical value may be expressed as a whole, integral, or fractional number) within that stated or described numerical range. For example, a stated or described numerical range ‘from 1 to 6’ also refers to, and encompasses, all possible sub-ranges, such as ‘from 1 to 3’, ‘from 1 to 4’, ‘from 1 to 5’, ‘from 2 to 4’, ‘from 2 to 6’, ‘from 3 to 6’, etc., and individual numerical values, such as ‘1’, ‘1.3’, ‘2’, ‘2.8’, ‘3’, ‘3.5’, ‘4’, ‘4.6’, ‘5’, ‘5.2’, and ‘6’, within the stated or described numerical range of ‘from 1 to 6’. This applies regardless of the numerical breadth, extent, or size, of the stated or described numerical range.

Moreover, for stating or describing a numerical range, the phrase ‘in a range of between about a first numerical value and about a second numerical value’, is considered equivalent to, and meaning the same as, the phrase ‘in a range of from about a first numerical value to about a second numerical value’, and, thus, the two equivalently meaning phrases may be used interchangeably. For example, for stating or describing the numerical range of room temperature, the phrase ‘room temperature refers to a temperature in a range of between about 20° C. and about 25° C.’, is considered equivalent to, and meaning the same as, the phrase ‘room temperature refers to a temperature in a range of from about 20° C. to about 25° C.’.

The term ‘about’, as used herein, refers to ±10% of the stated numerical value.

The phrase ‘operatively connected’, as used herein, equivalently refers to the corresponding synonymous phrases ‘operatively joined’, and ‘operatively attached’. These phrases, as used herein, mean that the described or/and shown entities are configured ‘connected’ to each other, in an ‘operative’ (ready-for-operation/ready-for-use) manner. Such operative connection, operative joint, or operative attachment, between or among the entities is according to one type, or a plurality of types, of a mechanical (physical, structural), or/and an electrical, or/and an electronic, or/and an electro-mechanical, connection or connections, involving one or more corresponding type(s) or kind(s) of mechanical (physical, structural), or/and electrical, or/and electronic, or/and electro-mechanical, equipment and components.

The phrase ‘operably connectable’, as used herein, equivalently refers to the corresponding synonymous phrases ‘operably joinable to’, and ‘operably attachable to’. These phrases, as used herein, mean that the described or/and shown entities are configured ‘connectable’ to each other (i.e., capable of being connected to each other, having ability to be connected to each other, or having potential to be connected to each other), for subsequently forming an ‘operative connection’, an ‘operative joint’, or an ‘operative attachment’, between or among the entities. Such operable connectability, operable joinability, or operable attachability, between or among the entities is according to one type, or a plurality of types, of a mechanical (physical, structural), or/and an electrical, or/and an electronic, or/and an electro-mechanical, connection or connections, involving one or more corresponding type(s) or kind(s) of mechanical (physical, structural), or/and electrical, or/and electronic, or/and electro-mechanical, equipment and components.

It is to be fully understood that certain aspects, characteristics, and features, of the invention, which are, for clarity, illustratively described and presented in the context or format of a plurality of separate embodiments, may also be illustratively described and presented in any suitable combination or sub-combination in the context or format of a single embodiment. Conversely, various aspects, characteristics, and features, of the invention which are illustratively described and presented in combination or sub-combination in the context or format of a single embodiment, may also be illustratively described and presented in the context or format of a plurality of separate embodiments.

Although the invention has been illustratively described and presented by way of specific exemplary embodiments, and examples thereof, it is evident that many alternatives, modifications, or/and variations, thereof, will be apparent to those skilled in the art. Accordingly, it is intended that all such alternatives, modifications, or/and variations, are encompassed by the broad scope of the appended claims.

All publications, patents, and or/and patent applications, cited or referred to in this disclosure are herein incorporated in their entirety by reference into the specification, to the same extent as if each individual publication, patent, or/and patent application, was specifically and individually indicated to be incorporated herein by reference. In addition, citation or identification of any reference in this specification shall not be construed or understood as an admission that such reference represents or corresponds to prior art of the present invention. To the extent that section headings are used, they should not be construed as necessarily limiting.

1. An apparatus for filtering and cleaning water in a mikvah, which complies with Jewish religious laws, the apparatus comprising:
an outer tube, longitudinally extending downwardly and upwardly between outer tube top and bottom ends, and configured with at least one outer tube mikvah water inlet opening and at least one outer tube mikvah water outlet opening;
a tubular filter medium, longitudinally extending downwardly and upwardly between filter medium top and bottom ends, and removably, collaterally positioned within and along said outer tube;
a middle tube, longitudinally extending downwardly and upwardly between middle tube top and bottom ends, and configured with a plurality of middle tube openings, said middle tube is collaterally positioned within and along, so as to support, said filter medium;
an inner tube, longitudinally extending downwardly and upwardly between inner tube top and bottom ends, and configured with a plurality of inner tube openings, said inner tube is collaterally securely positioned within and along said middle tube, such that said plurality of inner tube openings are spatially adjacently aligned and nearly coincide with said plurality of middle tube openings, so as to facilitate continuous unobstructed flow of filtered and cleaned mikvah water from said middle tube openings into and through said inner tube openings; and
a forced water circulation assembly, including a propeller, a propeller shaft, and a propeller shaft motor assembly, and operatively connected to said outer, middle, and inner tubes, whereby said forced water circulation assembly facilitates forced continuous and directional flow, and, filtering and cleaning, of the mikvah water from the mikvah into and through said at least one outer tube mikvah water inlet opening, said filter medium, said middle and inner tube openings, and said at least one outer tube mikvah water outlet opening.

2. The apparatus of claim 1, wherein said outer tube is configured with at least one alignment indentation, that facilitates spatial top to bottom longitudinal or/and horizontal latitudinal alignment of structural features of apparatus components.

3. The apparatus of claim 2, wherein said structural features of apparatus components comprise said plurality of middle tube openings that are spatially aligned and nearly coincide with said plurality of inner tube openings.

4. The apparatus of claim 2, wherein each one of said outer tube alignment indentation is located at any top to bottom longitudinal position along said outer tube, and has any one of numerous different geometrical shapes.

5. The apparatus of claim 2, wherein each one of said outer tube alignment indentation has a shape and size configured so as to facilitate secure fitting and holding of a complementary mated and matched alignment protrusion or projection configured in another apparatus component.

6. (canceled)

7. The apparatus of claim 1, wherein said filter medium top end and said middle tube top end are covered by a filter medium and middle tube top ends cover assembly that is cylindrical in form, and includes an outer member and an inner member securely positioned and held within said outer member.

8.-10. (canceled)

11. The apparatus of claim 7, wherein said filter medium and middle tube top ends cover assembly is configured with at least one alignment protrusion or projection, that facilitates spatial top to bottom longitudinal or/and horizontal latitudinal alignment of structural features of apparatus components.

12. The apparatus of claim 11, wherein said structural features of apparatus components comprise said plurality of middle tube openings spatially aligned and nearly coinciding with said plurality of inner tube openings.

13. (canceled)

14. The apparatus of claim 7, wherein said filter medium and middle tube top ends cover assembly is configured with at least one alignment protrusion or projection that has a shape and size configured so as to facilitate secure fitting and holding of a complementary mated and matched alignment indentation configured in a top end portion of said outer tube, to thereby facilitate spatial top to bottom longitudinal or/and horizontal latitudinal alignment of structural features of apparatus components.

15. The apparatus of claim 14, wherein said structural features of apparatus components comprise said plurality of middle tube openings that are spatially aligned and nearly coincide with said plurality of inner tube openings.

16. The apparatus of claim 1, wherein said middle tube includes a bottom end portion configured with bottommost openings, whose bottom peripheries are open in a form of spaces or gaps that are parallel to, and coincide with, said middle tube bottom end, whereby said spaces or gaps facilitate continuous unobstructed flow of filtered and cleaned mikvah water which passes through and exits said filter medium and then enters and passes through said middle tube bottom end portion.

17. The apparatus of claim 1, further comprising a tubes and filter medium bottom ends holding member, configured for holding said filter medium bottom end, said middle tube bottom end, and said inner tube bottom end, and configured for facilitating continuous and unobstructed flow of filtered and cleaned mikvah water that passes through and exits said filter medium and enters, passes through, and exits said middle tube openings and said inner tube openings.

18. The apparatus of claim 17, wherein said tubes and filter medium bottom ends holding member is configured with a cylindrical encircling solid portion that encircles a cylindrical central hollow portion.

19. (canceled)

20. The apparatus of claim 18, wherein said cylindrical encircling solid portion includes a solid portion top surface configured with a top surface gradient or inclination that latitudinally spans and descends upon and along said solid portion top surface, and further includes a solid portion bottom surface, a solid portion inner side surface, and a solid portion outer side surface.

21. The apparatus of claim 20, wherein said top surface gradient or inclination latitudinally spans and descends upon and along said solid portion top surface between an outer radius and an inner radius of said encircling solid portion.

22. The apparatus of claim 20, wherein said top surface gradient or inclination has a gradient or inclination angle, defined as an angle formed between a first straight line originating from a point on a circumferential periphery of said cylindrical central hollow portion and parallel to said solid portion bottom surface, and a second straight line originating from said originating point of said first straight line and collinear with said top surface gradient.

23. The apparatus of claim 22, wherein said gradient or inclination angle is in a range of between one degree and eighty-nine degrees.

24. The apparatus of claim 20, wherein said solid portion inner side surface has a bottom end portion configured as a cylindrical ledge or horizontal projection that horizontally, circularly extends from, and along, a circumferential periphery of said bottom end portion, inwardly into said cylindrical central hollow portion.

25. The apparatus of claim 20, wherein said filter medium bottom end and said middle tube bottom end are positioned on, and supported by, said top surface gradient or inclination, and said inner tube bottom end is positioned along, and supported by, said solid portion inner side surface.

26. The apparatus of claim 24, wherein said inner tube bottom end is positioned on, and supported by, a top width of said cylindrical ledge or horizontal projection of said solid portion inner side surface.

27.-46. (canceled)
